(19) United States
(12) Patent Application Publication
(10) Pub. No.: US 2008/0273146 A1
(43) Pub. Date: Nov. 6, 2008

(54) Cellulose Acylate Film, Polarizing Plate And Liquid Crystal Display

(75) Inventors: Sumio Ohtani, Kanagawa (JP); Hiroyuki Kawanishi, Kanagawa (JP); Seimi Satake, Kanagawa (JP); Susumu Sugiyama, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/659,004

(22) PCT Filed: Sep. 14, 2005
(86) PCT No.: PCT/JP2005/017319

§ 371 Date: Jan. 31, 2007

(30) Foreign Application Priority Data
Sep. 14, 2004 (JP) 2004-266482
Feb. 3, 2005 (JP) 2005-028044
Apr. 20, 2005 (JP) 2005-122437

(51) Int. Cl. G02F 1/1335; G02B 1/08

(52) U.S. Cl. 349/96; 359/500

(57) ABSTRACT

A cellulose acylate film for optics having an in-plane retardation Re (λ) of 46≦Re (630)≦200, a retardation in a film thickness direction Rth (λ) of 70≦Rth (630)≦350 and a thickness variation between every 10 mm in a breadth direction of 0.6 μm or less.

### TECHNICAL FIELD

The present invention relates to a cellulose acylate film, and a polarizing plate and a liquid crystal display using the same.

### BACKGROUND ART

Liquid crystal displays are widely used as monitors of personal computers and portable equipments, and for television uses for various advantages, e.g., low voltage, low consumption of electric power, and capable of miniaturization and thinning. Various modes are proposed of these liquid crystal displays by the state of arrays of liquid crystals in liquid crystal cells, although a TN mode in the state of array twisted by about 90° toward the upper substrate from the lower substrate has been a main stream.

A liquid crystal display generally consists of a liquid crystal cell, an optical compensation sheet and a polarizer. An optical compensation sheet is used for erasing image colors and widening angle of visibility, and stretched birefringent films and transparent films coated with liquid crystals are used as the optical compensation sheets. For example, a technique of widening angle of visibility by applying, to a TN mode liquid crystal cell, an optical compensation film formed by coating discotic liquid crystal to a triacetyl cellulose film, orienting and fixing is disclosed in Japanese Patent 2587398. However, in the liquid crystal displays for television use of large image planes supposed to be viewed from various angles, the requirement for dependency on angle of visibility is severe and even this technique cannot satisfy the requirement. Accordingly, liquid crystal displays different from a TN mode, e.g., an IPS (In-Plane Switching) mode, an OCB (Optically Compensatory Bend) mode, a VA (Vertically Aligned) mode and the like are under investigation. In particular, a VA mode is high in contrast and manufacturing yield is relatively high and attracting public attention as liquid crystal display for TV use.

A cellulose acylate film is characterized in that it is high in optical isotropy (a retardation value is low) as compared with other polymer films. Accordingly, it is usual to use a cellulose acetate film in uses where a high optical isotropy is required, e.g., a polarizing plate. In JP-A-2000-131524 (The term “JP-A” as used herein refers to an “unexamined published Japanese patent application”.) is disclosed a method of manufacturing a highly transparent cellulose acetate film little in undissolved substance by prescribing the viscosity average polymerization degree of cellulose acetate and the relationship with a dope obtained by dissolving cellulose acetate. For solving a face defect called die streak, the preferred relationship of the thickness d of a cellulose acetate film, solids concentration y (%) of a film-forming solution of a cellulose acetate film, and the viscosity p of the solution are disclosed in JP-A-2001-129838.

On the other hand, optical anisotropy (a high retardation value) is required of the optical compensation sheet (a phase film) of a liquid crystal display. In particular, in an optical compensation sheet for a VA mode, in-plane retardation (Re) of from 30 to 200 nm, and retardation in the thickness direction (Rth) of from 70 to 400 nm are required. Accordingly, it has been ordinary to use synthetic polymer films such as a polycarbonate film and a polysulfone film having a high retardation value as optical compensation films.

As has been described above, in the technical field of optical materials, it is a general principle to use synthetic polymer films when optical anisotropy (a high retardation value) is required, and use cellulose acetate films when optical isotropy (a low retardation value) is required.

Contrary to a general principle, a cellulose acetate film having a high retardation value also usable where optical anisotropy is required is disclosed in EP 911656

In the same literature, for realizing a high retardation value in cellulose acetate, stretching is performed with an aromatic compound having at least two aromatic rings, especially by adding a compound having a 1,3,5-triazine ring.

Cellulose acetate is in general a polymer material difficult to stretch, and it is known that to make a birefringence index high is difficult. However, the literature makes it possible to make a birefringence index high by orientating the additive at the same time in stretching process to realize a high retardation value. This film is advantageous in that it can double as the protective film of a polarizing plate, so that an inexpensive and thin liquid crystal display can be provided.

The method disclosed in the above literatures are advantageous in that an inexpensive and thin liquid crystal display can be provided. However, in recent years, a higher retardation value is required, so that it becomes necessary to increase the addition amount of a retardation increasing agent and to heighten stretching magnification. Accompanying with this tendency, unevenness of streaks called perpendicular streaks extending in the casting direction attributable to the thickness variation in the breadth direction are actualized in a casting process and a stretching process, and luminescent spot inclusion and unevenness in luminance and tint actualized only when the film is assembled into a liquid crystal display are now problems. In particular in a cellulose acylate film used in a large sized liquid crystal TV set, the deviation of optical axis of from −1° to +1° at its maximum occurs in the breadth direction and length direction according to places.

Further, the deviation of optical axis of 1° or so at its maximum is liable to occur in a process of assembling a cellulose acylate film into a polarizing plate or when two sheets of polarizing plates are stuck on a liquid crystal cell. When the deviation of the optical axis of a polarizing film from the optical axis of a cellulose acylate film and the deviation of the optical axes between two sheets of polarizing plates becomes large, light leakage in black display is conspicuous. When a film thickness varies in the breadth direction of a cellulose acylate film at narrow intervals, the greater the deviation of optical axis, the more conspicuous is the blurred luminance unevenness to come to be visually observed when it is viewed with a large image plane, eaten if the absolute value of the variation in film thickness is small. Therefore, the solution of such face unevenness is desired. Further, the greater the image plane, the lower becomes the yield of polarizing plates and liquid crystal displays and the more increases the manufacturing costs, if the occurrence of luminescent spot inclusions is not lessened. Therefore, the improvement from this aspect is also required.

### DISCLOSURE OF THE INVENTION

A first object of the invention is to provide a cellulose acylate film excellent in an increasing property of retardation in the in-plane and thickness directions, little in thickness variation in the breadth direction, and a polarizing plate using the film.

A second object of the invention is to provide a liquid crystal display inconspicuous in luminescent spot inclusion and face unevenness and little in variation of angle of visibility.

A third object of the invention is to provide a cellulose acylate film little in variation of optical characteristics by environmental humidity change, and a liquid crystal display little in tint variation by environmental humidity change.

The above objects of the invention have been, achieved by the following means.

(1) A cellulose acylate film for optics having an in-plane retardation Re (λ) of 46≦Re (630)≦200, a retardation in a film thickness direction Rth (λ) of 70≦Rth (630)≦350 and a thickness variation between every 10 mm in a breadth direction of 0.6 μm or less, wherein Re (λ) is an in-plane retardation Re value at wavelength λ nm (unit: nm) and Rth (λ) is a retardation Rth value in a film thickness direction at wavelength λ nm (unit: nm).

(2) The cellulose acylate film as described in (1) above, which is obtained by casting a dope having a coefficient of viscosity of from 10 to 70 Pas at 33° C.

(3) The cellulose acylate film as described in (1) or (2) above, wherein a degree of polymerization of the cellulose acylate is from 265 to 380.

(4) The cellulose acylate film as described in any of (1) to (3) above, wherein a bulk density of the cellulose acylate is from 0.30 to 0.80.

(5) The cellulose acylate film as described in any of (1) to (4) above, which is a film comprising a cellulose acylate obtained by substituting a hydroxyl group of a glucose unit constituting a cellulose with an acyl group having 2 or more carbon atoms,

wherein the film satisfies equations (I) and (II):

2.0≦DS2+DS3+DS6≦2.85 (I)

DS6/(DS2+DS3+DS6)≧0.315 (II)

wherein DS2 represents a degree of substitution of a hydroxyl group at a 2-position of the glucose unit with an acyl group;

DS3 represents a degree of substitution of a hydroxyl group at a 3-position with an acyl group; and

DS6 represents a degree of substitution of a hydroxyl group at a 6-position with an acyl group.

(6) The cellulose acylate film as described in any of (1) to (5) above; which comprises at least one retardation increasing agent comprising a rod-like or cylindrical compound.

(7) The cellulose acylate film as described in any of (1) to (6) above, which comprises at least one of a plasticizer, an ultraviolet absorber and a peeling accelerator.

(8) The cellulose acylate film as described in any of (1) to (7) above, wherein a thickness of the film is from 40 to 180 μm.

(9) The cellulose acylate film as described in any of (1) to (8) above, wherein a content of an additive added to the cellulose acylate is from 10 mass % or more to 30 mass % or less based on a total film mass.

(10) The cellulose acylate film as described in any of (1) to (9) above,

wherein a difference ΔRe between Re at 25° C. 10% RH (Re 10% RH) value and Re at 25° C. 80% RH (Re 80% RH) value (=Re 10% RH−Re 80% RH) of the film is 12 nm or less, and a difference ΔRth between Rth at 25° C. 10% RH (Rth 10% RH) value and Rth at 25° C. 80% RH (Rth 80% RH) value (=Rth 10% RH-Rth 80% RH) is 32 nm or less.

(11) The cellulose acylate film as described in any of (1) to (10) above,

wherein an equilibrium moisture content of the film at 25° C. 80% RH is 3.4% or less.

(12) The cellulose acylate film as described in any of (1) to (11) above,

wherein a moisture permeability (in terms of film thickness of 80 μM) of the film after being allowed to leave at 60° C. 95% RH for 24 hours is from 400 to 2,300 g/m²·24 hr.

(13) The cellulose acylate film as described in any of (1) to (12) above,

wherein a mass variation of the film in a case of being allowed to stand at 80° C. 90% RH for 48 hours is from 0 to 5%.

(14) The cellulose acylate film as described in any of (1) to (13) above,

wherein both dimensional variations of the film in a case of being allowed to stand at 60° C. 90% RH for 24 hours and in a case of being allowed to stand at 90° C. 3% RH for 24 hours are within ±2%.

(15) The cellulose acylate film as described in any of (1) to (14) above,

wherein a glass transition temperature Tg is from 80 to 180° C.

(16) The cellulose acylate film as described in any of (1) to (15) above;

wherein an elastic modulus is from 1,500 to 5,000 MPa.

(17) The cellulose acylate film as described in any of (1) to (16) above,

wherein a modulus of photoelasticity is 50×10⁻¹³ cm²/dyn (5×10⁻¹¹ Pa-l) or less.

(18) The cellulose acylate film as described in any of (1) to (17) above,

wherein a haze value is from 0.01 to 2%.

(19) The cellulose acylate film as described in any of (1) to (18) above, which comprises silicon dioxide fine particles having an average particle, size of secondary particles of from 0.2 or more to 1.5 μm or less.

(20) The cellulose acylate film as described in any of (1) to (19) above,

wherein Re (630) and Rth (630) measured in an environmental humidity at 25° C. 60% RH satisfy equations (A), (B) and (C):

46≦Re(630)≦100 (A)

Rth(630)=a−5.9Re(630) (B)

520≦a≦600 (C)

(21) The cellulose acylate film as described in any of (1) to (20) above,

wherein Re value and Rth value measured by varying a wavelength in an environmental humidity at 25° C. 60% RH satisfy both equations (D) and (E):

0.90≦Re(450)/Re(550)≦1.10, and 0.90≦Re(650)/Re(550)≦1.10 (D)

0.90≦Rth(450)/Rth(550)≦1.25, and 0.90≦Rth(650)/Rth(550)≦1.10 (E)

(22) The cellulose acylate film as described in any of (1) to (21) above,

wherein a number of luminescent spot inclusions having a major axis of 20 μm or more is 20 or less in any 2.16 mm×1.72 mm area of the cellulose acylate film.

(23) A polarizing plate comprising:

a polarizer; and

a protective film,

wherein the protective film comprises at least one cellulose acylate film as described in any of (1) to (22) above.

(24) The polarizing plate as described in (23) above,

wherein single transmittance TT (%), parallel transmittance PT (%), cross transmittance CT (%) and polarization degree P of the polarizing plate measured at 25° C. 60% RH satisfy at least one of equations (a) to (d):

40.0≦TT≦545.0 (a)

30.0≦PT≦40.0 (b)

CT≦2.0 (c)

95.0≦P. (d)

(25) The polarizing plate as described in (23) or (24) above,

wherein CT (380) (%), CT (410) (%) and CT (700) (%) satisfy at least one of equations (e) to (g), provided that a cross transmittance at wavelength λ is CT (λ) (%):

CT(380)≦2.0 (e)

CT(410)≦0.1 (f)

CT(700)≦0.5 (g)

(26) The polarizing plate as described in any of (23) to (25) above,

wherein a variation ΔCT (%) of a cross transmittance and a variation ΔP of a polarization degree at a time when the plate is allowed to stand at 60° C. 90% RH for 500 hours satisfy at least one of equations (h) and (i):

−3.0≦ΔCT≦3.0 (h)

−5.0≦ΔP≦0.0 (i)

wherein the variation means a value obtained by subtracting a measured value before a test from a measured value after the test.

(27) The polarizing plate as described in any of (23) to (26) above,

wherein a variation ΔCT (%) of a cross transmittance and a variation ΔP of a polarization degree at a time when the plate is allowed to stand at 60° C. 95% RH for 500 hours satisfy at least one of equations (j) and (k).

−6.0≦ΔCT≦6.0 (j)

−10.0≦ΔP≦0.0 (k)

wherein the variation means a value obtained by subtracting a measured value before a test from a measured value after the test.

(28) The polarizing plate as described in any of (23) to (27) above,

wherein a variation ΔCT of a cross transmittance and a variation ΔP of a polarization degree at a time when the plate is allowed to stand at 80° C. for 500 hours satisfy at least one of equations (l) and (m):

−3.0≦ΔCT≦3.0 (l)

−2.0≦ΔP≦0.0 (m)

(29) The polarizing plate as described in any of (23) to (28) above,

wherein at least one of a hard coat layer, a glare-proof layer and an antireflection layer is provided on a surface of a protective film provided on a side opposite to a liquid crystal cell of the polarizing plate.

(30) The polarizing plate as described in any of (23) to (29) above, which is packaged in a moisture-proof bag, and a humidity in a packaged state bag is from 43% RH to 70% RH at 25° C.

(31) The polarizing plate as described in any of (23) to (30) above, which is packaged in a moisture-proof bag, and a difference between a humidity in a packaged state bag and a humidity at a time of sticking the polarizing plate on a liquid crystal panel is 15% RH or less.

(32) An OCB mode liquid crystal display comprising at least one of a cellulose acylate film as described in any of (1) to (22) above and a polarizing plate as described in any of (23) to (31) above.

(33) A VA mode liquid crystal display comprising at least one of a cellulose acylate film as described in any of (1) to (22) above and a polarizing plate as described in any of (23) to (31) above.

(34) The VA mode liquid crystal display as described in (33) above, comprising only one of a cellulose acylate film as described in any of (1) to (22) above and a polarizing plate as described in any of (23) to (31) above.

(35) The VA mode liquid crystal display as described in (33) or (34) above, comprising any one of a cellulose acylate film as described in any of (1) to (22) above and a polarizing plate as described in any of (23) to (31) above on a back light side.

### BRIEF DESCRIPTION OF THE DRAWING

FIG. 1 is a view showing the method of sticking cellulose acylate films in polarizing plate manufacturing;

FIG. 2 is a cross-sectional view showing the cross-sectional structure of a polarizing plate in the invention; and

FIG. 3 is a cross-sectional view showing the cross-sectional structure of a liquid crystal display in the invention.

### BEST MODE FOR CARRYING OUT THE INVENTION

The invention is described in detail below.

### Cellulose Acylate:

In the first place, cellulose acylates preferably used in the invention are described in detail. A β-1,4-bonding glucose unit constituting cellulose has a free hydroxyl group at the 2-position, 3-position and 6-position. Cellulose acylate is a polymer obtained by the esterification of a part or all of these hydroxyl groups by acyl groups having 2 or more carbon atoms. The degree of acyl substitution means the ratio of esterification of the hydroxyl groups of cellulose of each of the 2-position, 3-position and 6-position (esterification of 100% is degree of substitution 1).

The degree of all acyl substitution of, i.e., DS2+DS3+DS6, is preferably from 2.00 to 2.85, more preferably from 2.22 to 2.82, and especially preferably from 2.40 to 2.80. Further, DS6/(DS2+DS3+DS6) is preferably 0.315 or more, especially preferably 0.320 or more. Here, DS2 is the degree of substitution of the hydroxyl group at the 2-position of a glucose unit with acyl groups (hereinafter also referred to as “acyl substitution degree at the 2-position”), DS3 is the degree of substitution of the hydroxyl group at the 3-position with acyl groups (hereinafter also referred to as “acyl substitution degree at the 3-position”), and DS6 is the degree of substitution of the hydroxyl group at the 6-position with acyl groups (hereinafter also referred to as “acyl substitution degree at the 6-position”).

Acyl groups for use in cellulose acylate in the invention may be only one kind, or two or more kinds of acyl groups may be used. When two or more kinds of acyl groups are used, it is preferred that one of the acyl groups is an acetyl group. When the sum total of the degree of substitution of hydroxyl groups at the 2-position, 3-position and 6-position with acetyl groups is taken as DSA, and the sum total of the degree of substitution of hydroxyl groups at the 2-position, 3-position and 6-position with acyl groups other than acetyl groups is taken as DSB, the value of DSA+DSB is more preferably from 2.2 to 2.85, especially preferably from 2.40 to 2.80. DSB is 1.70 or less, especially preferably 1.0 or less. Twenty-eight (28) % or more of DSB are the substituents of the hydroxyl groups at the 6-position, more preferably 30% or more are the substituents of the hydroxyl groups at the 6-position, still more 31% or more, and especially preferably 32% or more are the substituents of the hydroxyl groups at the 6-position. Further, cellulose acylate films having the value of DSA+DSB of cellulose acylate at the 6-position of 0.75 or more is preferred, 0.80 or more is more preferred, and 0.85 or more is especially preferred. Cellulose acylate having such acylate substitution characteristics is excellent in solubility in various kinds of solvents and a solution hardly containing undissolved substances can be obtained. Further, a solution low in viscosity and having a good filtering property can be manufactured. As a result, a cellulose acylate film in the invention contains little foreign matters, and it is possible to reduce the phenomenon of light leaking out and glistening, what is called luminescent spot inclusion, in black display in particular when the film is assembled into a liquid crystal display.

Acyl groups having 3 or more carbon atoms of cellulose acylate for use in the invention may be aliphatic acyl groups or arylacyl groups without any limitation. Cellulose acylates for use in the invention are, for example, alkylcarbonyl ester, alkenylcarbonyl ester, aromatic carbonyl ester, or aromatic alkylcarbonyl ester of cellulose, which may further be substituted. As the preferred examples of acyl groups, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl are exemplified. Of these groups, propionyl, butanoyl, dodecanoyl, octadecanoyl, t-butanoyl, oleoyl, benzoyl, naphthylcarbonyl and cinnamoyl are more preferred, and propionyl and butanoyl are especially preferred.

### Synthesizing Method of Cellulose Acylate:

The fundamental principle of the synthesizing method of cellulose acylate is described in Migita, et al., Mokuzai Kagaku (Wood Chemistry), pp. 180-190, KYORITSU SHUPPAN CO., LTD. (1968). A representative synthesizing method is a liquid phase acetylation method by carboxylic anhydride-acetic acid-a sulfuric acid catalyst. Specifically, cellulose materials of cotton linter and wood pulp are pre-treated with an appropriate amount of acetic acid, put into a previously cooled carboxylated mixed solution for esterification to thereby synthesize complete cellulose acylate (the total of the acyl substitution degree at the 2-position, 3-position and 6-position is almost 3.00). The carboxylated mixed solution generally contains acetic acid as a solvent, carboxylic anhydride as an esterifying agent and a sulfuric acid as a catalyst. It is usual to use carboxylic anhydride in excess amount stoichiometrically than the total amount of cellulose to be reacted with the carboxylic anhydride and the moisture present in the system. After completion of acylation reaction, an aqueous solution of a neutralizer (e.g., carbonate, acetate or oxide of calcium, magnesium, iron, aluminum or zinc) is added to hydrolyze excessive carboxylic acid remaining in the system and to neutralize a part of the esterification catalyst. In the next place, the obtained complete cellulose acylate is subjected to ripening by saponification in the presence of a small amount of acetylation reaction catalyst (generally the remaining sulfuric acid) while maintaining the temperature at 35 to 90° C. to be changed to cellulose acylate having a desired acyl substitution degree and polymerization degree. At a point of time when a desired cellulose acylate is obtained, the catalyst remaining in the system is completely neutralized with a neutralizer as above, or, without neutralization, cellulose acylate is separated by agglomeration and precipitation by putting the cellulose acylate solution into water or a dilute sulfuric acid (or putting water or a dilute sulfuric acid into the cellulose acylate solution), washing and stabilizing treatment to thereby obtain cellulose acylate.

A cellulose acylate film in the invention preferably comprises substantially cellulose acylates having the above definition as the polymer components constituting the film. “Substantially” means 55 mass % or more of the polymer components, preferably 70 mass % or more, and more preferably 80 mass % or more. (an this specification, mass parts and mass % are equal to weight parts and weight % respectively.) As the materials of film manufacture, cellulose acylate particles are preferably used. It is preferred that 90 mass % or more of the particles used have a particle size of from 0.5 to 5 mm. It is also preferred that 50 mass % or more of the particles used have a particle size of from 1 to 4 mm. Cellulose acylate particles are preferably close to a spherical form, if possible. The bulk density (apparent density) of the particles is preferably from 0.3 to 0.8 kg/liter. If bulk density is small, bridging is liable to occur when the material is put to a solution tank from a silo, in contrast with this, if bulk density is great, solubility deteriorates. Accordingly, more preferred bulk density is from 0.4 to 0.6. The adjustment of particle size and bulk density is performed by adjusting the speeds of stirring and agglomeration at the time of agglomeration and precipitation. When the concentration of cellulose acylate is low at the time of agglomeration and precipitation, the bulk density becomes small, and in contrast with this, if the concentration of cellulose acylate is high, the bulk density becomes great.

The polymerization degree of cellulose acylate usable in the invention is viscosity average polymerization degree of from 250 to 550, preferred viscosity average polymerization degree is from 265 to 380, and especially preferably from 280 to 360. Viscosity average polymerization degree can be measured according to a limiting viscosity method by Uda, et al. (Kazuo Uda and Hideo Saito, Sen'i Gakkaishi (Bulletin of Fiber Institution), Vol. 18, No. 1, pp. 105-120, (1962)). Further, viscosity average polymerization degree is disclosed in detail in JP-A-9-95538. Viscosity average polymerization degree is found from the intrinsic viscosity of cellulose acylate [η] measured with an Ostwald's viscometer according to the following equation.

Viscosity average polymerization degree DP=[η]/Km

In the equation, [η] is the intrinsic viscosity of cellulose acylate and Km is a constant of 6×10⁻⁴.

The molecular weight distribution Mw/Mn (Mw is a weight average molecular weight and Mn is a number average molecular weight) of cellulose acylate can be measured by gel permeation chromatography. The invention is characterized in that the viscosity of a cellulose acylate solution is adjusted to a preferred value. The viscosity of a cellulose acylate solution can also be adjusted to a preferred value by adjusting the molecular weight distribution. In this point of view, the specific value of Mw/Mn is preferably from 1.8 to 4.0, more preferably from 2.1 to 3.5.

The polymerization degree and the molecular weight distribution of cellulose acylate can be adjusted by adjusting the reaction temperature, the reaction time and the amount of a catalyst in acetylation reaction. For example, when the amount of a sulfuric acid catalyst is increased, the degree of polymerization is liable to lower. Accordingly, it is preferred to adjust the amount of a sulfuric acid catalyst to 0.5 to 20 mass parts per 100 mass parts of cellulose, more preferably from 3 to 15 mass parts. When the amount of a sulfuric acid catalyst is in the above range, cellulose acylate also preferred in the point of molecular weight distribution can be synthesized.

The polymerization degree and the molecular weight distribution of cellulose acylate can also be adjusted by adjusting the temperature at the time of saponification ripening in the stage of neutralization and saponification ripening, the residual amount of acid, the speed of neutralization and the moisture content. For example, when saponification is performed slowly with maintaining the water content in a reaction vessel low, polymerization degree lowers, since depolymerization also proceeds slowly at the same time with the saponification reaction.

Further, the polymerization degree and the molecular weight distribution can also be adjusted by removing low molecular weight components. For example, low molecular weight components can be removed by washing cellulose acylate with an appropriate organic solvent.

The moisture content of cellulose acylates for use in the invention is preferably 2 mass % or less, more preferably 1 mass % or less, and especially preferably 0.7 mass % or less. In general, cellulose acylates contain moisture, and it is shown to be from 2.5 to 5 mass %. To reach the above moisture content, it is necessary to dry cellulose acylate, and the method is not especially restricted so long as the objective moisture content is secured.

The material cotton and synthesizing methods of cellulose acylates in the invention are described in detail in Hatsumei Kyokai Kokai Giho Kogi No. 2001-1745 (on Mar. 15, 2001, published by Hatsumei Kyokai), pp. 7-12.

### Additives:

To a cellulose acylate solution in the invention, various additives (e.g., plasticizers, UV inhibitors, deterioration preventives, retardation (optical anisotropy) adjustors, fine particles, peeling accelerators, infrared absorbers, etc.) can be added according to purposes in each preparation process, and these additives may be solid or oily substances. That is, the melting points and the boiling points of these additives are not especially restricted. For example, the mixture of UV absorbers of 20° C. or lower and 20° C. or higher, and the mixture of plasticizers are the examples and these things are disclosed in JP-A-2001-151901 and the like. As the examples of the peeling accelerators, citric acid ethyl esters are exemplified. Further, the examples of the infrared absorbers are disclosed in JP-A-2001-194522. These additives may be added any stage in the manufacturing process of a dope, but they may be added at the final of the preparation process of dope by providing an addition process of additives. The addition amount of each additive is not particularly limited so long as the function is exhibited. Further, when a cellulose acylate film is formed as a multilayer structure, the kinds and addition amounts of additives in each layer may be different. The examples thereof are disclosed in JP-A-2001-151902 and the like, and these are conventionally known techniques, It is preferred to adjust the glass transition temperature Tg of cellulose acylate film to 80 to 180° C. and the elastic modulus measured with a tensile strength tester to 1,500 to 3,000 MPa.

The details of these things are described in Hatsumei Kyokai Kokai Giho Kogi No. 2001-1745 (Mar. 15, 2001, published by Hatsumei Kyokai), on and after page 6, and the materials described therein are preferably used.

### Plasticizers:

It is preferred for films in the invention to contain a plasticizer. Usable plasticizers are not especially limited, but it is preferred to use more hydrophobic plasticizers than cellulose acylate, alone or in combination, such as phosphates, e.g., triphenyl phosphate, tricresyl phosphate, cresyl-diphenyl phosphate, octyldiphenyl phosphate, diphenyl-biphenyl phosphate, trioctyl phosphate and tributyl phosphate, phthalates, e.g., diethyl phthalate, dimethoxyethyl phthalate, dimethyl phthalate, dioctyl phthalate, dibutyl phthalate, and di-2-ethylhexyl phthalate, glycolates, e.g., triacetin, tributyrin, butylphthalylbutyl glycolate, ethylpbthalylethyl glycolate, methylphthalylethyl glycolate and butylphthalyl-butyl glycolate are exemplified. If necessary, plasticizers may be used two or more in combination.

### Retardation Increasing Agent:

In the invention, to increase a retardation value, compounds having at least two aromatic rings can be preferably used as a retardation increasing agent. It is preferred to use a retardation increasing agent in the range of from 0.05 to 20 mass parts per 100 mass parts of the polymer, more preferably in the range of from 0.1 to 10 mass parts, still more preferably in the range of from 0.2 to 5 mass parts, and most preferably in the range of from 0.5 to 2 mass parts. Two or more kinds of retardation increasing agents may be used in combination.

It is preferred for retardation increasing agents to have maximum absorption in the wavelength region of from 250 to 400 nm, and it is preferred that retardation increasing agents substantially do not have absorption in the visible ray region.

In the specification of the invention, “aromatic rings” include aromatic heterocyclic rings in addition to aromatic hydrocarbon rings.

Aromatic hydrocarbon rings are especially preferably 6-membered rings (i.e. benzene rings).

Aromatic heterocyclic rings are generally unsaturated heterocyclic rings. Aromatic heterocyclic rings are preferably 5-, 6- or 7-membered rings, and more preferably 5- or 6-membered rings. Aromatic heterocyclic rings generally have possible most double bonds. As the hetero atoms, a nitrogen atom, an oxygen atom and a sulfur atom are preferred, and a nitrogen atom is most preferred. The examples of aromatic heterocyclic rings include a furan ring, a thiophene ring, a pyrrole ring, an oxazole ring, an isooxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic rings, a benzene ring, a condensed benzene ring and biphenyls are preferred, and a 1,3,5-triazine ring is especially preferably used. Specifically, the compounds disclosed in JP-A-2001-166144 are preferably used.

The carbon atoms of the aromatic ring which retardation increasing agent have are preferably from 2 to 20, more preferably from 2 to 12, still more preferably from 2 to 8, and most preferably from 2 to 6.

The bonding relation of two aromatic rings can be classified to (a) a case of forming a condensed ring, (b) a case of direct bonding via a single bond, and (c) a case of bonding via a linking group (as they are aromatic rings, spiro bonding cannot be formed). The bonding relation may be any of (a) to (c).

The examples of (a) condensed rings (condensed rings of two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and thianthrene ring. Of these rings, a naphthalene ring, an azulene ring, an indole ring, a benzoxazole ring, a benzothiazole ring, a benzimidazole ring, a benzotriazole ring and a quinoline ring are preferred.

A single bond in (b) is preferably bonding of two aromatic rings between carbon atoms. Two aromatic rings may be bonded by two or more single bonds, and an aliphatic ring or an aromatic heterocyclic ring may be formed between the aromatic rings.

It is also preferred that a linking group in (c) is bonded to the carbon atoms of two aromatic rings. The linking groups are preferably an alkylene group, an alkenylene group, an alkynylene group, —CO—, —O—, —NH—, —S— or combinations of these groups. The examples of linking groups comprising combination are shown below. The relation of the left and right of the examples of the following linking groups may be reverse.

c1: —CO—O—
c2: —CO—NH—
c3: -Alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -Alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic rings and linking groups may have a substituent.

The examples of the substituents include a halogen atom (F, Cl, Br, I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxyl group, an alkoxycarbonyl group, an alkoxycarbonylamino group, an alkylthio group, an alkylsulfonyl group, an aliphatic amido group, an aliphatic sulfonamido group, an aliphatic group-substituted amino group, an aliphatic group-substituted carbamoyl group, an aliphatic group-substituted sulfamoyl group, an aliphatic group-substituted ureido group and a non-aromatic heterocyclic group.

The alkyl group preferably has from 1 to 8 carbon atoms. Chain-like alkyl groups are preferred to cyclic alkyl groups, and straight chain alkyl groups are particularly preferred. The alkyl group may further have a substituent (e.g., a hydroxyl group, a carboxyl group, an alkoxyl group, an alkyl-substituted amino group). The examples of the alkyl groups (including substituted alkyl groups) include methyl, ethyl, n-butyl, n-hexyl, 2-hydroxyethyl, 4-carboxybutyl, 2-methoxyethyl and 2-diethylaminoethyl.

The alkenyl group preferably has from 2 to 8 carbon atoms. Chain-like alkenyl groups are preferred to cyclic alkenyl groups, and straight chain alkenyl groups are particularly preferred. The alkenyl group may further have a substituent. The examples of the alkenyl groups include a vinyl group, an allyl group and a 1-hexenyl group.

The alkynyl group preferably has from 2 to 8 carbon atoms. Chain-like alkyl groups are preferred to cyclic alkynyl groups, and straight chain alkynyl groups are particularly preferred. The alkynyl group may further have a substituent. The examples of the alkynyl groups include an ethynyl group, a 1-butynyl group and a 1-hexynyl group.

The aliphatic acy group preferably has from 1 to 10 carbon atoms. The examples of the aliphatic acyl groups include an acetyl group, a propanoyl group and a butanoyl group.

The aliphatic acyloxy group preferably has from 1 to 10 carbon atoms. The example of the aliphatic acyloxy group includes an acetoxy group.

The alkoxyl group preferably has from 1 to 8 carbon atoms. The alkoxyl group may further have a substituent (e.g., an alkoxyl group). The examples of the alkoxyl groups (including substituted alkoxyl groups) include a methoxy group, an ethoxy group, a butoxy group and a methoxyethoxy group.

The alkoxycarbonyl group preferably has from 2 to 10 carbon atoms. The examples of the alkoxycarbonyl groups include a methoxycarbonyl group and an ethoxycarbonyl group.

The alkoxycarbonylamino group preferably has from 2 to 10 carbon atoms. The examples of the alkoxycarbonylamino groups include a methoxycarbonylamino group and an ethoxy-carbonylamino group.

The alkylthio group preferably has from 1 to 12 carbon atoms. The examples of the alkylthio groups include a methylthio group, an ethylthio group and an octylthio group.

The alkylsulfonyl group preferably has from 1 to 8 carbon atoms. The examples of the alkylsulfonyl groups include a methanesulfonyl group and an ethanesulfonyl group.

The aliphatic amido group preferably has from 1 to 10 carbon atoms. The example of the aliphatic amido group includes an acetamido group.

The aliphatic sulfonamido group preferably has from 1 to 8 carbon atoms. The examples of the aliphatic sulfonamido groups include a methanesulfonamido group, a butanesulfon-amido group and an n-octanesulfonamido group.

The aliphatic group-substituted amino group preferably has from 1 to 10 carbon atoms. The examples of the aliphatic group-substituted amino groups include a dimethylamino group, a diethylamino group and a 2-carboxyethylamino group.

The aliphatic group-substituted carbamoyl group preferably has from 2 to 10 carbon atoms. The examples of the aliphatic group-substituted carbamoyl groups include a methylcarbamoyl group and a diethylcarbamoyl group.

The aliphatic group-substituted sulfamoyl group preferably has from 1 to 8 carbon atoms. The examples of the aliphatic group-substituted sulfamoyl groups include a methylsulfamoyl group and a diethylsulfamoyl group.

The aliphatic group-substituted ureido group preferably has from 2 to 10 carbon atoms.

The example of the aliphatic group-substituted ureido group includes a methylureido group.

The examples of the non-aromatic heterocyclic groups include a piperidino group and a morpholino group.

The molecular weight of retardation increasing agents is preferably from 300 to 800.

Rod-like compounds having a linear molecular structure are also preferably used in the invention besides the compounds having a 1,3,5-triazine ring. A linear molecular structure means that the molecular structure of a rod-like compound is linear in a thermodynamically most stable structure. A thermodynamically most stable structure can be found by the analysis of crystal structure or the computation of molecular orbital. For example, the molecular stricture by which the heat of formation of a compound is the smallest can be found from the computation of molecular orbital with the software of molecular orbital computation (e.g., WinMOPAC2000, manufactured by Fujitsu Limited). That a molecular structure is linear means the angle constituted by the main chains in a molecular structure is 140° or more in a thermodynamically most stable structure found by the computation as above.

As the rod-like compound having at least two aromatic rings, a compound represented by the following formula (1) is preferred.

Ar¹-L1-Ar² (1)

In the above formula (1), Ar¹ and Ar² each independently represents an aromatic group.

In the specification of the invention, the aromatic group includes an aryl group (an aromatic hydrocarbon group), a substituted aryl group, an aromatic heterocyclic group and a substituted aromatic heterocyclic group.

An aryl group and a substituted aryl group are preferred to an aromatic heterocyclic group and a substituted aromatic heterocyclic group. The hetero ring of an aromatic heterocyclic group is generally unsaturated. An aromatic heterocyclic group is preferably a 5-, 6- or 7-membered ring, more preferably a 5- or 6-membered ring. An aromatic heterocyclic group generally has possible most double bonds. The hetero atom is preferably a nitrogen atom, an oxygen atom or a sulfur atom, more preferably a nitrogen atom or a sulfur atom.

As the aromatic rings of the aromatic group, a benzene ring, a furan ring, a thiophene ring, a pyrrole ring, an oxazole ring, a thiazole ring, an imidazole ring, a triazole ring, a pyridine ring, a pyrimidine ring and a pyrazine ring are preferred, and a benzene ring is especially preferred.

As the examples of the substituents of the substituted aryl group and the substituted aromatic heterocyclic group, a halogen atom (e.g., F, Cl, Br, I), a hydroxyl group, a carboxyl group, a cyano group, an amino group, an alkylamino group (e.g., methylamino, ethylamino, butylamino, dimethylamino), a nitro group, a sulfo group, a carbamoyl group, an alkylcarbamoyl group (e.g., N-methylcarbamoyl, N-ethylcarbamoyl, N,N-dimethylcarbamoyl), a sulfamoyl group, an alkylsulfamoyl group (e.g., N-methylsulfamoyl, N-ethylsulfamoyl, N,N-dimethylsulfamoyl), a ureido group, an alkylureido group (e.g., N-methylureido, N,N-dimethylureido, N,N,N′-trimethylureido), an alkyl group (e.g., methyl, ethyl, propyl, butyl, pentyl, heptyl, octyl, isopropyl, s-butyl, t-amyl, cyclohexyl, cyclopentyl), an alkenyl group (e.g., vinyl, allyl, hexenyl), an alkynyl group (e.g., ethynyl, butynyl), an acyl group (e.g., formyl, acetyl, butyryl, hexanoyl, lauryl), an acyloxy group (e.g., acetoxy, butyryloxy, hexanoyloxy, lauryloxy), an alkoxyl group (e.g., methoxy, ethoxy, propoxy, butoxy, pentyloxy, heptyloxy, octyloxy), an aryloxy group (e.g., phenoxy), an alkoxycarbonyl group (e.g., methoxycarbolyl, ethoxycarbonyl, propoxycarbonyl, butoxycarbonyl, pentyloxy-carbonyl, lieptyloxycarbonyl), an aryloxycarbonyl group (e.g., phenoxycarbonyl), an alkoxycarbonylamino group (e.g., butoxy-carbonylamino, hexyloxycarbonylamino), an alkylthio group (e.g., methylthio, ethylthio, propylthio, butylthio, pentylthio, heptylthio, octylthio), an arylthio group (e.g., phenylthio), an alkylsulfonyl group (e.g., methylsulfonyl, ethylsulfonyl, propylsulfonyl, butylsulfonyl, pentylsulfonyl, heptylsulfonyl, octylsulfonyl), an amido group (e.g., acetamido, butylamido, hexylamido, laurylamido), and non-aromatic heterocyclic group (e.g., morpholino, pyrazinyl) are exemplified.

Above all, as preferred substituents, a halogen atom, a cyano group, a carboxyl group, a hydroxyl group, an amino group, an alkylamino group, an acyl group, an acyloxy group, an amido group, an alkoxycarbonyl group, an alkoxyl group, an alkylthio group and an alkyl group are exemplified.

The alkyl moiety of the alkylamino group, alkoxycarbonyl group, alkoxyl group, alkylthio group, and the alkyl group may further have a substituent. The examples of the substituents of the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxyl group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. As the substituents of the alkyl moiety and the alkyl group, a halogen atom, a hydroxyl group, an amino group, an alkylamino group, an acyl group, an acyloxy group, an acylamino group, an alkoxycarbonyl group, and an alkoxyl group are preferred.

In formula (1), L¹ represents a divalent linking group selected from the group consisting of an alkylene group, an alkenylene group, an alkynylene group, —O—, —CO— and a group consisting of the combination of these groups.

The alkylene group may have a cyclic structure. As the cyclic alkylene group, cyclohexylene is preferred, and 1,4-cyclohexylene is especially preferred. As the chain-like alkylene group, a straight chain alkylene group is preferred to a branched alkylene group.

The alkylene group preferably has from 1 to 20 carbon atoms, more preferably from 1 to 15, still more preferably from 1 to 10, still yet preferably from 1 to 8, and most preferably from 1 to 6.

As the structure of the alkenylene group and the alkynylene group, a chain-like structure is preferred to a cyclic structure, and a straight chain structure is more preferred to a branched chain structure.

The alkenylene group and the alkynylene group preferably have from 2 to 10 carbon atoms, more preferably from 2 to 8, still more preferably from 2 to 6, still yet preferably from 2 to 4, and most preferably 2 (a vinylene group or an ethynylene group).

The arylene group preferably has from 6 to 20 carbon atoms, more preferably from 6 to 16, and still more preferably from 6 to 12.

In the molecular structure of formula (1), the angle formed by Ar¹ and Ar² sandwiching L¹ is preferably 140° or more, more preferably from 140° to 220°.

As the rod-like compound, a compound represented by the following formula (2) is more preferred.

Ar¹-L²-X-L³-Ar² (2)

In formula (2), Ar¹ and Ar² each independently represents an aromatic group. The definition and examples of the aromatic group are the same as those of Ar¹ and Ar² in formula (1).

In formula 2), L² and L³ each independently represents a divalent linking group selected from the group consisting of an alkylene group, —O—, —CO— and a group consisting of the combination of these groups.

As the structure of the alkylene group, a cha in-like structure is preferred to a cyclic structure, and a straight chain structure is more preferred to a branched chain structure.

The alkylene group preferably has from 1 to 10 carbon atoms, more preferably from 1 to 8, still more preferably from 1 to 6, still yet preferably from 1 to 4, and most preferably 1 or 2 (a methylene group or an ethylene group).

L² and L³ each especially preferably represents —O—CO— or —CO—O—.

In formula (2), X represents a 1,4-cyclohexylene group, a vinylene group or an ethynylene group.

The specific examples of the compounds represented by formula (1) are shown below.

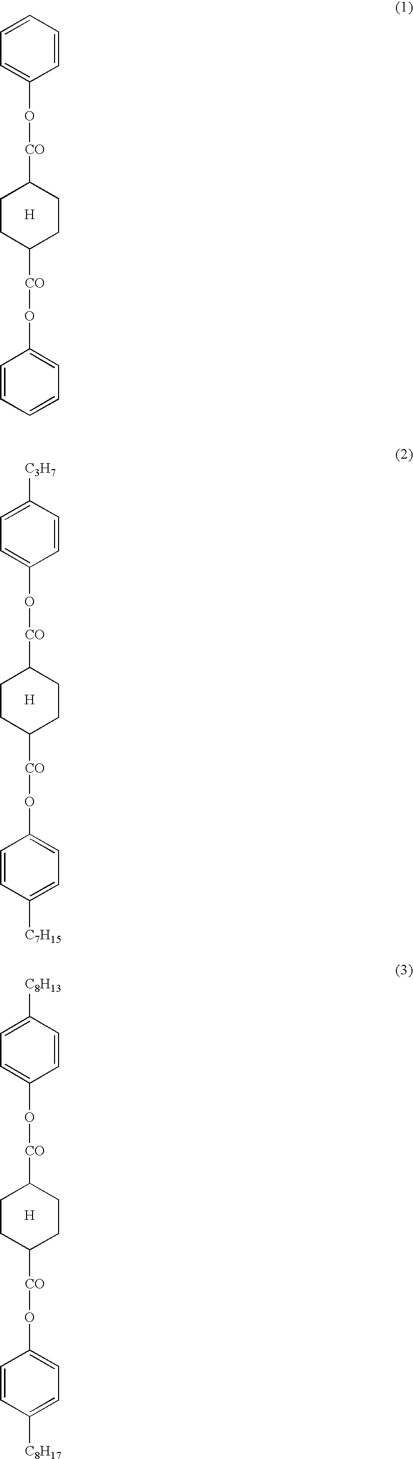

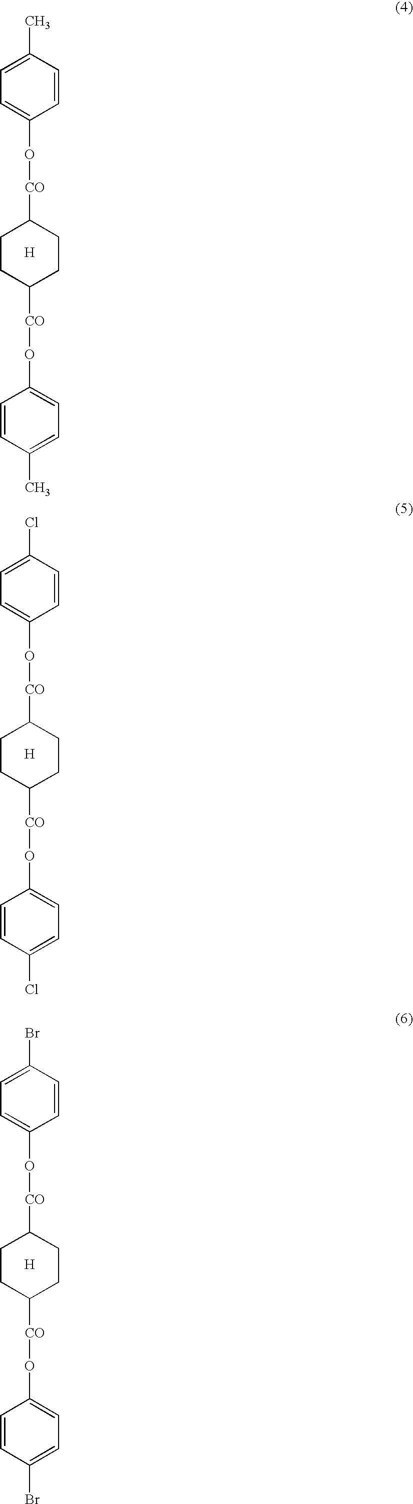

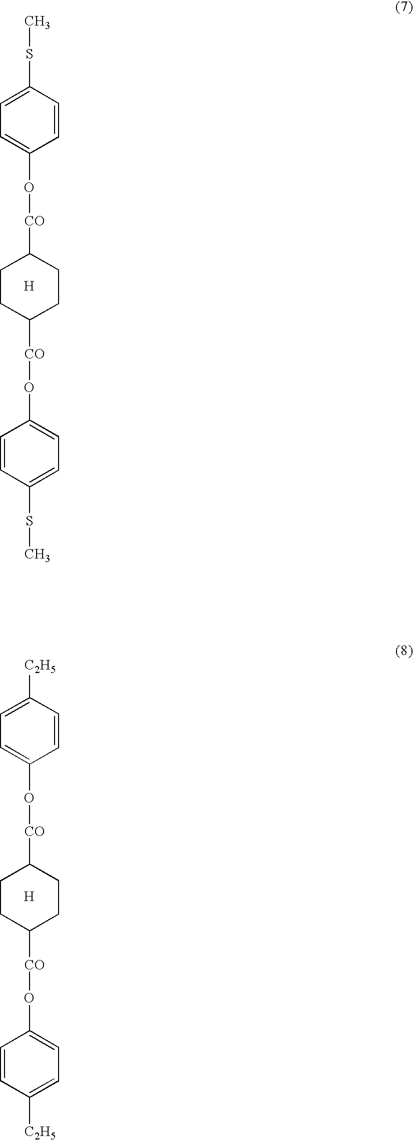

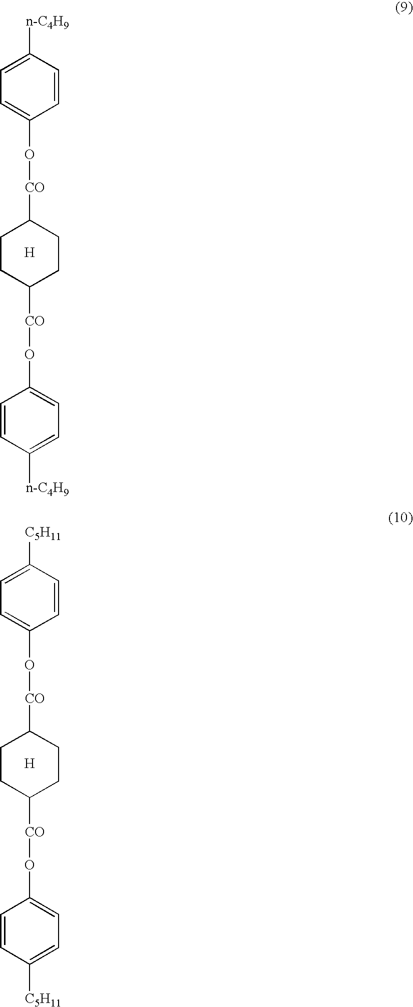

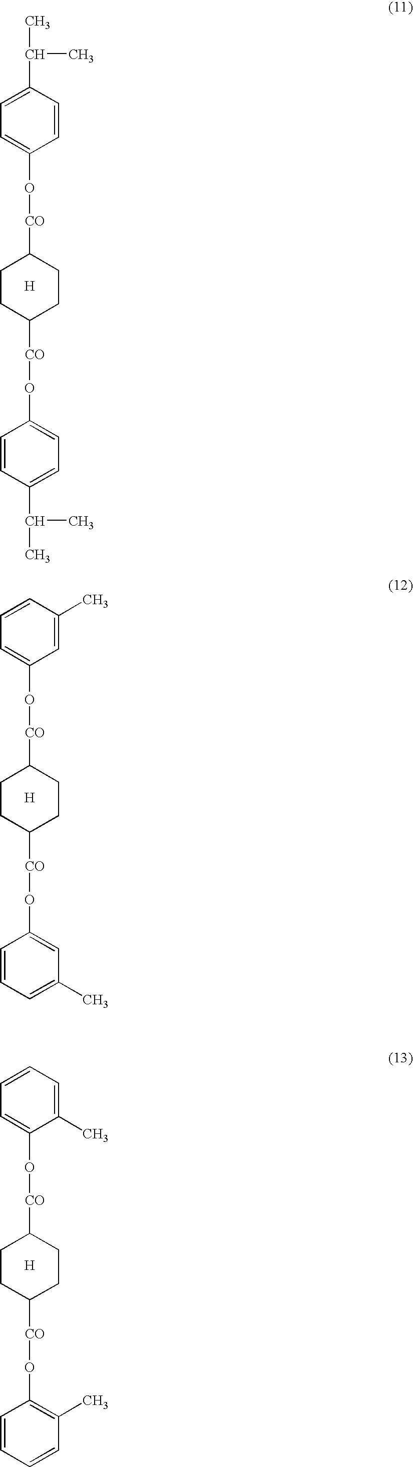

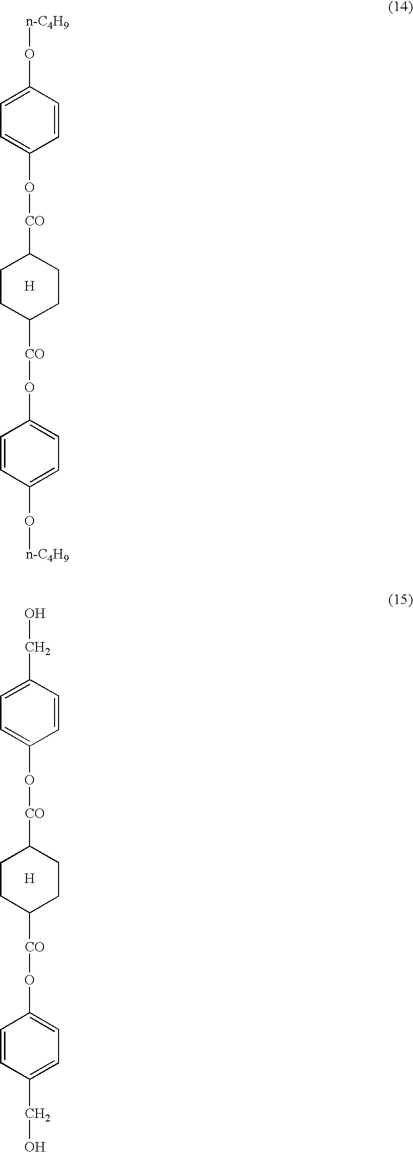

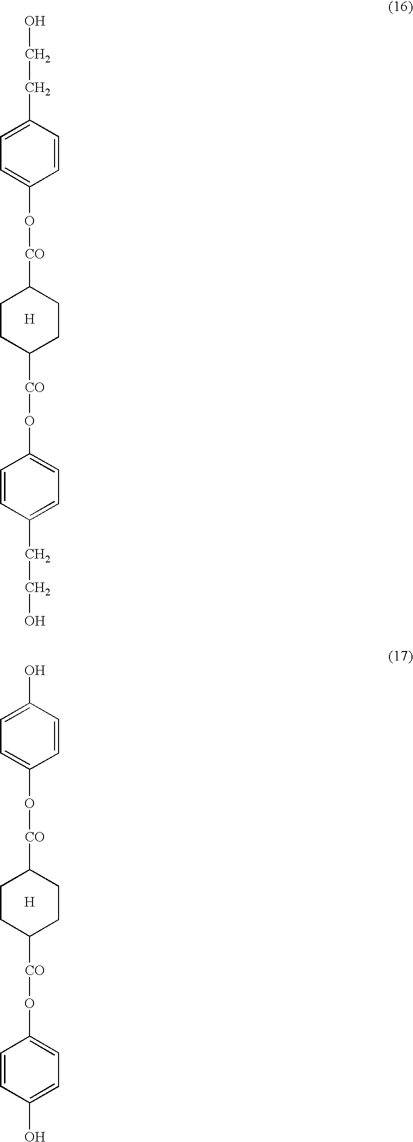

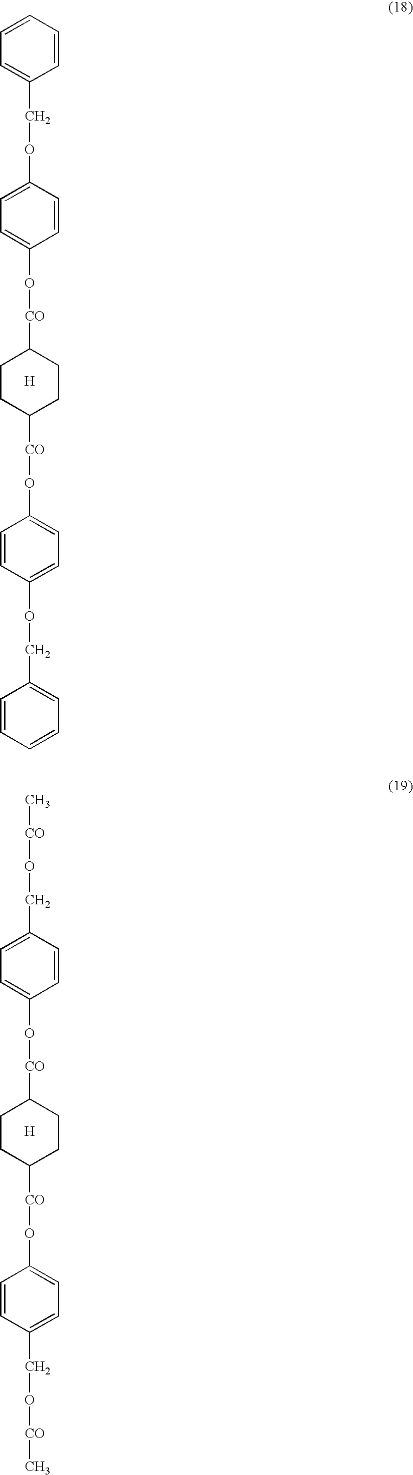

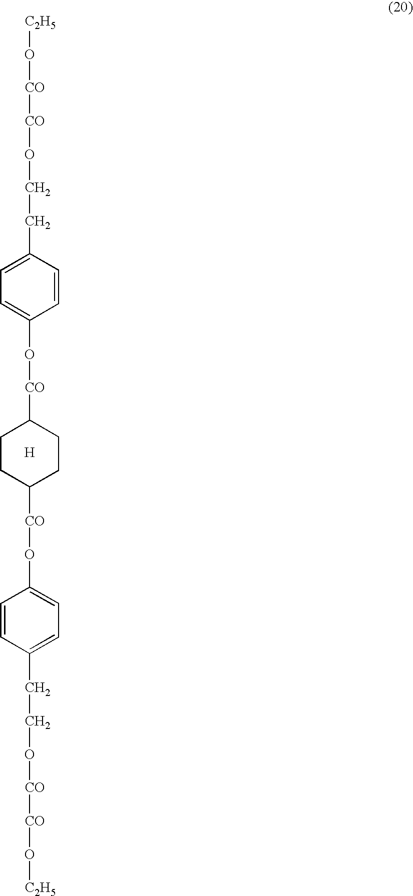

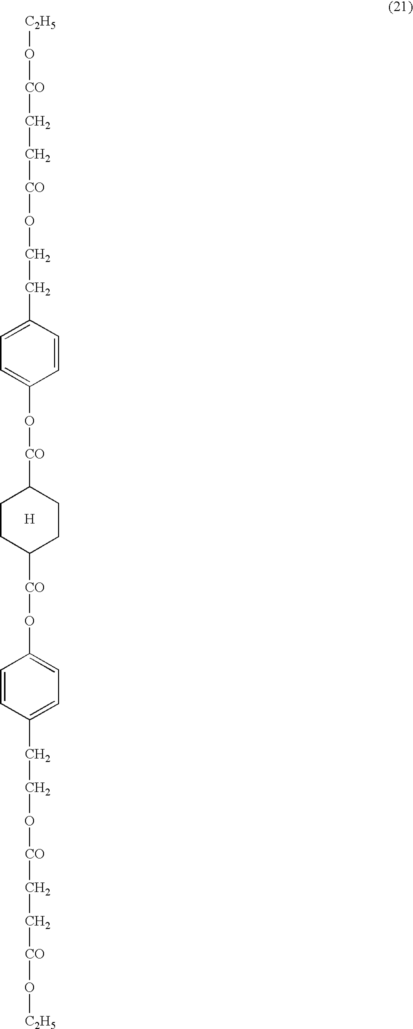

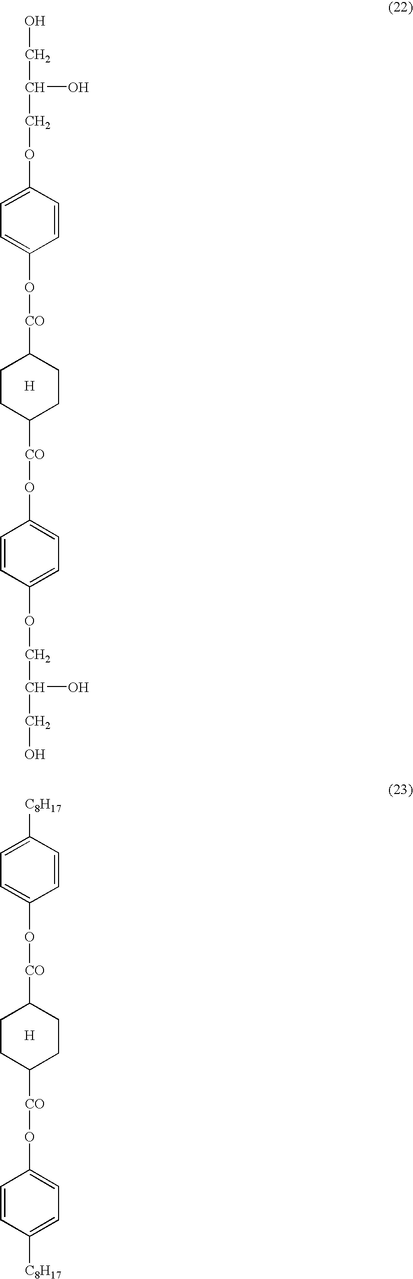

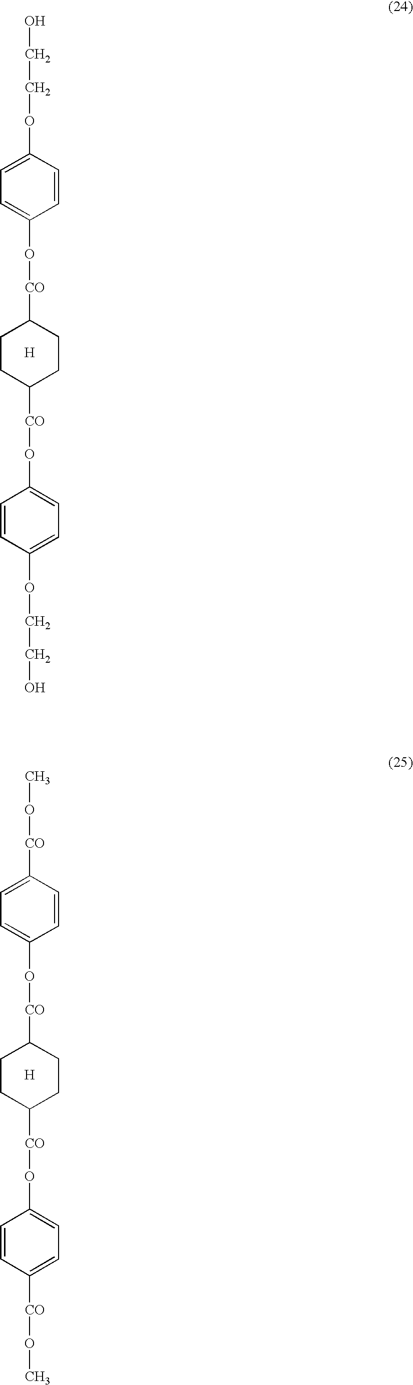

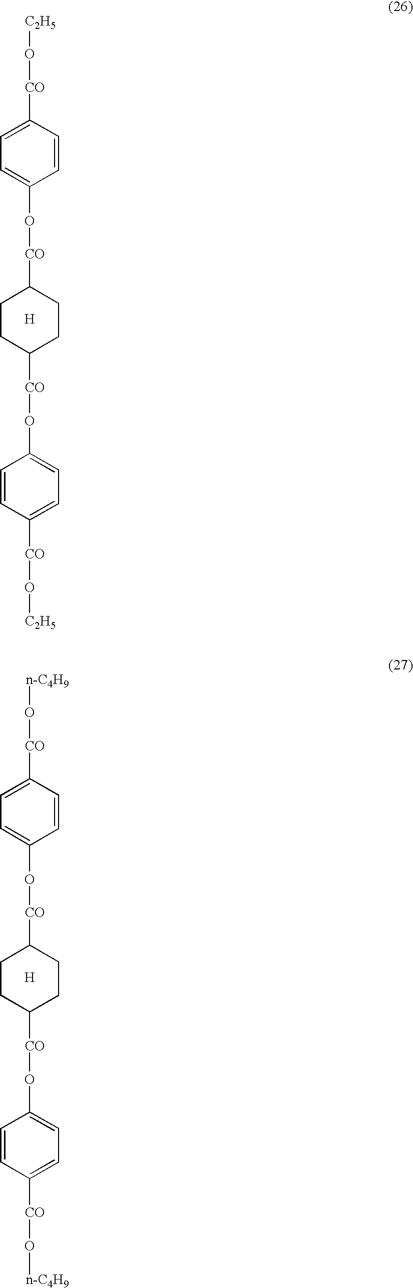

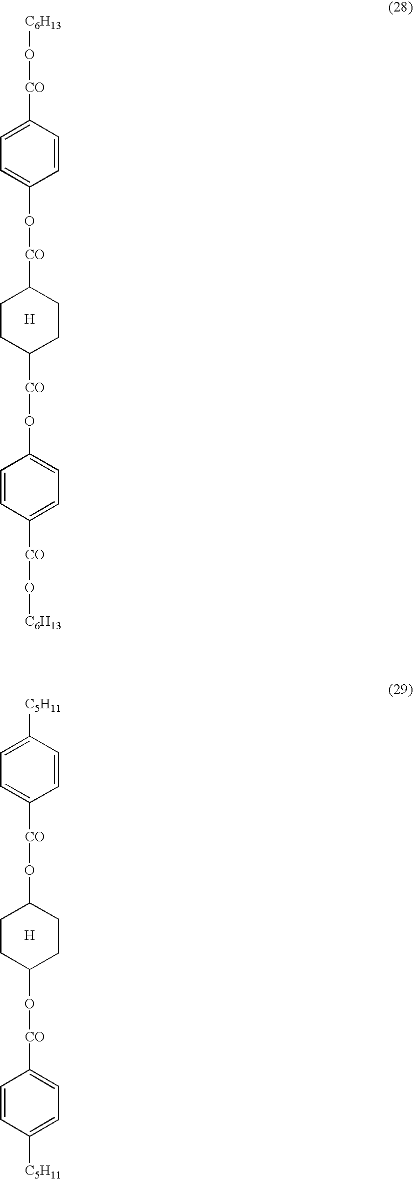

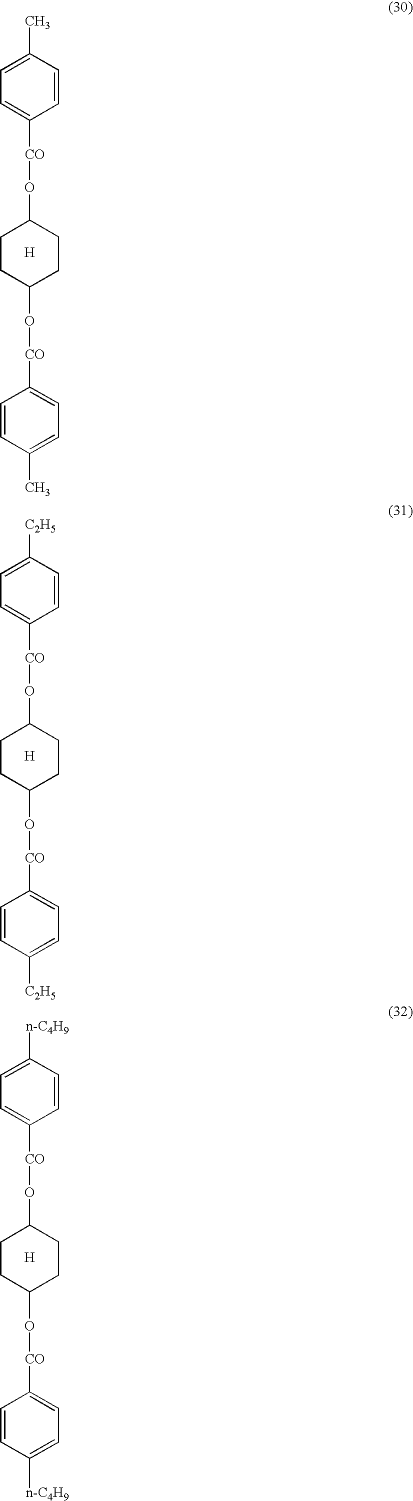

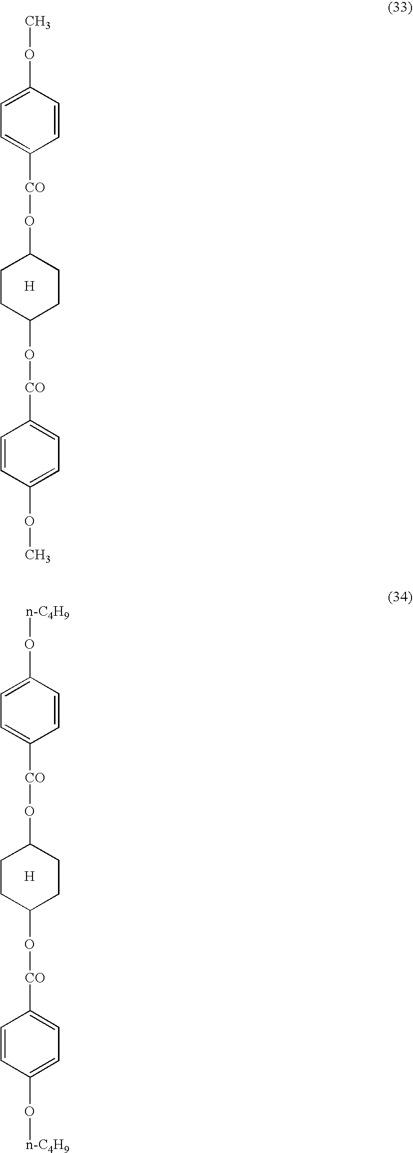

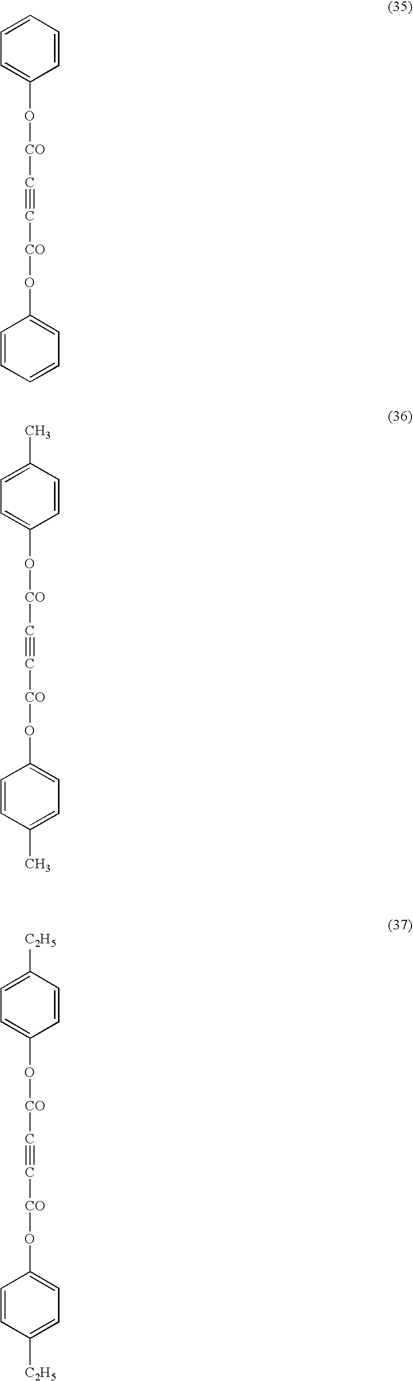

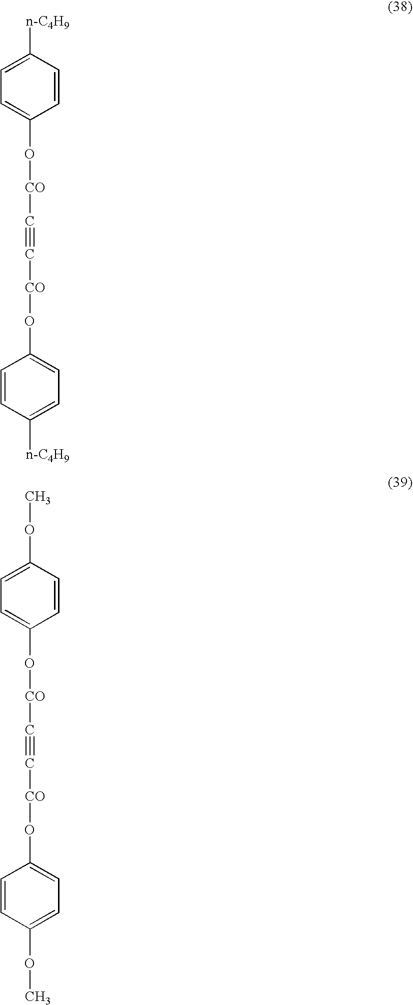

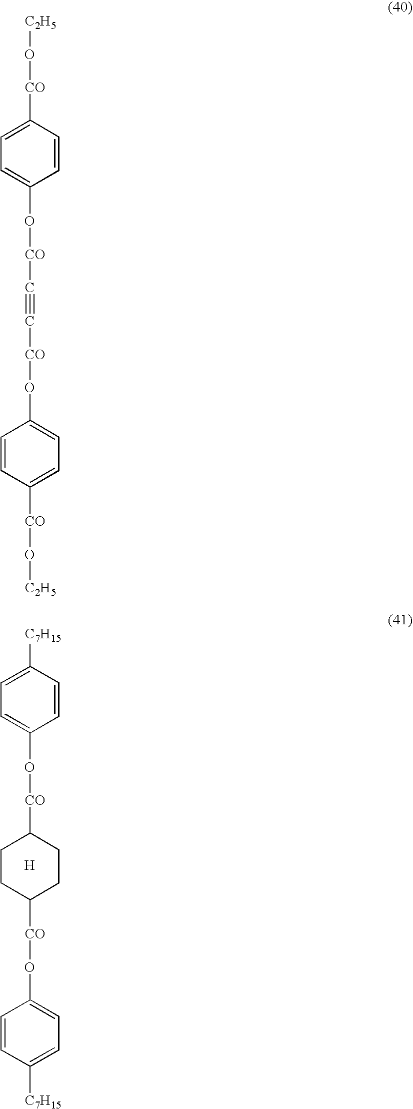

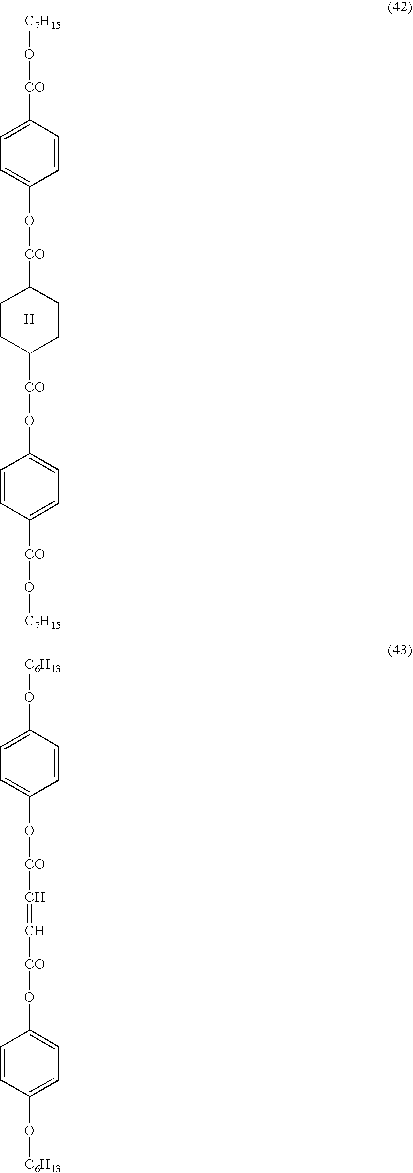

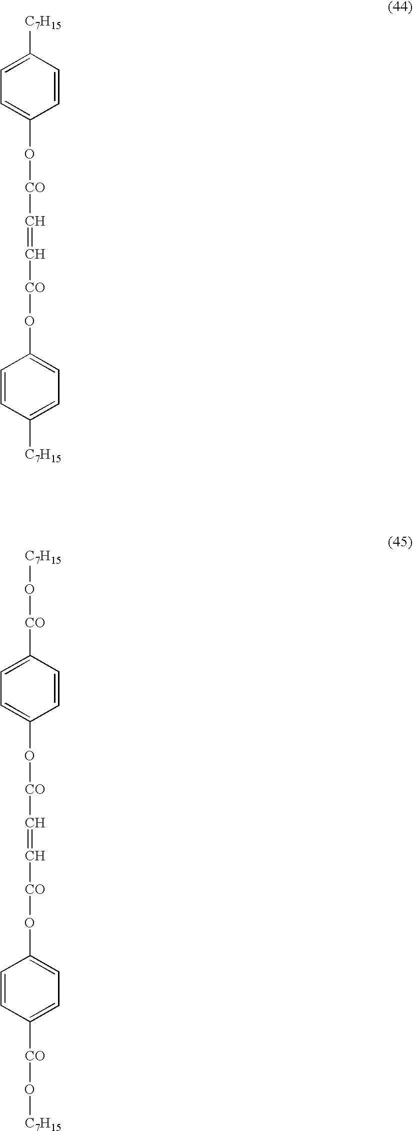

Specific examples (1) to (34), (41) and (42) have two asymmetric carbon atoms at the 1-position and 4-position of the cyclohexane ring. However, since specific examples (1), (4) to (34), (41) and (42) have a symmetric meso form molecular structure, they do not have an optical isomer (optical activity), and only a geometrical isomer (a trans form and a cis form) is present. A trans form (1-trans) and a cis form (1-cis) of specific example (1) are shown below.

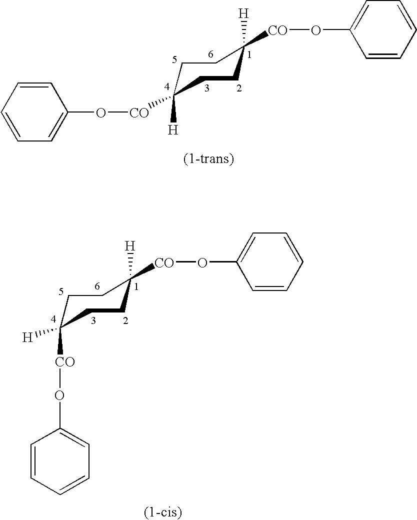

As described above, it is preferred that rod-like compounds have a linear molecular structure. Therefore, a trans form is preferred to a cis form.

Specific examples (2) and (3) have optical isomers (four kinds of isomers in total) in addition to geometrical isomers. With respect to a geometrical isomer, similarly a trans form is preferred to a cis form. There is no superiority or inferiority in optical isomers, and may be any of D, L or a racemic body.

In specific examples (43) to (45), there are a trans form and a cis form in the central vinylene bond. A trans form is preferred to a cis form for the same reason.

A compound represented by the following formula (3) is also preferred.

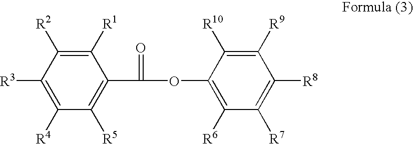

In formula (3), R¹, R², R³, R⁴, R⁵, R⁶, R⁷, R⁸, R⁹ and R¹⁰ each independently represents a hydrogen atom or a substituent, at least one of R¹, R², R³, R⁴ and R⁵ represents an electron donative group, R⁸ represents a hydrogen atom, an alkyl group having from 1 to 4 carbon atoms, an alkenyl group having from 2 to 6 carbon atoms, an alkynyl group having from 2 to 6 carbon atoms, an aryl group having from 6 to 12 carbon atoms, an alkoxyl group having from 1 to 12 carbon atoms, an aryloxy group having from 6 to 12 carbon atoms, an alkoxycarnonyl group having from 2 to 12 carbon atoms, an acylamino group having from 2 to 12 carbon atoms, a cyano group or a halogen atom.

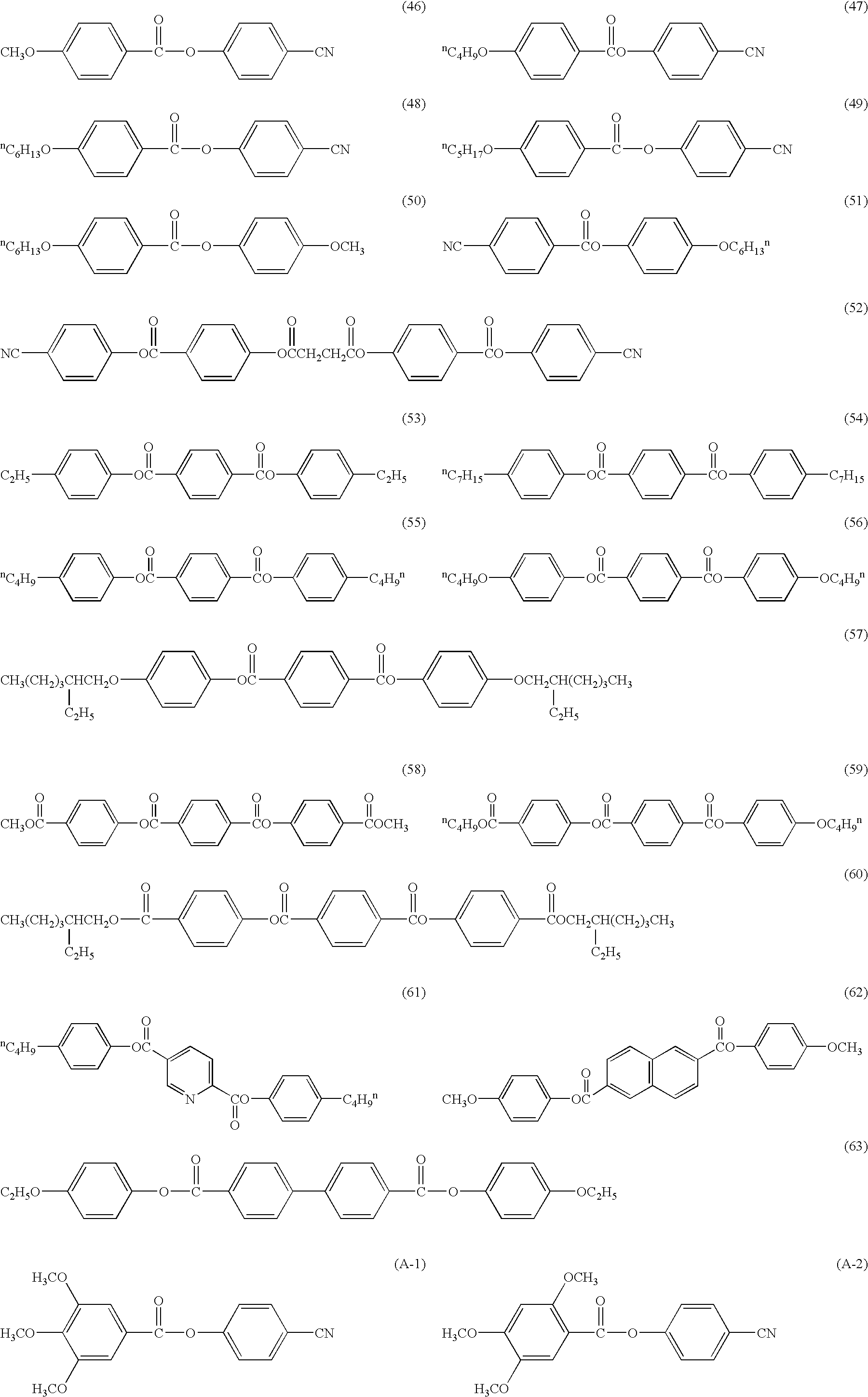

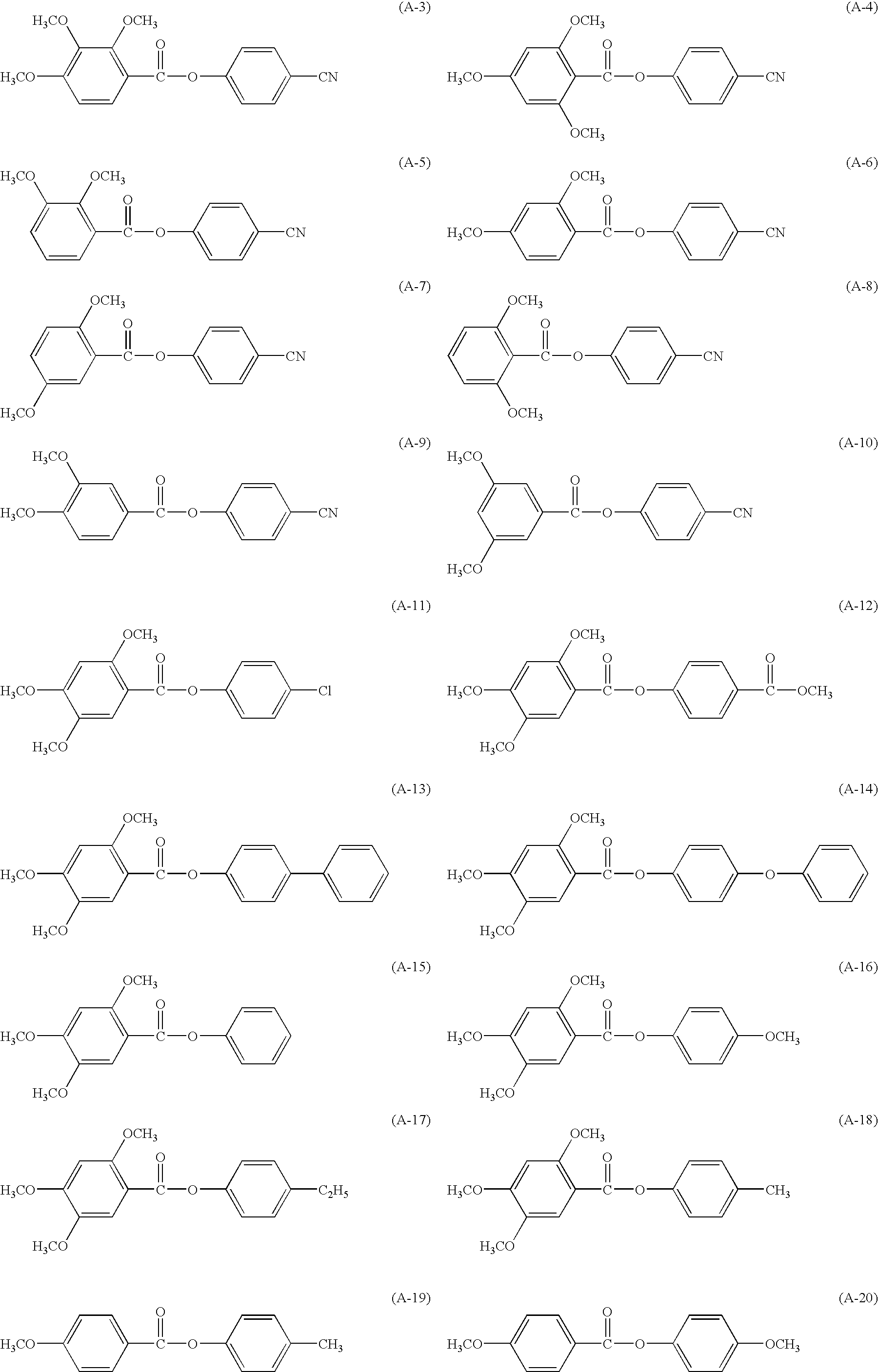

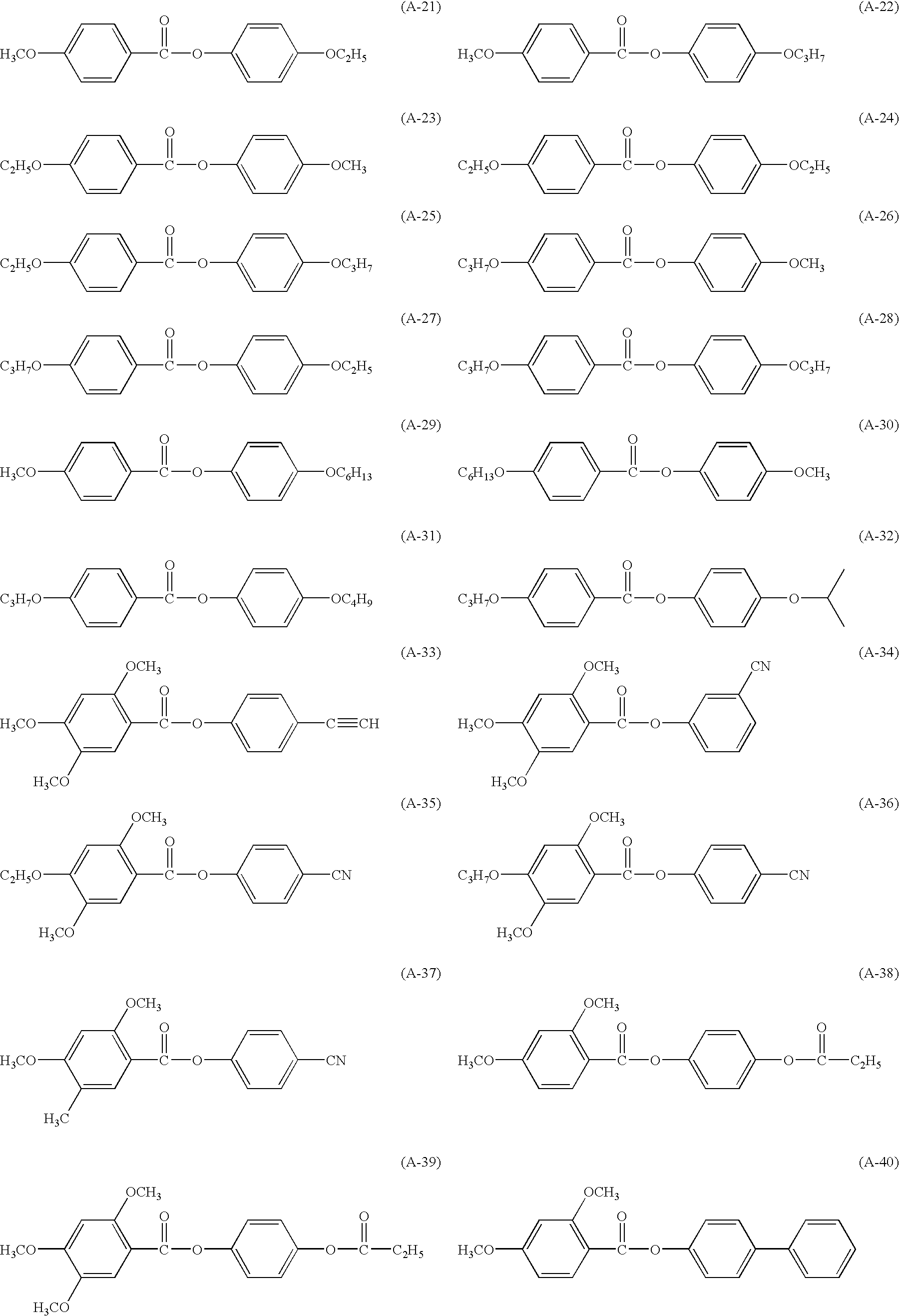

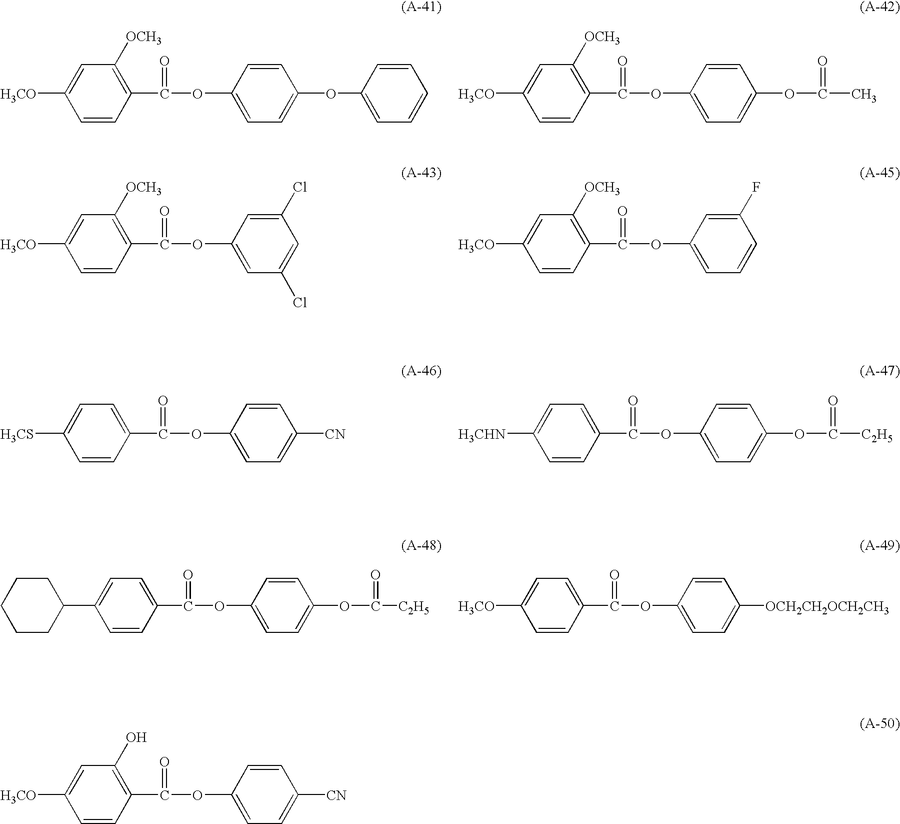

Rod-like compounds having maximum absorption (λmax) of 250 nm or shorter in UV absorption spectrum of a solution may be used in combination of two or more.

Rod-like compounds can be synthesized with reference to the methods described in various literatures, for example, Mol. Cryst. Liq. Cryst., Vol. 53, p. 229 (1979), ibid., Vol. 89, p. 93 (1982), ibid., Vol. 145, p. 111 (1987), ibid., Vol. 170, p. 43 (1989), J. Am. Chem. Soc., Vol. 113, p. 1349 (1991), ibid., Vol. 118, p. 5346 (1996), ibid.; Vol. 92, p. 1582 (1970), J. Org. Chem., Vol. 40, p. 420 (1975), and Tetrahedron, Vol. 48, No. 16, p. 3437 (1992) can be exemplified.

The addition amount of retardation increasing agents is preferably from 0.1 to 30 mass % of the amount of the polymer, more preferably from 0.5 to 20 mass %.

Aromatic compounds are preferably used in the range of from 0.01 to 20 mass parts per 0.100 mass parts of the cellulose acetate, more preferably used in the range of from 0.05 to 15 mass parts, and still more preferably used from 0.1 to 10 mass parts. Two or more aromatic compounds may be used in combination.

Organic solvents for dissolving cellulose acylate in the invention are described below.

### Chlorine Solvents:

In manufacturing a cellulose acylate solution in the invention, chlorine organic solvents are preferably used as the main solvents. The kinds of chlorine organic solvents are not especially restricted so long as cellulose acylate can be dissolved, cast to form a film to thereby achieve the object of the invention. Chlorine organic solvents are preferably dichloromethane and chloroform, and especially preferably dichloromethane. Organic solvents other than chlorine organic solvents can be blended with chlorine organic solvents with no problems. When other organic solvents are used, it is necessary to use at least 50 mass % of dichloromethane: Non-chlorine organic solvents that are used in the invention with chlorine organic solvents are described below.

As the non-chlorine organic solvents, solvents selected from ester, ketone, ether, alcohol and hydrocarbon each having from 3 to 12 carbon atoms are preferably used. The ester, ketone, ether and alcohol may have a cyclic structure. Compounds having any two or more functional groups of ester, ketone, and ether (i.e., —O—, —CO— and —COO—) can also be used as solvents, for example, other functional group, e.g., an alcoholic hydroxyl group, can be used at the same time. In the case of solvents having two or more functional groups, the carbon atom number may be in the range of the specification of the compounds having any functional groups. The examples of esters having from 3 to 12 carbon atoms include ethyl formate, propyl formate, pentyl formate, methyl acetate, ethyl acetate and pentyl acetate. The examples of ketones having from 3 to 12 carbon atoms include acetone, methyl ethyl ketone, diethyl ketone, diisobutyl ketone, cyclopentanone, cyclohexanone and methyl cyclohexanone. The examples of ethers having from 3 to 12 carbon atoms include diisopropyl ether, dimethoxymethane, dimethoxyethane, 1,4-dioxane, 1,3-dioxolan, tetrahydrofuran, anisole and phenetole. The examples of organic solvents having two or more functional groups include 2-ethoxyethyl acetate, 2-methoxyethanol and 2-butoxyethanol.

The alcohols to be used in combination with chlorine organic solvents may be straight chain, branched or cyclic, and saturated aliphatic hydrocarbons are especially preferably used. The hydroxyl groups of alcohols may be any of primary, secondary and tertiary. The examples of the alcohols include methanol, ethanol, 1-propanol, 2-propanol, 1-butanol, 2-butanol, t-butanol, 1-pentanol, 2-methyl-2-butanol and cyclohexanol. As the alcohols, fluorine alcohols can also be used. For example, 2-fluoroethanol, 2,2,2-trifluoroethanol, and 2,2,3,3-tetrafluoro 1-propanol are exemplified. The hydrocarbons may be straight chain, branched or cyclic. Both aromatic hydrocarbons and aliphatic hydrocarbons can be used. The aliphatic hydrocarbons may be saturated or unsaturated. The examples of the hydrocarbons include cyclohexane, hexane, benzene, toluene and xylene.

As the combinations of chlorine organic solvents that are preferred main solvents in the invention, the following combinations are exemplified but the invention is not limited thereto.
Dichloromethane/acetone/methanol/ethanol/butanol (75/10/5/5/5, mass parts)
Dichloromethane/acetone/methanol/propanol (80/10/5/5, mass parts)
Dichloromethane/acetone/methanol/butanol/cyclohexane (75/10/5/5/5, mass parts)
Dichloromethane/methyl ethyl ketone/methanol/butanol (80/10/5/5, mass parts)
Dichloromethane/acetone/methyl ethyl ketone/ethanol/isopropanol (75/8/5/5/7, mass parts)
Dichloromethane/cyclopentanone/methanol/isopropanol (80/7/5/8, mass parts)
Dichloromethane/methyl acetate/butanol (80/10/10, mass parts)
Dichloromethane/cyclohexanone/methanol/hexane (70/20/5/5, mass parts)
Dichloromethane/methyl ethyl ketone/acetone/methanol/ethanol (50/20/20/5/5, mass parts)
Dichloromethane/1,3-dioxolan/methanol/ethanol (70/20/5/5, mass parts)
Dichloromethane/dioxane/acetone/methanol/ethanol (60/20/10/5/5, mass parts)
Dichloromethane/acetone/cyclopentanone/ethanol/isobutanol/cyclohexane (65/10/10/5/5/5, mass parts)
Dichloromethane/methyl ethyl ketone/acetone/methanol/ethanol (70/10/10/5/5, mass parts)
Dichloromethane/acetone/ethyl acetate/ethanol/butanol/hexane (65/10/10/5/515, mass parts)
Dichloromethane/methyl acetoacetate/methanol/ethanol (65/20/10/5, mass parts)
Dichloromethane/cyclopentanone/ethanol/butanol (65/20/10/5, mass parts)

### Non-Chlorine Solvents:

In the next place, non-chlorine organic solvents preferably used in manufacturing a cellulose acylate solution in the invention are described. Non-chlorine organic solvents are not especially restricted so long as cellulose acylate can be dissolved, cast to form a film to thereby achieve the object of the invention. As the non-chlorine organic solvents, solvents selected from ester, ketone and ether each having from 3 to 12 carbon atoms are preferably used. The ester, ketone and ether may have a cyclic structure. Compounds having any two or more functional groups of ester, ketone, and ether (i.e., —O—, —CO— and —COO—) can also be used as main solvents, and may have other functional group, e.g., an alcoholic hydroxyl group. In the case of main solvents having two or more functional groups, the number of carbon atoms may be in the range of the specification of the compounds having any functional groups. The examples of esters having from 3 to 12 carbon atoms include ethyl formate, propyl formate, pentyl formate, methyl acetate, ethyl acetate and pentyl acetate. The examples of ketones having from 3 to 12 carbon atoms include acetone, methyl ethyl ketone, diethyl ketone, diisobutyl ketone, cyclopentanone, cyclohexanone, and methyl cyclohexanone. The examples of ethers having from 3 to 12 carbon atoms include diisopropyl ether, dimethoxymethane, dimethoxyethane, 1,4-dioxane, 1,3-dioxolan, tetrahydrofuran, anisole and phenetole. The examples of organic solvents having two or more functional groups include 2-ethoxyethyl acetate, 2-methoxyethanol and 2-butoxyethanol.

The non-chlorine organic solvents that are used for dissolving cellulose acylate are selected from various points of view as described above, and preferably as follows. The preferred solvents for cellulose acylate in the invention are mixed solvents of three or more kinds of solvents different from each other. The first solvent is at least one solvent selected from methyl acetate, ethyl acetate, methyl formate, ethyl formate, acetone, dioxolan and dioxane, or a mixed solvent of these solvents. The second solvent is selected from ketones having from 4 to 7 carbon atoms or acetoacetate, and the third solvent is selected from alcohols having from 1 to 10 carbon atoms or hydrocarbons, more preferably alcohols having from 1 to 8 carbon atoms. When the first solvent is a mixed solvent of two or more solvents, the second solvent may not be contained. The first solvent is more preferably methyl acetate, acetone, methyl formate, ethyl formate or a mixed solvent of these solvents. The second solvent is more preferably methyl ethyl ketone, cyclopentanone, cyclohexanone, methyl acetylacetate, or a mixed solvent of these solvents.

The alcohols of the third solvent may be straight chain, branched or cyclic, and saturated aliphatic hydrocarbons are especially preferred of hydrocarbons. The hydroxyl groups of the alcohols may be any of primary, secondary and tertiary. The examples of the alcohols include methanol, ethanol, 1-propanol, 2-propanol, 1-butanol, 2-butanol, t-butanol. 1-pentanol, 2-methyl-2-butanol and cyclohexanol. As the alcohols, fluorine alcohols can also be used. For example, 2-fluoroethanol, 2,2,2-trifluoroethanol, and 2,2,3,3-tetrafluoro-1-propanol are exemplified. The hydrocarbons may be straight chain, branched or cyclic. Both aromatic hydrocarbons and aliphatic hydrocarbons can be used.

The aliphatic hydrocarbons may be saturated or unsaturated. The examples of the hydrocarbons include cyclohexane, hexane, benzene, toluene and xylene. The alcohols and hydrocarbons as the third solvents may be used alone or in combination of two or more, and there are no restrictions.

The preferred specific examples of the third solvents include, as alcohols, methanol, ethanol, 1-propanol, 2-propanol, 1-butanol, and 2-butanol, and as hydrocarbons, cyclohexanol, cyclohexane and hexane, and of these solvents, methanol, ethanol, 1-propanol, 2-propanol and 1-butanol are especially preferred.

These three kinds of solvents are preferably used in the proportion of the first solvent of from 20 to 95 mass %, the second solvent of from 2 to 60 mass %, and the third solvent of from 2 to 30 mass %. It is more preferred that the proportion of the first solvent is from 30 to 90 mass %, the second solvent is from 3 to 50 mass %, and alcohol of the third solvent is from 3 to 25 mass %. It is still more preferred that the proportion of the first solvent is from 30 to 90 mass %, the second solvent is from 3 to 30 mass %, and alcohol of the third solvent is from 3 to 15 mass %. When the first solvent is a mixed solvent and the second solvent is not used, it is preferred that the first solvent is contained in the proportion of from 20 to 90 mass %, and the third solvent is contained in the proportion of from 5 to 30 mass %, and it is more preferred that the proportion of the first solvent is from 30 to 86 mass %, and the third solvent is from 7 to 25 mass %. The non-chlorine organic solvents for use in the invention are described in Hatsumei Kyokai Kokai Giho Kogi No. 2001-1745 (Mar. 15, 2001, published by Hatsumei Kyokai), on pages from 12 to 16 in detail. The preferred combinations of the non-chlorine organic solvents are shown below, but the invention is not limited thereto.
Methyl acetate/acetone/methanol/ethanol/butanol (75/10/5/5/5, mass parts)
Methyl acetate/acetone/methanol/ethanol/propanol (75/10/5/5/5, mass parts)
Methyl acetate/acetone/methanol/butanol/cyclohexane (75/10/5/5/5, mass parts)
Methyl acetate/acetone/ethanol/butanol (81/8/7/4, mass parts)
Methyl acetate/acetone/ethanol/butanol (82/10/4/4, mass parts)
Methyl acetate/acetone/ethanol/butanol (80/10/4/6, mass parts)
Methyl acetate/methyl ethyl ketone/methanol/butanol (80/10/5/5, mass parts)
Methyl acetate/acetone/methyl ethyl ketone/ethanol/isopropanol (75/8/5/5/7, mass parts)
Methyl acetate/cyclopentanone/methanol/isopropanol (80/7/5/8, mass parts)
Methyl acetate/acetone/butanol (85/10/5, mass parts)
Methyl acetate/cyclopentanone/acetone/methanol/butanol (60/15/14/5/6, mass parts)
Methyl acetate/cyclohexanone/methanol/hexane (70/20/5/5, mass parts)
Methyl acetate/methyl ethyl ketone/acetone/methanol/ethanol (50/20/20/5/5, mass parts)
Methyl acetate/1,3-dioxolan/methanol/ethanol (70/20/5/5, mass parts)
Methyl acetate/dioxane/acetone/methanol/ethanol (60/20/10/5/5, mass parts)
Methyl acetate/acetone/cyclopentanone/ethanol/isobutanol/cyclohexane (65/10/10/5/5/5, mass parts)
Methyl formate/methyl ethyl ketone/acetone/methanol/ethanol (50/20/20/5/5, mass parts)
Methyl formate/acetone/ethyl acetate/ethanol/butanol/hexane (65/10/10/5/5/5, mass parts)
Acetone/methyl acetoacetate/methanol/ethanol (65/20/10/5, mass parts)
Acetone/cyclopentanone/ethanol/butanol (65/20/10/5, mass parts)
Acetone/1,3-dioxolan/ethanol/butanol (65/20/10/5, mass parts)
1,3-Dioxolan/cyclohexanone/methyl ethyl ketone/methanol/ethanol/butanol (55/20/10/5/5/5, mass parts)

Further, a cellulose acylate solution can also be manufactured by the following methods.

A method of preparing a cellulose acylate solution by methyl acetate/acetone/ethanol/butanol (81/8/7/4, mass parts), filtering the solution to concentrate, and then adding 2 mass parts of butanol additionally to the filtrate.

A method of preparing a cellulose acylate solution by methyl acetate/acetone/ethanol/butanol (84/10/4/2, mass parts), filtering the solution to concentrate, and then adding 4 mass parts of butanol additionally to the filtrate.

A method of preparing s cellulose acylate solution by methyl acetate/acetone/ethanol (84/10/6, mass parts), filtering the solution to concentrate, and then adding 5 mass parts of butanol additionally to the filtrate.

### Characteristics of Cellulose Acylate Solution:

In the invention it is preferred that from 13 to 27 mass % of cellulose acylate is dissolved in an organic solvent, more preferably from 15 to 25 mass %, and especially preferably from 15 to 20 mass % of cellulose acylate is dissolved. For preparing cellulose acylate in the range of this concentration, a solution having the prescribed concentration may be prepared at the stage of dissolving cellulose acylate, or a solution having low concentration (e.g., from 9 to 14 mass %) is prepared in advance, and then the concentration may be raised to the prescribed concentration by a concentration process, or a solution having high concentration is prepared in advance, and then the concentration may be made lower to the prescribed concentration by adding various additives, and any method can be used in the invention, so long as a cellulose acylate solution can be prepared so as to reach the above concentration.

In the next place, it is preferred in the invention that the molecular weights of the aggregates of dilute cellulose acylate solutions obtained by diluting a cellulose acylate solution to 0.1 to 5 mass % with the organic solvent having the same composition are from 150,000 to 15,000,000. More preferably, the molecular weights of the aggregates are from 180,000 to 9,000,000. The molecular weight of the aggregate can be found by a static light scattering method. It is preferred to perform dissolution so that the square radius of inertia that can be found at the same time becomes from 10 to 200 nm. The more preferred square radius of inertia is from 20 to 200 nm. It is further preferred to perform dissolution so that the second virial coefficient is −2×10⁻⁴ to 4×10⁻⁴, more preferably the second virial coefficient is from −2×10⁻⁴ to 2×10⁻⁴.

The molecular weight of aggregate, the square radius of inertia, and the definition of the second virial coefficient are described. These were measured according to the following method by a static light scattering method. The measurement was performed in an attenuated region for reasons of the measuring instruments but the measured values reflect the behaviors of the dope of the invention in a high concentration region. In the first place, cellulose acylate is dissolved in a solvent for use in a dope to prepare solutions having concentrations of 0.1 mass %, 0.2 mass %, 0.3 mass % and 0.4 mass % respectively. For preventing moisture absorption, weighing was performed at 25° C. 10% RH by using cellulose acylate having been dried at 120° C. for 2 hours. Dissolution is performed according to a method adopted in the dissolution of a dope (normal temperature dissolution, cooling dissolution, high temperature dissolution). Subsequently, the solution and the solvent are filtered through a Teflon filter having a pore size of 0.2 μm. The static light scattering of the filtered solution is measured at 25° C. at angles of 30° to 140° with the intervals of 10®with a light scattering meter (DLS-700, manufactured by OTSUKA ELECTRONICS CO., LTD.). The obtained data are analyzed according to a Berry plotting method. As the refractive indexes necessary for the analysis, the values of the solvents found with an Abbe's refractometer are used. For the concentration gradient of refractive indexes (dn/dc), a differential refractometer (DRM-1021, manufactured by OTSUKA ELECTRONICS CO., LTD.) is used, and measurement is performed with the solvent and solution used in the light scattering measurement

### Preparation of Dope:

The dissolving method of a cellulose acylate solution (dope) in the invention is not especially restricted, and cellulose acylate may be dissolved by any of a normal temperature dissolution method, a cooling dissolution method, a high temperature dissolution method, or combination of these methods. The preparing methods of a cellulose acylate solution are disclosed in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017, and JP-A-11-302388. The dissolving techniques of cellulose acylate in organic solvents disclosed in these patents can be arbitrarily applied to the invention within the scope of the invention. The details thereof, in particular non-chlorine solvents, are described in Hatsumei Kyokai Kokai Giho Kogi No. 2001-1745 (on Mar. 15, 2001, published by Hatsumei Kyokai), pp. 22-25, and these methods can also be used in the invention. A dope solution in the invention is generally subjected to concentration and filtration, and these matters are also described in Hatsumei Kyokai Kokai Giho Kogi No. 2001-1745 (on Mar. 15, 2001, published by Hatsumei Kyokai), on page 25 in detail. When dissolution is carried out at high temperature, the temperature of dissolution is higher than the boiling points of organic solvents used in almost all the cases, and dissolution is performed under pressure in that case.

A cellulose acylate solution in the invention can be obtained in high concentration as described above, so that a dope of high concentration and excellent in stability can be obtained without relying upon a means of concentration. For further easy dissolution, a method of making a solution in low concentration and then increasing the concentration may be used. Concentrating methods are not limited, and a method of introducing a low concentration solution between a barrel and the rotary locus of the periphery of rotary blades rotating in the circumferential direction in the barrel and giving temperature difference between the barrel and the solution to thereby evaporate the solvent and obtain a high concentration solution (e.g., JP-A-4-259511), and a method of blowing a heated low concentration solution from a nozzle into a vessel, subjecting the solvent to flash evaporation during the time before the solution from the nozzle impinges on the wall of the vessel, at the same time, letting the solvent vapor out of the vessel, and taking the high concentration solution out of the vessel (e.g., U.S. Pat. Nos. 2,541,012, 2,858,229, 4,414,341 and 4,504,355) can be used.

It is preferred to remove foreign matters such as undissolved substances, dusts and impurities with an appropriate filter of wire screen or flannel prior to casting. For filtration of a cellulose acylate solution, filters having absolute filtration accuracy of from 0.1 to 100 μm are used, more preferably filters having absolute filtration accuracy of from 0.5 to 25 μm are used. The thickness of filters is preferably from 0.1 to 10 mm, more preferably from 0.2 to 2 mm. In this case, it is preferred to perform filtration at filtration pressure of preferably 1.6 MPa or less, more preferably 1.2 MPa or less, still more preferably 1.0 MPa or less, and especially preferably 0.2 MPa or less. As filter materials, well-known materials, e.g., glass fiber, cellulose fiber, filter paper, and fluorine resins, e.g., ethylene tetrafluoride resin, can be preferably used, and ceramics and metals are especially preferably used.

In the invention it is preferred that the coefficient of viscosity of a cellulose acylate solution is adjusted to a specific range. A coefficient of viscosity (unit: Pas) is measured of about 1 ml of a sample solution, e.g., with a stress rheometer (CVO 120, manufactured by Bohlin Instruments) under the conditions of dope temperature at 33° C., frequency of 1 Hz, and the application of a load of displacement of 1%.

The coefficient of viscosity of a solution can be adjusted with the characteristics of cellulose acylate and the concentration of cellulose acylate. As described in the synthesizing method, intrinsic viscosity characteristics of cellulose acylate can be varied by the adjustment of the viscosity average polymerization degree and the molecular weight distribution.

As described in the solution characteristics of cellulose acylate, the preferred concentration of cellulose acylate is between 13 and 27 mass %. As a result, the preferred coefficient of viscosity of a cellulose acylate solution obtained is from 10 to 70 Pas (measurement temperature: 33° C.), and when the viscosity is higher than this range, the fluidity becomes poor, so that filtration and casting are difficult, while when the viscosity is lower than this range, the internal pressure of casting die lowers and uniform casting in the breadth direction cannot be done, so that the variation in the breadth direction is liable to increase. The coefficient of viscosity of a dope is more preferably from 15 to 45 Pas, and most preferably from 20 to 35 Pas.

When the coefficient of viscosity is in the above range, load in filtration lessens, so that the use of filters having smaller pore size and higher accuracy is made possible. As a result, a cellulose acylate film in the invention contains little foreign matters, and it becomes possible to reduce the phenomenon of light leaking out and glistening, what is called luminescent spot inclusion, in black display in particular when the film is assembled into a liquid crystal display.

### Film Formation:

A manufacturing method of a film using a cellulose acylate solution is described below. As the manufacturing method and equipment of a cellulose acylate film of the invention, solution casting film-forming methods and solution casting film-forming apparatus conventionally used for manufacturing cellulose triacetate films can be used. A prepared dope (a cellulose acylate solution) is taken out of a dissolver (kiln) and once stored in a silo, and the dope is defoamed for final preparation. The dope is delivered to a pressure type die from a dope discharge port through, e.g., a pressure type volume regulating gear pump capable of highly accurate volume regulating feeding by number of revolutions, casting the dope uniformly on the metal support of a casting part endlessly running from the slit of the pressure type die, and a damp-dry dope film (also called web) is peeled from the metal support at peeling point where the metal support almost makes a round. Both ends of the web are clasped with clips, the web is conveyed by tenter with holding the breadth and dried, subsequently conveyed by the rollers of dryer to finish drying, and wound with a winder in a prescribed length. The combination of tenter with rollers of dryer varies according to purpose. In solution casting film-forming methods used for functional protective films for electronic display, in addition to the solution casting film-forming apparatus, a coating apparatus is additionally equipped in many cases for surface processing of, e.g., a subbing layer, an antistatic layer, an antihalation layer, a protective layer, etc. Each manufacturing process is described briefly, but the invention is not limited thereto.

The prepared cellulose acylate solution (dope) is cast on a drum or a band by a solvent cast method in manufacturing a cellulose acylate film to thereby evaporate the solvent and form a film. It is preferred to adjust the concentration of a dope before casting so that the solids content is from 5 to 40 mass %. It is preferred to planish the surface of a drum or a band beforehand. It is preferred to cast a dope on the surface of a drum or a band of 30° C. or lower, and it is more preferred that a dope be cast on a metal support of a temperature of from −10 to 20° C.

Further, the techniques disclosed in the following patents can be applied to the invention: JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650.

### Multilayer Casting:

A cellulose acylate solution may be cast on a metal support, e.g., a smooth band or a drum, as a single layer solution, or two or more cellulose acylate solutions may be cast. In the case of casting a plurality of cellulose acylate solutions, the cellulose acylate solutions may be cast from a plurality of casting heads provided with intervals in the proceeding direction of the metal support to thereby form a film while lamination, and the methods disclosed in JP-A-61-158414, JP-A-1-122419 and JP-A-11-198285 can be applied to the invention.

It is also preferred to form a film by casting cellulose acylate solutions from two casting heads and the methods disclosed, e.g., in JP-B-60-27562 (the term “JP-B” as used herein means an “examined Japanese patent publication”), JP-A-61-94724, JP-A-61-947245, JP-A-61-104813, JP-A-61-158413 and JP-A-6-134933 can be used for manufacture. Further, it is also preferred to use a cellulose acylate film casting method of wrapping the flow of a highly viscous cellulose acylate solution with a low viscous cellulose acylate solution and extruding the high and low viscous cellulose acylate solutions simultaneously as disclosed in JP-A-56-162617. As another method, it is also preferred for the outside solution to contain an alcohol-component of bad solvent in larger amount than the inside solution as disclosed in JP-A-61-94724 and JP-A-61-94725. Alternatively, a method of forming a film with two casting heads and peeling a formed film on a metal support by the first casting head, and then casting by the second casting head on the side in contact with the surface of the metal support may be used, as disclosed in JP-B-44-20235. The cellulose acylate solutions may be the same solutions or different solutions and not particularly restricted. For providing functions to a plurality of cellulose acylate layers, it is effective to extrude a cellulose acylate solution corresponding to each function from each casting head. Further, other functional layers (e.g., an adhesive layer, a dye layer, an antistatic layer, an antihalation layer, a UV absorbing layer, a polarizing layer, etc.) can be cast at the same time by cellulose acylate solutions.

For obtaining a necessary film thickness by a conventional single layer solution, it is necessary to extrude a highly concentrated and highly viscous cellulose acylate solution, in that case the stability of the cellulose acylate solution is bad, solid matters are generated, and accompanied by the problems of a failure due to the solid matters and planar failure. As the measure against this problem, by casting a plurality of cellulose acylate solutions from casting heads, highly viscous solutions can be extruded at the same time on a metal support, as a result not oily a planar property can be bettered and a film having a good face property can be formed, but also a drying load can be reduced by using a concentrated cellulose acylate solution and film production speed can be heightened.

In the case of co-casting, the film thickness of the outside and inside is not especially restricted, but preferably the outside thickness is from 1 to 50% of the total film thickness, more preferably from 2 to 30%. In the case of co-casting of three or more layers, the total film thickness of the layer in contact with a metal support and the layer in contact with air is defined as the outside thickness. In the case of co-casting, a cellulose acylate film of a lamination structure can be formed by co-casting cellulose acylate solutions different in the concentrations of additives such as plasticizers, UV absorbers and matting agents. For example, a cellulose acylate film having a structure of skin layer/core layer/skin layer can be formed. For instance, a large amount of a matting agent can be added to a skin layer, or only to a skin layer. A greater amount of a plasticizer and a UV absorber can be added to a core layer than the amount in the skin layer, or may be added only to a core layer. The kinds of a plasticizer and a UV absorber can be changed in a skin layer and a core layer. For instance, low volatile plasticizer and/or UV absorber can be added to a skin layer, and a plasticizer having excellent plasticizing property or a UV absorber having excellent UV-absorbing property can be added to a core layer. It is also a preferred embodiment to add a peeling accelerator only to a skin layer on the side of a metal support. It is also preferred to add a greater amount of bad solvent alcohol to a skin layer than the amount in a core layer for gelling the solution by cooling a metal support according to a cooling drum method. Tg's of a skin layer and a core layer may be different, and it is preferred that the Tg of a core layer is lower than the Tg of a skin layer. The viscosities of solutions containing cellulose acylate in casting may be different between a skin layer and a core layer, and it is preferred that the viscosity of a skin layer is smaller than that of a core layer, but the viscosity of a core layer may be smaller than that of a skin layer.

### Casting:

As the casting methods of a solution, there are a method of uniformly extruding a prepared dope on a metal support from a pressure die, a method of adjusting the film thickness of a dope once cast on a metal support with a blade according to a doctor blade method, and a reverse roll method of adjusting the film thickness of a dope with a reverse rotating roll, and a method by a pressure die is preferred. There are a coat hanger type and a T die type in the pressure die, and both types can be preferably used. Other than the above shown methods, various conventionally known methods can be used for making films by casting cellulose triacetate solutions, and the similar effects to those described in respective patents can be obtained by setting the film-forming conditions considering the difference of the boiling points and the like of the solvents to be used. As a metal support for use in endless running for manufacturing a cellulose acylate film of the invention, a drum the surface of which is planished by chromium plating and a stainless steel belt (or band) planished by surface polishing are used. As the pressure die for use in manufacturing a cellulose acylate film in the invention, one die may be installed on the upper part of a metal support or two or more dies may be equipped, preferably one or two. When two or more dies are installed, the amount of dope to be cast may be divided into various proportions to respective dies, or the dope may be fed to respective dies in respective proportions from a plurality of precision volume regulating gear pumps. The temperature of a cellulose acylate solution used in casting is preferably from −10 to 55° C., more preferably from 25 to 50° C. Every process may be the same temperature or may be different in each process. When the temperature is different, it is sufficient that the desired temperature is secured just before casting.

### Drying:

Drying of a dope on a metal support in cellulose acylate film manufacture is generally performed by a method of blowing hot air from the surface side of a metal support (a drum or a belt), i.e., from the surface side of a web on a metal support, a method of blowing hot air from the back surface of a drum or a belt, or a liquid heat transfer method of bringing temperature-controlled liquid into contact with the back surface of a belt or a drum opposite to the side of dope casting, heating the drum or the belt by heat transfer to thereby control the surface temperature, and a back surface liquid heat transfer method is preferred of these methods. The surface temperature of a metal support before casting may be any degree so long as it is lower than the boiling point of the solvent used in the dope. However, for expediting drying and getting rid of fluidity on a metal support, the temperature is preferably set at a temperature lower than the boiling point of the solvent having the lowest boiling point by 1 to 10° C. This rule, however, does not apply to the case where a cast dope is peeled off without cooling and drying.

### Stretching Treatment:

Retardation of a cellulose acylate film in the invention can be adjusted by stretching treatment. There are methods of intentionally stretching a film in the breadth direction, and the methods are disclosed in JP-A-62-115035, JP-A-4-152125, JP-A-4-284211, JP-A-4-298310 and JP-A-11-48271. For raising the in-plane retardation of a cellulose acylate film, a manufactured film is stretched.

Stretching of a film is performed in room temperature or under heating. The heating temperature is preferably lower than the glass transition temperature of a film. Stretching of a film may be monoaxial stretching in only perpendicular or horizontal direction, or may be simultaneous or successive biaxial stretching. Stretching is generally from 1 to 200% stretching, preferably from 1 to 100% stretching, and especially preferably from 1 to 50% stretching. In birefringence of an optical film, it is preferred that a refractive index in the breadth direction is greater than a refractive index in the length direction. Accordingly, it is preferred to perform greater stretching in the breadth direction. Stretching may be performed during the film forming process or a formed and wound web may be subjected to stretching treatment. In the former case, stretching may be carried out while containing a residual solvent and stretching can be performed at a residual solvent amount of from 2 to 30%.

In the invention the thickness of a finished (after drying) cellulose acylate film varies according to purpose, but it is generally in the range of from 5 to 500 μm, preferably from 20 to 300 μm, and from 40 to 110 μm is especially preferred for a VA liquid crystal display. On the other hand, by making the film thickness 110 to 180 μm, a drying load in film formation by casting increases, but the magnitude of optical characteristics is in proportion to a film thickness, so that desired optical characteristics can be obtained by increasing the film thickness. Since moisture permeability decreases in inverse proportion to a film thickness, moisture permeability decreases by increasing the film thickness and it becomes harder to permeate moisture, which is advantageous in a durability test of a polarizing plate at 60° C. 90% RH for 500 hours.

A film thickness can be adjusted to a desired thickness by adjusting the solid concentration in a dope, the gap of a die head, extrusion pressure from a die and the speed of a metal support. The breadth of a cellulose acylate film thus obtained film is preferably from 0.5 to 3 m, more preferably from 0.6 to 2.5 m, and still more preferably from 0.8 to 2.2 in. The length of a film to be wound is preferably from 100 to 10,000 m per a role, more preferably from 500 to 7,000 m, and still more preferably from 1,000 to 6,000 m. In winding, it is preferred to provide knurling at least on one end of a film, and the breadth is preferably from 3 to 50 mm, more preferably from 5 to 30 mm, the height is from 1 to 50 μm, preferably from 2 to 20 μm, and more preferably from 3 to 10 μm. The knurling may be single action pressing or double action pressing.

The film thickness difference in the breadth direction exclusive of knurled part is preferably 5 μm or less, more preferably 3 μm or less. When the film thickness difference in the breadth direction is great, deformation called a black belt attributable to the film thickness unevenness is liable to occur when a long sized film exceeding 4,000 m is wound. The sudden film thickness variation in a narrow breadth is not only seen as perpendicular streaky abnormality in appearance but also is liable to cause luminance unevenness when the film is assembled into a liquid crystal display, so that particularly problematic. It is preferred that when a film thickness is measured continuously in the breadth direction, the thickness difference between every 10 mm is 0.6 μm or less, and the thickness difference between every 10 mm is preferably 0.5 μm or less.

A haze value for maintaining transparency is preferably from 0.01 to 2%. For lessening the haze value, it is effective to lessen the number of agglomerated particles by thorough dispersion of a fine particle matting agent added, or a matting agent is added only to a skin layer to reduce the addition amount.

### Optical Characteristics of Cellulose Acylate Film:

The optical characteristics Re retardation value and Rth retardation value of a cellulose acylate film in the invention respectively satisfy the following equations (V) and (VI).

46 nm≦Re(630)≦200 nm (V)

70 nm≦Rth(630)≦350 nm (VI)

In equations (V) and (VI), Re (λ) is an in-plane retardation value at wavelength λ nm (unit: nm), and Rth (λ) is a retardation value in the film thickness direction at wavelength λ nm (unit: nm).

Re (λ) can be measured by projecting rays of light of wavelength λ nm in the direction of normal line of the film with a birefringence refractometer, e.g., KOBRA 21 ADH (manufactured by Oji Scientific Instruments). Rth (λ) can be computed by inputting the virtual value of average refractive index 1.48 and a film thickness, based on retardation values measured in three directions of the above Re (λ), the retardation value measured by projecting rays of light of wavelength λ in from the direction inclined by +40′ to the direction of normal line of the film with the in-plane retardation axis as the inclined axis, and the retardation value measured by projecting rays of light of wavelength 1 nm from the direction inclined by −40° to the direction of normal line of the film with the in-plane retardation axis as the inclined axis.

It is more preferred to satisfy the following equations (VII) and (VIII).

46 nm≦Re(630)≦100 nm (VII)

160 nm≦Rth(630)≦350 nm (VIII)

It is preferred for a VA liquid crystal display using only one optical film, a polarizing plate of the invention, to satisfy the following equations (IX) and (X) in addition to equations (VII) and (VIII).

Rth(630)=a−5.9Re(630) nm (IX)

520≦a≦600 nm (X)

The central value of y intercept a of a straight line represented by equation (IX) is 560 nm, and with the deviation of a from 560 to lower side, the black luminance value of VA liquid crystal display becomes great. That is, light leakage occurs and black becomes not black. With the deviation of a from 560 to upper side, the change in tint becomes great according to the angle of viewing the liquid crystal display, so that not preferred. Equation (X) shows the latitude of a value. In particular, for a VA liquid crystal display using only one polarizing plate, 55 nm≦Re (630)≦85 nm, and 535≦a≦585 nm are preferred. Re (630) and Rth (630) vary according to the Δnd value of VA liquid crystal cell to be used. For instance, when the Δnd value of VA liquid crystal cell is 300 nm, the most preferred Re (630) and Rth (630) are respectively from 55 to 60 and from 185 to 275. When the Δnd value of VA liquid crystal cell is 300 nm, the most preferred Re (630) and Rth (630) are respectively from 60 to 65 and from 160 to 240.

It is preferred that the dispersion of Re value of all the breadth is preferably ±5 nm, more preferably ±3 nm. The dispersion of Rth value is preferably ±10 nm, more preferably ±5 nm. It is also preferred that the dispersions of Re value and Rth value in the machine direction are also in the range of the dispersions of the breadth direction.

The optical characteristic values of Re and Rth vary with the humidity change and mass change by high temperature aging. The variation of Re and Rth values is preferably as small as possible. For reducing the change of optical characteristics by humidity, the moisture permeability and equilibrium moisture content of a film can be reduced by using cellulose acylate having a large acyl substitution degree at the 6-position, and various hydrophobic additives (plasticizers, retardation increasing agents, UV absorbers, etc.). The preferred moisture permeability at 60° C. 95% RH for 24 hours is from 400 to 2,300 g/m². The preferred equilibrium moisture content at 25° C. 80% RH is 3.4% or less. It is preferred that the variations of optical characteristics at the time when the humidity at 25° C. is changed from 10% RH to 80% RH are 12 nm or less in Re value and 32 nm or less in Rth value. The preferred addition amount of hydrophobic additives is from 10 to 30% based on the cellulose acylate, more preferably from 12 to 25%, and especially preferably from 14.5% to 20%. When the mass change and the dimensional change of a film occur due to the volatility and decomposability of additives, optical characteristics vary. Accordingly, it is preferred that the mass change of a film after aging at 80° C. 90% RH for 48 hours is 5% or less. Similarly, the dimensional change after aging at 60° C. 90% RH for 24 hours and after aging at 90° C. 3% RH for 24 hours is preferably ±2% or less. Further, even when dimension change and mass change occur a little, the variation of optical characteristics decreases when the photo-elastic modulus of a film is small. Accordingly, the photo-elastic modulus of a film is preferably 50×10⁻¹³ cm²/dyn (50×10⁻¹⁰ m²/N) or less.

### Polarizing Plate:

A polarizing plate consists of a polarizer and two sheets of transparent protective film provided on both sides of the polarizer. A cellulose acylate film in the invention can be used as one protective film. Ordinary cellulose acetate films may be used as other protective film. As polarizers, an iodine polarizer, a dye polarizer using two-color dyes and a polyene polarizer are known. Iodine polarizers and dye polarizer are generally manufactured with polyvinyl alcohol films. When a cellulose acylate film in the invention is used as the protective film of a polarizing plate, the manufacturing method of the polarizing plate is not especially restricted and ordinary methods can be used. There is a method of alkali processing an obtained cellulose acylate film, and sticking the film on both sides of a polarizer obtained by immersing and stretching a polyvinyl alcohol film in an iodine solution by using a completely saponified vinyl alcohol aqueous solution. In place of alkali processing, easy adhesion process as disclosed in JP-A-6-94915 and JP-A-6-118232 may be used. As adhesives for use for adhering a protective film and a polarizer, polyvinyl alcohol adhesive, e.g., polyvinyl alcohol and polyvinyl butyral, and vinyl latex, e.g., butyl acrylate are exemplified. A polarizing plate consists of a polarizer and protective films to protect both sides of the polarizer. Further, a protective film is stuck on one side of the polarizing plate, and a separate film on the other. The protective film and separate film are used for the purpose of protecting the polarizing plate at the time of shipping and inspection of the polarizing plate. In this case, the protective film is stuck for the purpose of protecting the surface of the polarizing plate, and the protective film is stuck on the side opposite to the side to be adhered with a liquid crystal plate. The separate film is used for the purpose of covering an adhesive layer to be adhered to a liquid crystal plate, and is adhered to the side of the polarizing plate to be adhered to a liquid crystal plate.

A sticking method of a cellulose acylate film in the invention to a polarizer is preferably such that the polarizer and the cellulose acylate film are stuck so that the transmission axis of the polarizer and the retardation axis of the cellulose acylate film coincide with each other. As a result of evaluation of a polarizing plate manufactured under polarizing plate crossed nicols, it was found that when the crossed accuracy of the retardation axis of the cellulose acylate film and the absorption axis (axis crossed to transmission axis) of the polarizer is greater than 1°, polarizing property under polarizing plate crossed nicols lowers and light missing occurs. In this case, sufficient black level and contrast cannot be obtained by the combination with a liquid crystal cell. Accordingly, it is preferred that the deviation of the direction of the main refractive index nx of a cellulose acylate film in the invention from the direction of the transmission axis of the polarizing plate is 1° or less, more preferably 0.5° or less.

Single transmittance TT, parallel transmittance PT and cross transmittance CT of a polarizing plate are measured with UV3100PC (manufactured by Shimadzu Corporation). Measurement was performed at wavelength region of from 380 to 780 nm of each of single transmittance, parallel transmittance and cross transmittance, and an average value of the measurement of 10 times was taken. Durability tests of a polarizing plate were two kinds of (1) a polarizing plate alone, and (2) a polarizing plate adhered to a glass plate with an adhesive. In the measurement of a polarizing plate alone, an optical compensation film was sandwiched between two polarizers, and two same samples were prepared. A sample (about 5 cm×5 cm) of test (2) was prepared by adhering a polarizing plate on a glass plate so that an optical compensation film was on the side of the glass plate, and two same samples were prepared. In the measurement of single transmittance, the sample was set with the film side to a light source. Two samples were measured and the average value was taken as single transmittance. As preferred ranges of a polarizing property, single transmittance TT, parallel transmittance PT and cross transmittance CT are respectively 40.0≦TT≦45.0, 30.0≦PT≦40.0, CT≦2.0, and more preferably 41.0≦TT≦44.5, 34≦PT≦39.0, CT≦1.3 (unit is %). In a durability test of a polarizing plate, the variation is preferably as small as possible.

When a polarizing plate in the invention is allowed to stand at 60° C. 95% RH for 500 hours, the variation ΔCT (%) of crossed single transmittance and the variation ΔP of polarization degree satisfy at least one of the following equations (j) and (k)

−6.0≦ΔCT≦6.0 (j)

−10.0≦ΔP≦0.0 (k)

Here, the variation means a value obtained by subtracting the measured value before test from the measured value after test.

By satisfying the requisite, stability of the polarizing plate during use or preservation is secured

### Moisture-Proof Bag:

In the invention, “a moisture-proof bag” is prescribed by the moisture permeability measured according to a cylinder plate method (JIS Z208). It is preferred to use materials having moisture permeability of 30 g/(m²·Day) or lower at 40° C. 90% RH. When moisture permeability is 30 g/(m²·Day) or higher, it is difficult to prevent the influence of the environmental moisture of the outside of the bag. Moisture permeability of 10 g/(m²·Day) or lower is more preferred, and 5 g/(m²·Day) or lower is most preferred.

The materials of the moisture-proof bag are not especially restricted so long as the above moisture permeability is satisfied, and well-known materials can be used. (Refer to Hoso Zairyo Binran (Handbook of Packaging Materials), Nippon Hoso Gijutsu Kyokai (1995), Hoso Zairyo no Kiso Chishiki (Elementary Knowledge of Packaging Materials), Nippon Hoso Gijutsu Kyokai (November, 2001), Kinosei Hoso Nyumon (Introduction to Functional Package), First Ed., 21 Seiki Hoso Kenkyu Kyokai (Feb. 28, 2002).) In the invention, materials low in moisture permeability, light weight and easy to handle are preferred. Composite materials such as plastic films deposited with silica, alumina or ceramics, and laminated films of plastics and aluminum foil are especially preferably used. The thickness of aluminum foil is not particularly limited so long as the moisture in the bag is not influenced by the environmental moisture, preferably from several μm to several 100 μm, more preferably from 10 to 500 μm. It is preferred that the moisture in a moisture-proof bag in the invention satisfies any of the following conditions.

Preferably from 43% RH to 70% RH at 25° C. in the state of packaging a polarizing plate, more preferably from 45% to 65%, and still more preferably from 45% to 63%.

The difference between the humidity in the bag packaging a polarizing plate and the humidity at the time of sticking a polarizing plate on a liquid crystal panel is 15% RH or less.

### Surface Treatment:

By treating the surface of a cellulose acylate film in the invention, the adhesion of the cellulose acylate film and other functional layers (e.g., an undercoat layer and a backing layer) can be improved. As the surface treatment, e.g., glow discharge treatment, UV irradiation treatment, corona treatment, flame treatment, and acid or alkali treatment can be used. The glow discharge treatment may be low temperature plasma treatment in low-pressure gas of 10⁻³ to 20 Torr, or may be plasma treatment in the atmospheric pressure. Plasma exciting gas is gas capable of plasma excitation under the above condition, e.g., argon, helium, neon, krypton, xenon, nitrogen, carbon dioxide and fluorocarbons, e.g., tetrafluoromethane, and mixtures of these gases are exemplified. These treatments are described in detail in Hatsumei Kyokai Kokai Giho Kogi No. 2001-1745 (on Mar. 15, 2001, published by Hatsumei Kyokai), pp. 30-32. Plasma treatment in the atmospheric pressure now attracting public attention uses irradiation energy of from 20 to 500 kGy at 10 to 1,000 keV, preferably from 20 to 300 kGy at 30 to 500 keV. Alkali saponification treatment is especially preferred for the surface treatment of cellulose acylate film.

Alkali saponification treatment is preferably performed by a method of directly immersing a cellulose acylate film in a saponification solution tank, or a method of coating a saponification solution on a cellulose acylate film.

Dip coating, curtain coating, extrusion coating, bar coating, and E-type coating can be used as coating methods. For coating a saponification on a transparent support, it is preferred that the solvent of an alkali coating solution for saponification treatment has a good wetting property, does not form unevenness on the surface of a transparent support, and is capable of maintaining a good face property. Specifically, alcohol solvents are preferred, and isopropyl alcohol is especially preferred. It is also possible to use an aqueous solution of surfactant as the solvent. The alkali of an alkali saponification coating solution is preferably alkali soluble in the above solvents, and KOH and NaOH are more preferred. The pH of an alkali saponification coating solution is preferably 10 or higher, more preferably 12 or higher. The reaction conditions in alkali saponification are preferably room temperature and from 1 second to 5 minutes, more preferably from 5 seconds to 5 minutes, and especially preferably from 20 seconds to 3 minutes. After alkali saponification reaction, it is preferred that a surface coated with a saponification solution is washed with water, or acid and then water.

### Antireflection Layer:

It is preferred to provide a functional film, e.g., an antireflection layer, on a transparent protective film of a polarizing plate arranged on the side opposite to the side on which a liquid crystal cell is provided. In particular in the invention, an antireflection layer comprising a lamination of a light scattering layer and a low refractive index layer on a transparent protective film in this order, or an antireflection layer comprising a lamination of a middle refractive index layer, a high refractive index layer and a low refractive index layer on a transparent protective film in this order is preferably used. The preferred examples of antireflection layers are described below.

The preferred examples of the antireflection layer comprising a light scattering layer and a low refractive index layer provided on a transparent protective film are described.

Matting particles are dispersed in the light scattering layer in the invention, and the refractive index of the components other than matting particles in the light scattering layer is preferably in the range of from 1.50 to 2.00, and the refractive index of the low refractive index layer is preferably in the range of from 1.35 to 1.49. In the invention, the light scattering layer doubles as glare-proof and hard coat properties, and may comprise one layer, or a plurality of layers, e.g., two to four layers.

As the surface unevenness of the antireflection layer, it is preferred to design to provide central line average roughness Ra of from 0.08 to 0.40 μm, tell point average roughness Rz of 10 times Ra or less, average peak and valley distance Sm of from 1 to 100 μm, the standard deviation of the height of convexity from the deepest point of the unevenness is 0.5 μm or less, the standard deviation of average peak and valley distance Sm with the central line as standard is 20 μm or less, and the surface having inclination angle of from 0 to 5° of 10% or more, whereby sufficient glare-proofing property and uniform matte feeling by visual observation can be achieved.

By making the tint of reflected light under C light source a* value of −2 to 2, a b* value of −3 to 3, and the ratio of the minimum value and the maximum value of the reflectance in the range of from 380 to 780 nm of from 0.5 to 0.99, the tint of reflected light becomes neutral and preferred. Further, by making a b* value of reflected light of from 0 to 3, a yellowish color in white display is reduced when the anti-reflection layer is applied to an image display and preferred.

When a lattice of 120 μm×40 μm is inserted between a surface light source and the antireflection film of the invention and the standard deviation of luminance distribution measured on the film is 20 or less, glare at the time when a film of the invention is applied to a high precision panel is preferably reduced.

When the antireflection layer in the invention has optical characteristics such as mirror reflectivity of 2.5% or less, transmittance of 90% or more, and 60′ glossiness of 70% or less, the reflectance of outer light can be restrained and visibility is improved. Mirror reflectivity is more preferably 1% or less, and most preferably 0.5% or less. By making a haze value of from 20 to 50%, the ratio of inside haze value/total haze value of from 0.3 to 1, the reduction of the haze value from the haze value at the time of providing a light scattering layer after the time of providing a low refractive index layer of 15% or less, the visibility of transmitted image at the time of comb breadth of 0.5 mm of from 20 to 50%, and the ratio of transmittance of the transmitted light perpendicular to the antireflection layer and the transmitted light in the direction inclined by 2° from perpendicularity of from 1.5 to 5.0, glare on a high precision LCD panel can be prevented and the reduction of halation of letters and the like can be achieved.

### Low Refractive Index Layer:

The refractive index of the low refractive index layer of the antireflection film in the invention is from 1.20 to 1.49, preferably from 1.30 to 1.44. It is preferred for the low refractive index layer to satisfy the following equation (XI) for reducing the refractive index.

(m/4)×0.7<n⁻⁴d⁻⁴<(m/4)×1.3 (XI)

In the equation, m represents a positive odd number, n⁻⁴ represents a refractive index of a low refractive index layer, and d⁻⁴ represents a layer thickness (nm) of a low refractive index layer. λ is wavelength, which is in the range of from 500 to 550 nm.

The materials for forming the low refractive index layer are described below.

The low refractive index layer in the invention contains a fluorine-containing polymer as the low refractive index binder. As the fluorine polymers, fluorine-containing polymers having a dynamic friction coefficient of from 0.03 to 0.20, a contact angle to water of from 90 to 120°, and capable of crosslinking by heat or ionizing radiation of the falling angle of pure water of 70°or less are preferably used. When the antireflection film of the invention is mounted on an image display, the lower the peeling force from commercially available adhesive tapes, the more easily is the peeling of a sticker, a memo pad and the like after sticking them, preferably 5N or less, more preferably 3N or less, and most preferably 1N or less. Further, the harder the surface hardness measured with a micro-hardness tester, the more hardly scratched is the surface, preferably 0.3 GPa or more, more preferably 0.5 GPa or more.

As the fluorine-containing polymers for use in the low refractive index layer, hydrolyzed products and dehydrated and condensed products of perfluoroalkyl group-containing silane compounds (e.g., (heptadecafluoro-1,1,2,2-tetrahydrodecyl)-triethoxysilane), and fluorine-containing copolymers comprising a fluorine-containing monomer unit and a constitutional unit for providing crosslinking reactivity are exemplified.

The examples of the fluorine-containing monomers include fluoroolefins (e.g., fluoroethylene, vinylidene fluoride, tetrafluoroethylene, perfluorooctylethylene, hexafluoro-propylene, perfluoro-2,2-dimethyl-1,3-dioxole, etc.), partially or completely fluorinated alkyl ester derivatives of (meth)acrylic acid (e.g., Viscoat 6FM (manufactured by Osaka Organic Chemical Industry Ltd.), M-2020 (manufactured by Daikin Industries Ltd.), etc.), and completely or partially fluorinated vinyl ethers, preferably fluoroolefins, and especially preferably hexafluoropropylene for refractive index, solubility, transparency and availability.

As the constitutional units for providing crosslinking reactivity, constitutional units obtainable by the polymerization of monomers having a self-crosslinkable functional group in the molecule in advance, e.g., glycidyl (meth)acrylate and glycidyl vinyl ether, constitutional units obtainable by the polymerization of monomers having a carboxyl group, a hydroxyl group, an amino group, or a sulfo group (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, crotonic acid, etc.), and constitutional units obtained by introducing a cross-linking reactive group such as (meth)acryloly group to these constitutional units by polymer reaction (e.g., a crosslinking reactive group can be introduced by a technique of reacting acrylic acid chloride to a hydroxyl group) are exemplified.

From the viewpoint of solubility in solvents and for providing transparency to films, besides the above fluorine-containing monomer units and constitutional units for providing crosslinking reactivity, monomers not containing fluorine can also be arbitrarily copolymerized. Monomer units usable in combination are not especially restricted, e.g., olefins (ethylene, propylene, isoprene, vinyl chloride, vinylidene chloride, etc.), acrylates (e.g., methyl acrylate, ethyl acrylate, 2-ethylhexyl acrylate, etc.), methacrylates (e.g., methyl methacrylate, ethyl methacrylate, butyl methacrylate, ethylene glycol dimethacrylate, etc.), styrene derivatives (e.g., styrene, divinylbenzene, vinyltoluene, α-methylstyrene, etc.), vinyl ethers (e.g., methyl vinyl ether, ethyl vinyl ether, cyclohexyl vinyl ether, etc.), vinyl esters (e.g., vinyl acetate, vinyl propionate, vinyl cinnamate, etc.), acrylamides (e.g., N-tert-butylacrylamide, N-cyclohexyl-acrylamide, etc.), methacrylamides, and acrylonitrile derivatives can be exemplified.

Curing agents may be arbitrarily used in these polymers as disclosed in JP-A-10-25388 and JP-A-10-147739.

### Light Scattering Layer:

A light scattering layer is formed for the purpose of providing light diffusibility by light scattering at the surface and/or light scattering in the inner part, and a hard coat property to improve scratch resistance of the film. Accordingly, the light scattering layer is formed by containing a binder for providing a hard coat property, matting particles for providing light diffusibility and, if necessary, inorganic fillers for increasing refractive index, preventing shrinkage by crosslinking, and increasing strength.

The thickness of the light scattering layer is preferably from 1 to 10 μm, more preferably from 1.2 to 6 μm, from the viewpoints of providing a hard coat property, preventing the generation of curling, and restraining the deterioration of brittleness.

As the binders of the light scattering layer, polymers having a saturated hydrocarbon chain or a polyether chain as the main chain are preferred, and polymers having a saturated hydrocarbon chain as the main chain are more preferred. Further, it is preferred for the binder polymers to have a crosslinking structure. As the binder polymers having a saturated hydrocarbon chain as the main chain, polymers of ethylenic unsaturated monomers are preferred. As the binder polymers having a saturated hydrocarbon chain as the main chain and also having a crosslinking structure, (co)polymers of monomers having two or more ethylenic unsaturated groups are preferred. For making the binder polymers high refractive index, it is effective to use monomers having at least one kind of atom selected from a halogen atom other than a fluorine atom, a sulfur atom, a phosphorus atom, and a nitrogen atom.

The examples of the monomers having two or more ethylenic unsaturated groups include esters of polyhydric alcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)-acrylate, pentaerythritol tri(meth)acrylate, trimethylol-propane tri(meth)acrylate, trimethylolethane tri(meth)-acrylate, dipentaerythritol tetra(meth)acrylate, dipenta-erythritol penta(meth)acrylate, dipentaerythritol hexa-(meth)acrylate, pentaerythritol hexa(meth)acrylate, 1,2,3-cyclohexane tetra(meth)acrylate, polyurethane polyacrylate, and polyester polyacrylate), ethylene oxide-modified products of the above monomers, vinylbenzene and derivatives thereof (e.g., 1,4-divinylbenzene, 4-vinylbenzoic acid-2-acryloyl-ethyl ester, and 1,4-divinylcyclohexanone), vinyl sulfone (e.g., divinyl sulfone), acrylamide (e.g., methylenebis-acrylamide), and methacrylamide. These monomers may be used in combination of two or more kinds.

As the specific examples of high refractive index monomers, bis(4-methacryloylthiophenyl) sulfide, vinyl-naphthalene, vinylphenyl sulfide, and 4-methacryloxyphenyl-4-methoxyphenyl thioether are exemplified. These monomers may also be used in combination of two or more kinds.

Polymerization of these monomers having an ethylenic unsaturated group can be performed by irradiation with ionizing radiation or heating in the presence of a photo-radical polymerization initiator or a thermal radical polymerization initiator.

Accordingly, an antireflection film can be formed by preparing a coating solution containing a monomer having an ethylenic unsaturated group, a photo-radical polymerization initiator or a thermal radical polymerization initiator, matting particles and an inorganic filler, coating the coating solution on a transparent support, and then performing polymerization reaction by irradiation with ionizing radiation or heating to thereby cure the coated layer, Well-known photo-radical polymerization initiators can be, used.

As polymers having a polyether chain as the main chain, ring opening polymers of polyfunctional epoxy compounds are preferred. Ring opening-polymerization of a polyfunctional epoxy compound can be effected by irradiation with ionizing radiation or by heating in the presence of a photo-acid generator or a heat-acid generator.

Accordingly, an antireflection film can be formed by preparing a coating solution containing a polyfunctional epoxy compound, a photo-acid generator or a heat-acid generator, matting particles and an inorganic filler, coating the coating solution on a transparent support, and then performing polymerization reaction with ionizing radiation or heating to thereby cure the coated layer.

In place of or in addition to a monomer having two or more ethylenic unsaturated groups, crosslinkable functional groups may be introduced into a polymer by using a monomer having crosslinkable functional groups, and a crosslinking structure may be introduced to a binder polymer by the reaction of the crosslinkable functional groups.

The examples of the crosslinkable functional groups include an isocyanate group, an epoxy group, an aziridine group, an oxazoline group, an aldehyde group, a carbonyl group, a hydrazine group, a carboxyl group, a methylol group and an active methylene group. Vinylsulfonic acid, acid anhydride, cyano acrylate derivative, melamine, etherified methylol, ester and urethane, and metal alkoxide, such as tetramethoxy-silane, can also be used as monomers for introducing a crosslinking stricture. A functional group showing a crosslinking property as a result of decomposition reaction, such as a block isocyanate group, can also be used as a crosslinkable functional group. That is, in the invention, crosslinkable functional groups may be those that show reactivity as a result of decomposition even if they do not show reactivity at once.

By coating binder polymers having these crosslinkable functional groups and then heating, a crosslinking structure can be formed.

For the purpose of imparting a glare-proof property, matting particles having an average particle size of from 1 to 10 μm, preferably from 1.5 to 7.0 μm, which are greater than filler particles, e.g., particles of inorganic compounds or resin particles, are contained in a light scattering layer.

As the specific examples of the matting particles, such as particles of inorganic compounds, e.g., silica particles and TiO₂ particles, and resin particles, e.g., acrylic particles, crosslinked acrylic particles, polystyrene particles, cross linked styrene particles, melamine resin particles, and benzoguanamine resin particles are preferably exemplified. Of these particles, crosslinked styrene particles, crosslinked acrylic particles, crosslinked acrylstyrene particles, and silica particles are preferred. The matting particles may be spherical or amorphous.

Further, two or more matting particles each having different particle size may be used together. It is possible to give a glare-proof property by larger size matting particles and give other optical properties by smaller size matting particles.

The particle size distribution of the matting particles is most preferably monodispersion. The particle sizes of all the particles are preferably equivalent as far as possible. Taking the particles having particle sizes greater than the average particle size by 20% or more as coarse particles, the proportion of the coarse particles is preferably 1% or less of all the particle number, more preferably 0.1% or less, and still more preferably 0.01% or less Matting particles having such particle size distribution are obtained by classification after ordinary synthesizing reaction. By increasing the number of times of classification or raising the degree of classification, matting particles having more preferred particle size distribution can be obtained.

The matting particles are added so that the amount contained in a formed light scattering layer is preferably from 10 to 1,000 mg/m², more preferably from 100 to 700 mg/m².

The particle size distribution of matting particles is measured with a coulter counter method and the measured particle size distribution is converted to particle number distribution.

For increasing the refractive index of the layer, it is preferred to add an inorganic filler to the light scattering layer in addition to the matting particles. For example, inorganic fillers comprising at least one oxide of metal selected from titanium, zirconium, aluminum, indium, zinc, tin and antimony, and having an average particle size of 0.2 μm or less, preferably 0.1 μm or less, and more preferably 0.06 μm or less are preferably used.

Contrary to this, in a light scattering layer containing high refractive index matting particles for the purpose of increasing the refractive index difference between the matting particles, it is also preferred to use a silicon oxide for maintaining the refractive index of the layer lowish. The preferred particle size is the same as that of the above inorganic fillers.

The specific examples of the inorganic fillers for use in a light scattering layer include TiO₂, ZrO₂, Al₂O₃, In₂O₃, ZnO, SnO₂, Sb₂O₃, ITO and SiO₂. TiO₂ and ZrO₂ are especially preferred for increasing a refractive index. It is also preferred for the surfaces of inorganic fillers to be treated with a silane coupling agent or a titanium coupling agent, and surface treating agents having functional groups capable of reacting with the binder are preferably used on the surfaces of fillers.

The addition amount of these inorganic fillers is preferably from 10 to 90% of the entire mass of the light scattering layer, more preferably from 20 to 80%, and especially preferably from 30 to 75%.

These particle sizes of these fillers are sufficiently smaller than the wavelength of light, so that light scattering does not occur and a dispersion comprising a binder polymer having dispersed therein these fillers behaves as an optically uniform material.

The total refractive index of the mixture of a binder and an inorganic filler in a light scattering layer in the invention is preferably from 1.48 to 2.00, more preferably from 1.50 to 1.80. The above range of refractive index can be reached by the selection of the ratio of the kind and amount of the binder and the inorganic filler. The selection can be easily known experimentally in advance.

For securing uniform face properties, e.g., resistance to coating unevenness, drying unevenness and point defects, a light scattering layer contains surfactants, e.g., fluorine surfactants or silicone surfactants, or both of them, in a coating composition for forming a glare-proof layer. Fluorine surfactants are especially preferably used for the reason that fluorine surfactants have the effect of improving face defects such as coating unevenness, drying unevenness and point defects of the antireflection film of the invention with a smaller addition amount. The object of the addition of fluorine surfactants is to increase productivity by high speed coating aptitude while increasing the uniformity of face property.

In the next place, an antireflection layer comprising a transparent protective film having laminated thereon a middle refractive index layer, a high refractive index layer, and a low refractive index layer in this order is described below.

An antireflection layer comprising a layer constitution of a substrate having thereon at least a middle refractive index layer, a high refractive index layer, and a low refractive index layer (the outermost layer) in this order is designed so as to have refractive indexes satisfying the relationship shown below.

The refractive index of a high refractive index layer>the refractive index of a middle refractive index layer>the refractive index of a transparent support>the refractive index of a low refractive index layer.

A hard coat layer may be provided between a transparent support and a middle refractive index layer. Further, the antireflection layer may comprise a middle refractive index hard coat layer, a high refractive index layer, and a low refractive index layer. (Refer to JP-A-8-122504, JP-A-8-110401, JP-A-10-300902, JP-A-2002-243906 and JP-A-2000-111706.) Each layer may have other function and as such examples, e.g., an antifouling low refractive index layer and an antistatic high refractive index layer (e.g., JP-A-10-206603 and JP-A-2002-243906) are exemplified.

The haze value of an antireflection layer is preferably 5% or less, more preferably 3% or less. The film strength is preferably H or higher by a pencil hardness test according to JIS K5400, more preferably 2H or higher, and most preferably 3H or higher.

### High Refractive Index Layer and Middle Refractive Index Layer:

A layer having a high refractive index of an anti-reflection film comprises a hard film containing at least super fine particles of a high refractive index inorganic compound having an average particle size of 100 mm or less and a matrix binder.

As the inorganic compound fine particles having a high refractive index, inorganic compounds having a refractive index of 1.65 or more, preferably a refractive index of 1.9 or more, are exemplified. For example, oxides of Ti, Zn, Sb, Sn, Zr, Ce, Ta, La, In, etc., and compound oxides containing these metal atoms are exemplified.

For obtaining such super fine particles, treating the surfaces of particles with a surface treating agent (e.g., with a silane coupling agent as disclosed in JP-A-11-295503, JP-A-11-153703 and JP-A-2000-9908, with an anionic compound or an organic metal coupling agent as disclosed in JP-A-2001-310432), taking a core/shell structure with high refractive index particles as core (JP-A-2001-166104 and JP-A-2001-310432), and using a specific dispersant in combination (JP-A-11-153703, U.S. Pat. No. 6,210,858 and JP-A-2002-2776069) are exemplified.

As the materials forming the matrix, well-known thermoplastic resins and thermosetting resins are exemplified.

Further, at least one kind of composition selected from a composition containing a polyfunctional compound having at least two polymerizable groups of radical polymerizable and/or cationic polymerizable groups, and a composition containing an organic metal compound having a hydrolyzable group and a partial condensation product of the compound is preferred. For example, the compositions disclosed in JP-A-2000-47004, JP-A-2001-315242, JP-A-2001-31871 and JP-A-2001-296401 are exemplified.

Further, cured films obtainable from colloidal metal oxide obtained from hydrolyzed and condensed products of metal alkoxide and metal alkoxide composition are also preferred, as disclosed, e.g., in JP-A-2001-293818.

The refractive index of a high refractive index layer is generally from 1.70 to 2.20. The thickness of a high refractive index layer is preferably from 5 nm to 10 μm, more preferably from 10 nm to 1 μm.

The refractive index of a middle refractive index layer is adjusted to be between the refractive index of a low refractive index layer and the refractive index of a high refractive index layer. The refractive index of a middle refractive index layer is preferably from 1.50 to 1.70. The thickness of a middle refractive index layer is preferably from 5 nm to 10 μm, more preferably from 10 nm to 1 μm.

### Low Refractive Index Layer:

A low refractive index layer is laminated on a high refractive index layer. The refractive index of a low refractive index layer is from 1.20 to 1.55, preferably from 1.30 to 1.50.

A low refractive index layer is preferably formed as the outermost layer having scratch resistance and an antifouling property. As a means to conspicuously improve scratch resistance, it is effective to provide a sliding property to the surface, and providing a thin layer comprising the introduction of well-known silicone and the introduction of fluorine can be applied as this means.

The refractive index of the fluorine-containing compounds is preferably from 1.35 to 1.50, more preferably from 1.36 to 1.47. As the fluorine-containing compounds, compounds having crosslinkable or polymerizable functional groups containing fluorine atoms from 35 to 80 mass % are preferred.

For example, as such compounds, the compounds disclosed in JP-A-9-222503, paragraphs [0018] to [0026], JP-A-11-38202, paragraphs [0019] to [0030], JP-A-201-40284, paragraphs [0027] and [0028], and JP-A-2000-284102 are exemplified.

Silicone compounds are compounds having a polysiloxane structure, and those having a curable functional group or a polymerizable functional group in the polymer chain, and a crosslinking structure in the film are preferred. For example, reactive silicone (e.g., Silaplane, manufactured by Chisso Corporation), and polysiloxane containing silanol groups at both terminals (e.g., JP-A-11-258403) are exemplified.

It is preferred that the crosslinking reaction or polymerization reaction of fluorine-containing and/or siloxane polymers having a crosslinkable group or a polymerizable group is performed simultaneously with or immediately after coating a coating composition containing a polymerization initiator and a sensitizer for forming the outermost layer with light irradiation or heating.

A cured film by sol gel conversion of curing by condensation reaction of an organic metal compound such as a silane coupling agent and a silane coupling agent containing a specific fluorine-containing hydrocarbon in the presence of a catalyst is also preferred.

For example, polyfluoroalkyl group-containing silane compound or partially hydrolysis condensates of the compound (the compounds disclosed in JP-A-58-142958, JP-A-58-147483, JP-A-58-147484, JP-A-9-157582 and JP-A-11-106704), and silyl compounds containing a poly(perfluoroalkyl ether) group, i.e., a fluorine-containing long chain group (the compounds disclosed in JP-A-2000-117902, JP-A-2001-48590 and JP-A-2002-53804) are exemplified.

Besides the above additives, a low refractive index layer can contain low refractive index inorganic compounds having an average particle size of primary particles of from 1 to 150 nm such as fillers (e.g., silicon dioxide (silica)), fluorine-containing particles (e.g., magnesium fluoride, calcium fluoride, barium fluoride), the organic fine particles disclosed in JP-A-11-3820, paragraphs from [0020] to [0038], silane coupling agents, sliding agents and surfactants.

When a low refractive index layer is formed as the lower layer of the outermost layer, the low refractive index layer may be formed by gaseous phase methods (e.g., a vacuum deposition method, a sputtering method, an ion plating method, a plasma CVD method). Coating methods are preferred in the point of capable of manufacturing inexpensively.

The thickness of a low refractive index layer is preferably from 30 to 200 nm, more preferably from 50 to 150 nm, and most preferably from 60 to 120 nm.

Further, a hard coat layer, a forward scattering layer, a primer layer, an antistatic layer, an undercoat layer and a protective layer may be provided.

### Hard Coat Layer:

A hard coat layer is provided on the surface of a transparent support for the purpose of giving physical strength to a transparent protective film having provided an antireflection layer. It is particularly preferred to provide a hard coat layer between a transparent support and a high refractive index layer. A hard coat layer is preferably provided by a crosslinking reaction or a polymerization reaction of a photo- and/or thermo-curable compound. As the curable functional groups, photo-polymerizable functional groups are preferred, and as the organic metal compounds containing a hydrolysis decomposable functional group, organic alkoxysilyl compounds are preferred.

The specific examples of these compounds, the same compounds as shown in the high refractive index layer can be exemplified. The specific constitutional compositions of a hard coat layer are disclosed, e.g., in JP-A-2002-144913, JP-A-2000-9908 and WO 00/46617.

A high refractive index layer can double as a hard coat layer. When a high refractive index layer doubles as a hard coat layer, it is preferred to form the hard coat layer by adding fine particles to the hard coat layer as fine dispersion according to the method as described in the high refractive index layer.

A hard coat layer can double as a glare-proof layer (described later) having a glare-proof function by containing particles having an average particle size of from 0.2 to 10 μm.

The thickness of a hard coat layer can be appropriately designed according to purposes. The thickness of a hard coat layer is preferably from 0.2 to 10 μm, more preferably from 0.5 to 7 μm.

The strength of a hard coat layer is preferably H or higher by a pencil hardness test according to JIS K5400, more preferably 2H or higher, and most preferably 3H or higher. In a taper test according to JIS K5400, the abrasion loss of a sample piece before and after the test is preferably as small as possible.

### Antistatic Layer:

When an antistatic layer is provided, it is preferred to give electric conductivity of volume resistivity of 10⁻⁸ (Ω cm⁻³) or less. It is possible to provide volume resistivity of 10⁻⁸ (Ω cm⁻³) or less by the use of moisture-absorbing materials, water-soluble inorganic salts, certain kinds of surfactants, cationic polymers, anionic polymers and colloidal silica, but there is a problem that the temperature and moisture-dependency is great and sufficient electric conductivity cannot be obtained at low moisture. Therefore, metal oxides are preferred as the electric conductive materials. There are colored metal oxides, but when such colored metal oxides are used as electric conductive materials, the film at large is colored, so that not preferred. As the metals forming metal oxides not colored, Zn, Ti, Al, In, Si, Mg, Ba, Mo, W and V can be exemplified, and it is preferred to use metal oxides comprising these metals as the main component.

As the specific examples, ZnO, TiO₂, SnO₂, Al₂O₃, In₂O₃, SiO₂, MgO, BaO, MoO₃, V₂O₅, or compound oxides of them are preferred, and ZnO, TiO₂ and SnO₂ are especially preferred. As the examples containing other kinds of atoms, e.g., the addition of Al and In to ZnO, Sb, Nb and halogen atoms to SnO₂, and Nb and TA to TiO₂ are effective. Further, as disclosed in JP-B-59-6235, materials obtained by adhering the above metal oxides to other crystalline metal particles or fibrous substances (e.g., titanium oxide) may be used.

Although a volume resistive value and a surface resistive value are different physical values and they cannot be easily compared, for securing electric conductivity of volume resistivity of 10⁻⁸ (Ω cm⁻³) or less, it is sufficient that the electric conductive layer has in general a surface resistive value of 10⁻¹⁰ (Ω/□) or less, more preferably 10⁻⁸ (Ω/□) or less. It is necessary that the surface resistive value of an electric conductive layer is measured as the value of the time with an antistatic layer as the outermost layer, and this value can be measured in the midway of forming the lamination film described in this specification.

### Liquid Crystal Display:

The cellulose acylate film, an optical compensation sheet comprising the film, and a polarizing plate using the film can be used in various liquid crystal cells of display modes and liquid crystal displays, and various display modes are proposed, e.g., TN (Twisted Nematic), IPS (In-Plane Switching), FLC (Ferroelectric Liquid Crystals), AFLC (Anti-Ferroelectric Liquid Crystal), OCB (Optically Compensatory Bend), STN (Super Twisted Nematic), VA (Vertical Alignment), and HAN (Hybrid Aligned Nematic). Of these modes, the optics of the invention can be preferably used for OCB mode or VA mode.

OCB mode liquid crystal cell is a liquid crystal display using liquid crystal cell of bend orientation mode of orientating rod-like liquid crystal molecules substantially reverse directions (symmetrically) at the upper and lower of the liquid crystal cell, and disclosed in U.S. Pat. Nos. 4,583,825 and 5,410,422. Since rod-like liquid crystal molecules are orientated symmetrically at the upper and lower of the liquid crystal cell, the liquid crystal cell of bend orientation mode has a self-optical compensation function. Therefore, this liquid crystal mode is also called OCB (Optically Compensatory Bend) liquid crystal mode. The liquid crystal display of bend orientation mode has the advantage that response speed is quick.

In VA mode liquid crystal cell, rod-like liquid crystal molecules are substantially perpendicularly orientated when no voltage is applied.

VA mode liquid crystal cell includes (1) VA mode liquid crystal cell in a narrow sense of substantially perpendicularly orientating rod-like liquid crystal molecules when no voltage is applied, and substantially horizontally orientating when voltage is applied (e.g., JP-A-2-176625), (2) liquid crystal cell having multi-domains of VA mode (MVA mode) for widening angle of visibility (SID97, described in Digest of Tech. Papers, (drafts) 28, 845 (1997)), (3) liquid crystal cell of a mode of substantially perpendicularly orientating rod-like liquid crystal molecules when no voltage is applied, and twisted multi-domain orientating when voltage is applied (n-ASM mode) (described in the drafts of Liquid Crystal Forum, Japan, 58-59 (1998)), and (4) SURVAIVAL mode liquid crystal cell (released at LCD International 98).

VA mode liquid crystal display comprises a liquid crystal cell and two sheets of polarizing plates arranged both sides of the liquid crystal cell. The liquid crystal cell carries liquid crystal between two electrodes. In one embodiment of a transmission type liquid crystal display of the invention, one sheet of optical compensation sheet of the invention is arranged between the liquid crystal cell and one polarizing plate, or two sheets of optical compensation sheets are arranged between the liquid crystal cell and two polarizing plates.

In another embodiment of a transmission type liquid crystal display of the invention, an optical compensation sheet comprising cellulose acylate film of the invention is used as the transparent protective film of the polarizing plates arranged between the liquid crystal cell and the polarizer. The optical compensation sheet may be used as the protective film of the polarizing plate of only one side (the polarizing plate between the liquid crystal cell and the polarizer), or may be used for two sheets of transparent protective films of both polarizing plates (the polarizing plates between the liquid crystal cell and the polarizer). When the optical compensation sheet is used for the polarizing plate of only one side, it is particularly preferred to use the sheet as the protective film of the liquid crystal cell side of the polarizing plate on the back light side of the liquid crystal cell. It is preferred in sticking to make the cellulose acylate film of the invention on VA cell side. Protective film may be ordinary cellulose acylate films, but preferably thinner than the cellulose acylate film of the invention. For example, a thickness of from 40 to 80 μm is preferred, and commercially available KC4UX2M (40 μm, manufactured by Konica Opto, Inc.), KC5UX (60 μm, manufactured by Konica Opto Co.), and TD80 (80 μm, manufactured by Fuji Photo Film Co., Ltd.) are exemplified, but the invention is not limited thereto.

### EXAMPLE

The invention will be described with referring to Examples but the invention is not limited thereto.

### Measuring Methods:

Various characteristics of cellulose acylate film were measured by the following methods.

### Retardation Re, Rth:

Retardation was measured by projecting rays of light of wavelength λ nm in the direction of normal line of the film with a birefringence refractometer, KOBRA 21ADH (manufactured by Oji Scientific Instruments). Rth (λ) was computed by inputting the virtual value of average refractive index 1.48 and a film thickness, based on retardation values measured in three directions of the above Re (λ), the retardation value measured by projecting rays of light of wavelength λ nm from the direction inclined by +400 to the direction of normal line of the film with the in-plane retardation axis as the inclined axis, and the retardation value measured by projecting rays of light of wavelength λ nm from the direction inclined by −40° to the direction of normal line of the film with the in-plane retardation axis as the inclined axis.

### Moisture Content:

A sample of 7 mm×35 mm was subjected to humidity conditioning at 25° C. 80% RH for 2 hours, and the moisture content was measured with a Karl Fischer's method micro-moisture meter LE-20S (manufactured by Hiranuma Sangyo Co., Ltd.). The moisture content was computed by dividing the amount of moisture (g) in the sample by the mass of the sample (g).

### Heat Shrinkage Factor:

A sample of 30 mm×120 mm was aged at 25° C. 60% RH for 2 hours. A hole of 6 mmφ was punched on both sides of the sample with the interval of 100 mm, and the full scale of the distance between holes (L1) was measured to the minimum graduation of 1/1,000 mm with an automatic pin gauge (manufactured by Shinto Scientific Co., Ltd.). The sample was further aged at 60° C. 90% RH or at 90° C. 3% RH for 24 hours, again at 25° C. 60% RH for 2 hours, and the dimension between holes (L2) was measured. The heat shrinkage factor was found by [(L1−L2)/L1]×100.

### Glass Transition Temperature Tg:

A sample of 5 mm×30 mm (unstretched) was subjected to humidity conditioning at 25° C. 60% RH for 2 hours or more, and viscoelasticity was measured with automatic viscoelasticity measuring instrument (Vibron, DVA-225, manufactured by IT Keisoku Seigyo Co.) by the distance between gripper (holding point) of 20 mm, temperature up speed of 2° C./min, the range of measuring temperature of 30° C., 200° C., and frequency of 1 Hz, and the measured values were plotted with the storage elastic modulus as logarithmic axis on the axis of ordinate and the temperature (° C.) as linear axis on the axis of abscissa. At that time, sudden reduction of storage elastic modulus seen at the time when storage elastic modulus transitioned from solid region to glass transition region was drawn with line 1 in the solid region and line 2 was drawn in glass transition region. The intersection of line 1 and line 2 is the temperature where the storage elastic modulus suddenly decreases in temperature increasing and the film begins to soften, which is the temperature of the beginning of migration to glass transition region, thus this point is taken as the glass transition temperature Tg (dynamic viscoelasticity).

### Number of Luminescent Spot Inclusion:

The polarizing plates of the top and bottom of sample film were adjusted to the state of crossed nicols, the sample was observed at 30 points with a polarizing microscope and 50 magnifications, and recorded as digital images by recording density of 1,280×1,024 dots, the observation area at that time was 2.16 mm×1.72 mm. Image magnification was adjusted to 108 mm×86 mm, image was observed with a personal computer, the number of inclusions having a major axis of 1 mm or more glistened white on the image was counted, the number of inclusions of 30 points of each sample were summed up and taken as measured data.

### Filtration Clogging Coefficient:

A cellulose acylate solution maintained at 36° C. was filtered at a flow rate of 7 ml/min through a filter paper (pore diameter: 47 μm, thickness: 1.32 mm, density: 0.32 g/m³) supported by a porous plate provided with 61 holes having a diameter of 3.8 mm in a circular plate having an effective area of 12.5 cm². From the time when the filtration pressure was temporarily stabilized, pressure increase was observed for 3.5 to 4 hours. A graph taking filtration time on the axis of abscissa and plotting PO/P^{0.64} on the axis of ordinate was made, and straight approximation of the plot was found. P and PO means filtration pressure and initial filtration pressure.

Filtration clogging coefficient Ks is obtained by substituting the found inclination of the straight line for the equation of filtration clogging coefficient [−Ks=3.5×inclination]. Here, the pore diameter of the filter paper used is a value computed from the bubble point value of the filter paper. A gear pump KAI (manufactured by Kawasali Heavy Industries, Ltd.) was used for liquid feeding.

### Elastic Modulus:

A sample of 10 mm×200 mm was subjected to humidity conditioning at 25° C. 60% RH for 2 hours, and elastic modulus was computed from the stress and elongation of initial pulling with the initial sample length of 100 mm and tensile speed of 100 mm/min with a tension tester Strograph R2 (manufactured by Toyo Seiki Seisaku-Sho, Ltd.).

### Modulus of Photoelasticity:

Tensile stress was applied to a film sample of 10 mm×100 mm in the major axis direction, and Re retardation at this time was measured with an ellipsometer M150 (manufactured by JASCO Corporation). Modulus of photoelasticity was computed from the variation of retardation to the stress.

### Haze:

Haze was measured of a sample of 40 mm×80 mm at 25° C. 60% RH with a haze meter HGM-2DP (manufactured by Suga Test Instruments Co., Ltd.) according to JIS K6714.

### Example 1

### Manufacture of Cellulose Acylate Film

### (1) Cellulose Acylate

Cellulose acylate films having different degree of acyl substitution as shown in Table 1 were manufactured. Cellulose acylate films can be manufactured by using a sulfuric acid as the catalyst, adding a carboxylic acid and carboxylic anhydride for acylation reaction, and then neutralizing, saponification and ripening, but cellulose acylates having various different complete substitution degrees, substitution degrees at the 6-position, bulk densities and polymerization degrees can be obtained by varying the catalyst, the addition amount of a neutralizer, the addition amount of water, the reaction temperature, and the ripening temperature. The low molecular weight component of each cellulose acylate was removed by washing with acetone.

### (2) Preparation of Dope

### <1-1> Cellulose Acylate Solution

The following composition was put into a mixing tank, stirred to dissolve each component, heated at 90° C. for about 10 minutes, and then subjected to quantitative filtration with a filter paper having an average pore size of 34 μm. A filtration clogging coefficient of each sample computed was between 200 and 500 m⁻³. Each solution filtered through the filter paper was further filtered with a sintered metal filter having an average pore size of 10 μm.

### Cellulose Acylate Solution:

| | | |
|---|---|---|
| Cellulose acylate shown in Table 1 | 100.0 | mass parts |
| Triphenyl phosphate | 8.0 | mass parts |
| Biphenyldiphenyl phosphate | 4.0 | mass parts |
| Methylene chloride | 403.0 | mass parts |
| Methanol | 60.2 | mass parts |

### <1-2> Dispersion of Matting Agent

A dispersion of a matting agent was prepared by putting the following composition containing the cellulose acylate solution prepared in the above manner into a disperser.

### Dispersion of Matting Agent:

| | | |
|---|---|---|
| Silica particles having an average particle | 2.0 | mass parts |
| size of 16 nm (Aerosil R972, manufactured | | |
| by Nippon Aerosil Co., Ltd.) | | |
| Methylene chloride | 72.4 | mass parts |
| Methanol | 10.8 | mass parts |
| Cellulose acylate solution | 10.3 | mass parts |

### <1-3> Retardation Increasing Agent Solution A

Retardation increasing agent solution A was prepared by putting the following composition containing the cellulose acylate solution prepared in the above manner into a mixing tank, and dissolving the composition by stirring with heating.

### Retardation Increasing Agent Solution A:

| | | |
|---|---|---|
| Retardation increasing agent A | 20.0 | mass parts |
| Methylene chloride | 58.3 | mass parts |
| Methanol | 8.7 | mass parts |
| Cellulose acylate solution | 12.8 | mass parts |

A dope for preparing a film was prepared by blending 100 mass parts of the above cellulose acylate solution, 1.35 mass parts of a matting agent dispersion, and retardation increasing agent solution A in the ratio as shown in Table 2 below. The obtained dope was used in the preparation of film F1 to F5 and F8 to F14.

### Retardation Increasing Agent A

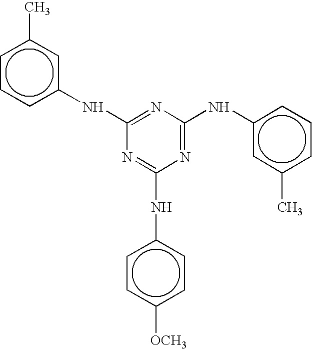

### <1-4> Retardation Increasing Agent Solution B

Retardation increasing agent solution B was prepared by putting the following composition containing the cellulose acylate solution prepared in the above manner into a mixing tank, and dissolving the composition by stirring with heating.

### Retardation Increasing Agent Solution B:

| | | |
|---|---|---|
| Retardation increasing agent A | 8.0 | mass parts |
| Retardation increasing agent B | 12.0 | mass parts |
| Methylene chloride | 58.3 | mass parts |
| Methanol | 8.7 | mass parts |
| Cellulose acylate solution | 12.8 | mass parts |

A dope for preparing a film was prepared by blending 100 mass parts of the above cellulose acylate solution, 1.35 mass parts of a matting agent dispersion, and retardation increasing agent solution B in the ratio as shown in Table 2 below. The obtained dope was used in the preparation of film F6 and F7.

The addition ratio of the retardation increasing agent was shown in Table 2 in mass parts with the amount of cellulose acylate 100 mass parts. The viscosity of each dope at 33° C. was also shown in Table 2.

### Retardation Increasing Agent B

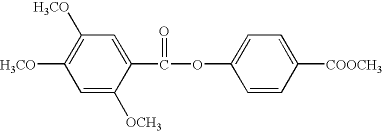

### (Casting)

The above dope was cast with a band-casting machine. A film peeled off the band when the residual solvent amount was from 25 to 35 mass % was stretched in the breadth direction by a stretching rate of from 15 to 25% (shown in Table 2) with a tenter to thereby obtain a cellulose acylate film. After stretching in the breadth direction while drying by blowing hot air at the tenter, the film was shrunk about 5%, conveyance was changed from tenter to roll to be further dried, knurling was pressed, and wound in the breadth of 1,500 mm. As the stretching rate, the value computed from the film breadths at the inlet mid outlet of the tenter is shown in Table 2.

TABLE 1

| | | | | | Substitution | | |
|---|---|---|---|---|---|---|---|
| | | | | | Degree at | | |
| | | | | | 6-Position/ | | |
| | Material | Acetyl | Propionyl | Substitution | Total | | Bulk |
| | Cotton | Substitution | Substitution | Degree at | Substitution | Polymerization | Density |
| Remarks | No. | Degree | Degree | 6-Position | Degree | Degree | (kg/liter) |
| Comparison | CA1 | 2.849 | 0.000 | 0.934 | 0.328 | 260 | 0.61 |
| Comparison | CA2 | 2.847 | 0.000 | 0.947 | 0.333 | 207 | 0.72 |
| Invention | CA3 | 2.785 | 0.000 | 0.910 | 0.327 | 302 | 0.455 |
| Invention | CA4 | 2.753 | 0.000 | 0.903 | 0.328 | 291 | 0.68 |
| Invention | CA5 | 2.745 | 0.000 | 0.882 | 0.321 | 324 | 0.64 |
| Invention | CA6 | 1.952 | 0.808 | 0.897 | 0.325 | 287 | 0.55 |
| Comparison | CA7 | 2.860 | 0.000 | 0.887 | 0.310 | 369 | 0.515 |
| Invention | CA8 | 2.794 | 0.000 | 0.902 | 0.323 | 294 | 0.32 |

Total substitution degree is the sum total of acyl substitution degree at the 2-position, 3-position and 6-position. Total substitution degree is equivalent to the value obtained by adding acetyl substitution degree and propionyl substitution degree.

Re retardation value and Rth retardation value of the prepared cellulose acylate film (optical compensation sheet) at 25° C. 60% RH and wavelength of 630 nm were measured with a birefringence refractometer KOBRA 21ADH (manufactured by Oji Scientific Instruments). Further, a film was subjected to humidity conditioning at 25° C. 10% RH and 25° C. 80% RH for 2 hours or more, and Re retardation value and Rth retardation value at 630 nm were respectively measured. The variations of retardation of the cellulose acylate film at this time from 80% RH to 10% RH (Re (10% RH)−Re (80% RH), and Rth (10% RH)−Rth (80% RH)) were taken as ΔRe and ΔRth and shown in Table 2. The film thickness in the breadth direction was measured with a continuous thickness meter (manufactured by Anritsu Denki Co., Ltd.), and the difference in thickness in the entire breadth excluding the knurled part, and the maximum film thickness variation between 10 mm are shown in Table 2. Further, the number of luminescent spot inclusions was measured. The results obtained are shown in Table 2.

TABLE 2

| | | | | | | | | Maximum | | | | | |
|---|---|---|---|---|---|---|---|---|---|---|---|---|---|
| | | | Addition | | | | | Thickness | | | | | |
| | | | Amount of | | | | Maximum | Variation | | | | | |
| | | Retardation | Retardation | | | | Thickness | in | | | | | |
| | | Increasing | Increasing | | | Average | Difference | Breadth | | | | | |
| | Material | Agent | Agent | Dope | Stretching | Film | in Breadth | Direction | | | | | |
| | Cotton | Solution | (mass | Viscosity | Rate | Thickness | Direction | between | Re | Rth | ΔRe | ΔRth | |
| Film No. | No. | Used | parts) | (Pas) | (%) | (μm) | (μm) | 10 mm | (nm) | (nm) | (nm) | (nm) | Remarks |
| F1 | CA3 | — | 0.0 | 17 | 20 | 92 | 3.4 | 0.5 | 16 | 114 | 12.1 | 41.0 | Comp. |
| F2 | CA7 | A | 5.0 | 68 | 25 | 92 | 4.6 | 0.6 | 45 | 189 | 10.4 | 28.6 | Comp. |
| F3 | CA3 | A | 6.0 | 16 | 15 | 92 | 3.8 | 0.6 | 62 | 234 | 8.3 | 26.6 | Ex. |
| F4 | CA3 | A | 5.0 | 16 | 25 | 86 | 3 | 0.5 | 62 | 225 | 10.5 | 27.9 | Ex. |
| F5 | CA1 | A | 6.5 | 9 | 23 | 92 | 5.8 | 0.7 | 63 | 209 | 10.5 | 29.3 | Comp. |
| F6 | CA3 | B | 6.5 | 16 | 15 | 110 | 2.7 | 0.6 | 63 | 223 | 9.9 | 29.8 | Ex. |
| F7 | CA3 | B | 6.5 | 16 | 20 | 92 | 3.5 | 0.5 | 68 | 248 | 8.9 | 29.1 | Ex. |
| F8 | CA3 | A | 6.5 | 16 | 20 | 89 | 3.2 | 0.5 | 65 | 240 | 9.2 | 24.7 | Ex. |
| F9 | CA8 | A | 7.5 | 22 | 25 | 92 | 2.4 | 0.4 | 66 | 202 | 8.5 | 26.2 | Ex. |
| F10 | CA2 | A | 6.5 | 7 | 23 | 92 | 7.2 | 0.9 | 66 | 211 | 10.6 | 28.7 | Comp. |
| F11 | CA4 | A | 5.0 | 14 | 18 | 92 | 3.4 | 0.6 | 70 | 228 | 8.6 | 28.4 | Ex. |
| F12 | CA5 | A | 5.0 | 25 | 18 | 92 | 2.2 | 0.4 | 72 | 235 | 8.6 | 30.8 | Ex. |
| F13 | CA3 | A | 5.0 | 16 | 20 | 92 | 3.4 | 0.6 | 74 | 220 | 8.8 | 28.2 | Ex. |
| F14 | CA6 | A | 5.0 | 11 | 23 | 92 | 4.5 | 0.5 | 81 | 163 | 9.2 | 30.4 | Ex. |

The glass transition temperature (Tg) of each film was between 138 and 147° C. The moisture content after humidity conditioning at 25° C. 80% RH was between 2.9% and 3.4%. The moisture permeability of films after being allowed to leave at 60° C. 95% RH for 24 hours was from 800 to 2,000 g/m²/24 hr. The haze was from 0.1 to 0.9 with all the films, the average secondary particle size of the matting particles was 1.0 μm or less, the elastic modulus in tension was 4 GPa or more, the mass variation after being allowed to stand at 80° C. 90% RH for 48 hours was from 0 to 3%, the dimensional change after being allowed to stand at 60° C. 90% RH and 90° C. 3% RH for 24 hours was −1.2 to 0.2%, and the modulus of photoelasticity esd 50×10⁻¹³ cm²/dyn (5×10⁻¹¹ m²/N) or less with every sample.

Films having a dry thickness of 1.5 times (i.e., 138 μm) the size of optical film F13 shown in Table 2, and 1.9 times (176 μm) were prepared. Re and Rth increased almost in proportion to the thickness and moisture permeability was in inverse proportion to the thickness. The moisture dependency of Re and Rth, ΔRe and ΔRth, glass transition temperature Tg and moisture content were the same value regardless of the thickness.

Re and Rth were measured by varying the wavelength in the environmental humidity at 25° C. 60% RH with an ellipsometer M150 (manufactured by JASCO Corporation). According to the measured values, it can be seen that samples in the Examples in the invention satisfy the requisites of the invention (46≦Re (630)≦200, 70≦Rth (630)≦350, and the thickness variation in the breadth direction is 0.6 μm or less), and comparative samples do not satisfy. Further, all the optical films exclusive of F1 was 0.90≦Re (450)/Re (550)≦1.10, and 0.90≦Re (650)/Re (550)≦1.10, 0.90≦Rth (450)/Rth (550)≦1.25, and 0.90≦Rth (650)/Rth (550)≦1.10.

On the other hand, F10 was 7≦Re (450)/Re (550)≦0.8, 1≦Re (650)/Re (550)≦1.2, 0.90≦Rth (450)Rth (550)≦1.25, and 0.90≦Rth (650)/Rth (550)≦1.10.

With respect to the sample film of film No. F4, the details of manufacturing conditions at casting, the physical properties of the obtained film, and measuring conditions are summarized below.

### Manufacturing Conditions:

Residual solvent amount at peeling: 35 mass %
A zone tensile force: 100 N/m
A zone termination: methanol/(methylene chloride+methanol) 26 mass %
Stretching speed in process C: 24%/min
Atmospheric temperature in process C: 140° C.
Stretching magnification in process C, 1.25 magnifications
Film temperature at initiation of stretching: 47° C.
Residual solvent amount in film at initiation of stretching: 34 mass %
Film temperature at termination of stretching: 108° C.
Termination of stretching: methanol/(methylene chloride+methanol): 4 mass %
Methylene chloride concentration in the atmosphere in process B: 18 vol %
Methylene chloride concentration in the atmosphere in process C: 18 vol %

### Nore)

Process A: process of conveying a film to the tenter after peeling the cast film
Process B: process of holding the end parts of the breadth direction at the tenter
Process C: process of stretching a film in the breadth direction at the tenter

### Measuring Method:

### Residual Amount of Solvent:

### Residual Amount of Solvent in Film:

[(A−B)/A]×100
A: Weight at sampling time of a film
B: Weight after drying a film at 120° C. for 2 hours
The ratio of methanol, methylene chloride
   Determination of methylene chloride and methanol in a film with gas chromatography

The physical properties of the obtained films are shown below.

### Re: 62 nm

### Rth: 225 nm

Distribution of orientation angle: ±0.5° or less
Distribution of retardation (Re): 2.7%
Distribution of retardation (Rth): 1.3%
Film thickness (aVe): 86.0 μm
Maximum film thickness (max): 87.6 μm
Minimum film thickness (min): 84.6 μm

### Haze: 0.7%

Dimensional variation (MD): −0.05%
Dimensional variation (TD): +0.08%
Tear strength (MD): 23 g
Tear strength (TD)+28 g
Elastic modulus (MD): 400 kgf/mm²
Elastic modulus (TD): 487 kgf/mm²
Breaking point stress (MD): 7.9 kgf/mm²
Breaking point stress (TD): 11 kgf/mm²
Breaking point elongation (MD): 17%
Breaking point elongation (TD): 12%

### Measuring Method:

### a) Orientation Angle Distribution

Measuring apparatus: KOBRA 21ADH (Oji Scientific Instruments)
Temperature and relative humidity: Measured after humidity conditioning at 25° C. 60% for 2 hours
Measuring condition: Orientation angle was measured every 10 cm at 13 points by phase difference mode (degree 1)

### b) Retardation Distribution

Measuring apparatus: KOBRA 21ADH (Oji Scientific Instruments)
Temperature and relative humidity: Measured after humidity conditioning at 25° C. 60% for 2 hours
Measuring condition: Re value and Rth value at wavelength of 630 nm were measured every 20 cm at 7 points, retardation distribution=(maximum value−minimum value)/average value×100

### c) Haze

Measuring apparatus: Turbidimeter NDH2000 (manufactured by Nippon Denshoku Industries Co., Ltd.)
Measuring condition: JIS K-6714

### d) Dimensional Variation

Measuring apparatus: Pin gauge
Sample size: 250 mm×50 mm, reference length: about 200 mm
Procedure: Reference length L1 was measured, after a sample was left in 60° C. 90% RH air-conditioned tank for 24 hours, subjected to humidity conditioning at 25° C. 60% RH, and then reference length L2 was measured.

Dimensional variation (%)=[(L2−L1)/L1]×100

### e) Tear Strength

Measuring apparatus: Light load tearing tester (manufactured by Toyo Seiki Seisaku-Sho, Ltd.)

### Range: 0 to 90 g

Dead weight: 90 g
Sample size: 64×51 mm
Temperature and relative humidity: Measured after humidity conditioning at 25° C. 65% for 2 hours

### f) Breaking Point Stress, Judging Point of Progress, Elastic Modulus

Measuring apparatus: Strograph R2 (manufactured by Toyo Seiki Seisaku-Sho, Ltd.)
Sample size: Breadth 10 mm×chuck distance 100 mm
Temperature and relative humidity: Measured after humidity conditioning at 25° C. 65% for 2 hours
Stretching speed: 10 mm/min

### Comparative Example 1

A cellulose acylate film was prepared in the same manner as in Example 1 except for changing the amount of cellulose acylate in the composition of cellulose acylate solution to 120.0 mass parts. As cellulose acylate, CA5 as shown in Table 1 was used. Subsequently, the prepared solution was filtered through a filter paper having the same pore diameter of 34 μm as used in Example 1. The initial filtration pressure was 4 times greater that that of the cellulose acylate solution used in film F12 manufactured in Example 1. A filtration clogging coefficient in Comparative Example 1 was as large as 1,117 m⁻³ as compared with 305 m⁻³ of the solution for forming F12. The filtered amount required to reach the filtration pressure of 0.8 MPa, a standard of filter material exchange, was as small as ⅕ times the amount of the solution for forming F12, which showed the sample to be wanting in practicality.

### Example 2

### 2-1-1

### Preparation of Polarizing Plate-1:

A polarizer was manufactured by making iodine adsorb onto a stretched polyvinyl alcohol film.

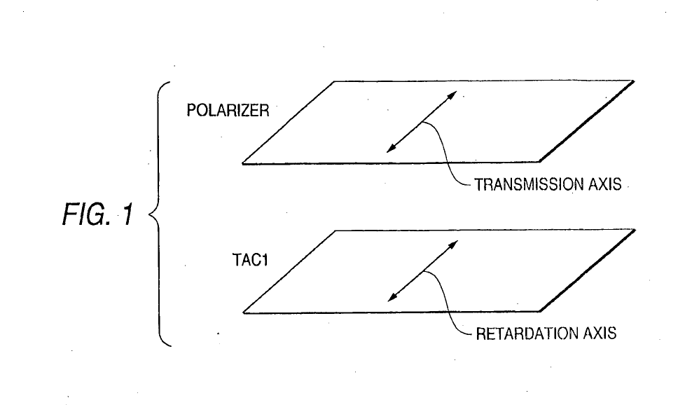

Each of the cellulose acylate films prepared in Example 1 (F1 to F14, corresponding to TAC1 in FIGS. 1 to 3) was adhered on one side of a polarizer with a polyvinyl alcohol adhesive. Saponification treatment was performed as follows.

A 1.5 N aqueous solution of sodium hydroxide was prepared and maintained at 55° C. A 0.01 N aqueous solution of dilute sulfuric acid was prepared and maintained at 35° C. The prepared cellulose acylate film was immersed in the sodium hydroxide aqueous solution for 2 minutes, and then immersed in water to sufficiently wash out the sodium hydroxide aqueous solution. After that, the cellulose acylate film was immersed in the dilute sulfuric acid aqueous solution for 1 minute, and then immersed in water to sufficiently wash out the dilute sulfuric acid aqueous solution.

Finally the sample was sufficiently dried at 120° C.

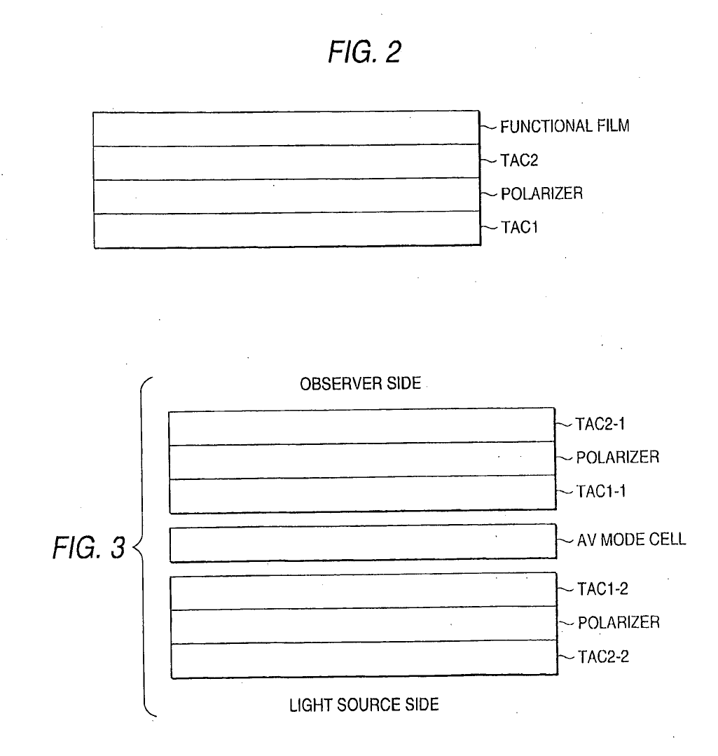

Commercially available cellulose triacylate film (Fuji TAC TD-80UF, manufactured by Fuji Photo Film Co., Ltd., corresponding to functional film TAC2 in FIG. 2, TAC2-1 or 2-2 in FIG. 3) was subjected to saponification treatment, adhered on the opposite side of the polarizer with a polyvinyl alcohol adhesive, and dried at 70° C. for 10 minutes or more.

The transmission axis of the polarizer and the retardation axis of the cellulose acylate film prepared in Example 1 were arranged so as to be parallel (FIG. 1). The transmission axis of the polarizer and the retardation axis of the commercially available cellulose triacylate film were arranged so that to be crossed.

The cellulose acylate film prepared in Example 1 was combined with the polarizer so that the cellulose acylate film was the inside of the polarizer with a spectrophotometer (UV3100PC), and single transmittance TT, parallel transmittance PT, and cross transmittance CT of the polarizing plate of from 380 to 780 nm were measured to find the average values at 400 to 700 nm. TT was 40.8 to 44.7, PT was 34 to 38.8, and CT was 1.0 or lower. Further, in a durability test of the polarizing plate at 60° C. 95% RH for 500 hours, ΔCT and ΔP were in the range of −0.1≦ΔCT≦0.2 and −2.0≦ΔP≦0, and at 60° C. 90% RH were −0.05≦ΔCT≦0.15 and −1.5≦ΔP≦0.

Of the thus manufactured polarizing plates A1 to A14 (an integrated type polarizing plate of an optical compensation film with no functional film in FIG. 2), a part was preserved in a moisture-proof bag without humidity conditioning, and other part was humidity conditioned at 25° C. 60% RH for 2 hours and then preserved in a moisture-proof bag. The moisture-proof bag was packaging material having a lamination structure of polyethylene terephthalate/aluminum/polyethylene, and moisture permeability was 0.01 mg/m² (24 hours) or less.

<2-2-1>

### Preparation of Light Scattering Layer Coating Solution:

A mixture of pentaerythritol triacrylate and pentaerythritol tetraacrylate (PETA, manufactured by Nippon Kayaku Co., Ltd.) (50 g) was diluted with 38.5 g of toluene. Further, 2 g of a polymerization initiator (Irgacure 184, manufactured by Ciba Specialty Chemicals Inc.) was added to the solution and mixed and stirred. The refractive index of a film obtained by coating the obtained coating solution and curing with ultraviolet irradiation was 1.51.

To the solution were further added 1.7 g of a 30% toluene dispersion of crosslinking polystyrene particles having an average particle size of 3.5 μm (refractive index: 1.60, SX-350, manufactured by The Soken Chemical & Engineering Co., Ltd.) with a polytron disperser at 10,000 rpm for 20 minutes, and 13.3 g of a 30% toluene dispersion of crosslinking acryl-styrene particles having an average particle size of 3.5 μm (refractive index: 1.55, manufactured by The Soken Chemical & Engineering Co., Ltd.), and finally 0.75 g of a fluorine surface modifier (FP-1), and 10 g of a silane coupling agent (KBM-5103, manufactured by Shin-Etsu Chemical Co., Ltd.) were added to obtain a finished solution.

The above mixed solution was filtered through a polypropylene filter having a pore diameter of 30 μm, whereby a light scattering layer coating solution was prepared.

<2-2-2>

### Preparation of Low Refractive Index Layer Coating Solution:

In the first place, sol solution a was prepared as follows. Methyl ethyl ketone (120 parts), 100 parts of acryloyloxy-propyltrimethoxysilane (KBM 5103, manufactured by Shin-Etsu Chemical Co., Ltd.), and 3 parts of diisopropoxyaluminum ethyl acetate were put in a reaction vessel with a stirrer and a reflux condenser and mixed, 30 parts of ion exchange water was added thereto and the reaction solution was allowed to react at 60° C. for 4 hours, and then the temperature was lowered to room temperature, whereby sol solution a was obtained. The mass average molecular weight of the solution was 1,600. Of oligomer or higher components, the components having a molecular weight of from 1,000 to 20,000 accounted for 100%. From the analysis by gas chromatography, it was confirmed that acryloyloxypropyltrinmethoxysilane of starting material was not remained at all. A thermo-crosslinkable polymer having a refractive index of 1.42 (JNT-7228, solids content concentration: 6%, manufactured by JSR) (13 g), 1.3 g of silica sol (silica, different from MEK-ST in particle sizes, average particle size: 45 nm, solids content concentration: 30%, manufactured by Nissan Chemical Industries, Ltd.), 0.6 g of sol solution a, 5 g of methyl ethyl ketone, and 0.6 g of cyclohexanone were mixed and stirred. The reaction mixture was filtered through a polypropylene filter having a pore diameter of 1 μm, whereby a low refractive index layer coating solution was prepared.

<2-2-3>

### Preparation of Transparent Protective Film 01 Having Light Scattering Layer:

A triacetyl cellulose film having a thickness of 80 μm (Fuji TAC-TD80U, manufactured by Fuji Photo Film Co., Ltd.) in the form of a roll was unwound, and the above coating solution for forming a functional layer (a light scattering layer) was coated on the film by using micro gravure roll of a diameter of 50 mm and having a gravure pattern of line number 180/inch and a depth of 40 μm and a doctor blade on the conditions of gravure roll rotation number of 30 rpm and a traveling speed of 30 m/min, and then the film was dried at 60° C. for 150 seconds. After drying, the coated layer was cured under nitrogen purge with an air-cooled metal halide lamp of 160 W/cm (manufactured by EYEGRAPHICS, CO., LTD.) by irradiation with ultraviolet ray at illumination intensity of 400 mW/cm² and quantity of radiation of 250 mJ/cm², whereby a functional group having a thickness of 6 μm was formed, and the film was rewound.

The triacetyl cellulose film on which a functional layer was coated was unwound again, and the above low refractive index layer coating solution was coated on the light scattering layer side by using micro gravure roll of a diameter of 50 mm and having a gravure pattern of line number 180/inch and a depth of 40 μm and a doctor blade on the conditions of gravure roll rotation number of 30 rpm and a traveling speed of 15 m/min, and then the film was dried at 120° C. for 150 seconds, and further at 140° C. for 8 minutes. After drying, the coated layer was subjected to irradiation with ultraviolet ray under nitrogen purge with an air-cooled metal halide lamp of 240 W/cm (manufactured by EYEGRAPHICS, CO., LTD.) at illumination intensity of 400 mW/cm² and quantity of radiation of 900 mJ/cm², whereby a low refractive index layer having a thickness of 100 nm was formed, and the film was rewound (corresponding to functional film TAC2 in FIG. 2 or TAC2-1 in FIG. 3).

<2-3-1>

### Preparation of Polarizing Plate-2:

A polarizer was manufactured by making iodine adsorb onto a stretched polyvinyl alcohol film.

The prepared transparent protective film 01 having a light scattering layer was subjected to saponification treatment in the same manner as described in <2-1-1>, and the side not having a functional film of the protective film and one side of the polarizer were adhered with a polyvinyl alcohol adhesive.

Each of the cellulose acylate films prepared in Example 1 (F1; to F14, corresponding to TAC1 in FIG. 1) was subjected to the same saponification treatment, adhered on one side of the polarizer with a polyvinyl alcohol adhesive, and dried at 70° C. for 10 minutes or more (the completed form of the constitution in FIG. 2).

The transmission axis of the polarizer and the retardation axis of the cellulose acylate film prepared in Example 1 were arranged so as to be parallel (FIG. 1). The transmission axis of the polarizer and the retardation axis of transparent protective film 01 having a light scattering layer were arranged so that to be crossed. Thus, a polarizing plate (B1 to B14, an integrated type polarizing plate of a functional film and an optical compensation film) was prepared. Similarly to preparation of a polarizing plate <2-1-1>, some were preserved in a moisture-proof bag without humidity conditioning, and other were humidity conditioned at 25° C. 60% RH for 2 hours and then preserved in a moisture-proof bag.

A polarizer was manufactured by making iodine adsorb onto a stretched polyvinyl alcohol film. A transparent protective film 01 having a light scattering layer prepared in <2-2-3> and a triacetyl cellulose film having a thickness of 80 μm and not having a functional layer (Fuji TAC TD-80UF, manufactured by Fuji Photo Film Co., Ltd.) were subjected to saponification treatment in the same manner as above, and adhered to the polarizer in the same manner as above with a polyvinyl alcohol adhesive, thus a polarizing plate (BO, functional film, optical compensation film in FIG. 2) was manufactured. Similarly to preparation of a polarizing plate <2-1-1>, some were preserved in a moisture-proof bag after humidity conditioning, and other were preserved in a moisture-proof bag without humidity conditioning.

In the wavelength region of from 380 to 780 nm, spectral reflectance at an incident angle of 5° was measured from the functional film side with a spectrophotometer (manufactured by JASCO Corporation). Integrating sphere average reflectance in 450 to 650 nm obtained was 2.3%.

<2-4-1>

### Preparation of Hard Coat Layer Coating Solution:

To 750.0 mass parts of trimethylolpropane triacrylate (TMPTA, manufactured by Nippon Kayaku Co., Ltd.) were added 270.0 mass parts of poly(glycidyl methacrylate) having a mass average molecular weight of 3,000, 730.0 g of methyl ethyl ketone, 500.0 g of 35 cyclohexanone, and 50.0 g of a photo-polymerization initiator (Irgacure 184, manufactured by Ciba Specialty Chemicals Inc.) and stirred. The solution was filtered through a polypropylene filter having a pore diameter of 0.4 μm, whereby a hard coat layer coating solution was obtained.

<2-4-2>

### Preparation of Dispersion of Titanium Dioxide Fine Particles:

As titanium dioxide fine particles, titanium dioxide fine particles containing cobalt and subjected to surface treatment with aluminum hydroxide and zirconium hydroxide (MPT-129C, manufactured by Ishihara Sangyo Kaisha Ltd.) was used.

The following shown dispersant (38.6 g) and 704.3 g of cyclohexanone were added to 257.1 g of the above particles, and the mixture was dispersed with DYNO-MILL, whereby a titanium dioxide dispersion having a mass average particle size of 70 nm was prepared.

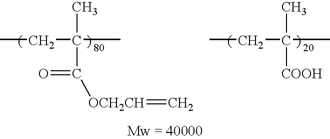

<2-4-3>

### Preparation of Middle Refractive Index Layer Coating Solution:

To 88.9 g of the above titanium dioxide dispersion were added 58.4 g of a mixture of dipentaerythritol pentaacrylate and dipentaerythritol hexaacrylate (DPHA, manufactured by Nippon Kayaku Co., Ltd.), 3.1 g of a photo-polymerization initiator (Irgacure 907), 1.1 g of a photosensitizer (Kayacure DETX, manufactured by Nippon Kayaku Co., Ltd.), 482.4 g of methyl ethyl ketone, and 1,869.8 g of cyclohexanone, and stirred. The solution was thoroughly stirred and filtered through a polypropylene filter having a pore diameter of 0.4 μm, whereby a middle refractive index layer coating solution was obtained.

<2-4-4>

### Preparation of High Refractive Index Layer Coating Solution:

To 586.8 g of the above titanium dioxide dispersion were added 47.9 g of a mixture of dipentaerythritol pentaacrylate and dipentaerythritol hexaacrylate (DPHA, manufactured by Nippon Kayaku Co., Ltd.), 4.0 g of a photo-polymerization initiator (Irgacure 907, manufactured by Ciba Specialty Chemicals Inc.), 1.3 g of a photosensitizer (Kayacure DETX, manufactured by Nippon Kayaku Co., Ltd.), 455.8 g of methyl ethyl ketone, and 1,427.8 g of cyclohexanone, and stirred. The solution was filtered through a polypropylene filter having a pore diameter of 0.4 μm, whereby a high refractive index layer coating solution was obtained.

<2-4-5>

### Preparation of Low Refractive Index Layer Coating Solution:

A copolymer having the following structure was dissolved in methyl isobutyl ketone in concentration of 7 mass %, and terminal methacrylate group-containing silicone resin X-22-164C (manufactured by Shin-Etsu Chemical Co., Ltd.) in concentration of 3% based on the solids content, and a photo-radical generator Irgacure 907 (a trade name) in concentration of 5% based on the solids content were respectively added to the above solution, whereby a low refractive index layer coating solution was obtained.

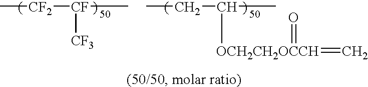

<2-4-6>

### Preparation of Transparent Protective Film 02 Having Antireflection Layer:

The hard coat layer coating solution was coated on a triacetyl cellulose film having a thickness of 80 μm (Fuji TAC TD80UF, manufactured by Fuji Photo Film Co., Ltd.) with a gravure coater. After drying at 100° C., the coated layer was cured under nitrogen purge for reaching the atmosphere of oxygen concentration of 1.0 vol % or lower with an air-cooled metal halide lamp of 160 W/cm (manufactured by EYEGRAPHICS, CO., LTD.) by irradiation with ultraviolet ray at illumination intensity of 400 mW/cm² and quantity of radiation of 300 mJ/cm², whereby a hard coat layer having a thickness of 8 μm was formed.

The middle refractive index layer, high refractive index layer and low refractive index layer were continuously coated on the hard coat layer with a gravure coater having three coating stations.

Drying condition of the middle refractive index layer was 100° C. for 2 minutes, and UV ray curing was performed under nitrogen purge for reaching the atmosphere of oxygen concentration of 1.0 vol % or lower with an air-cooled metal halide lamp of 180 W/cm (manufactured by EYEGRAPHICS, CO., LTD.) at illumination intensity of 400 mW/cm² and quantity of radiation of 400 mJ/cm². The refractive index of the middle refractive index layer after curing was 1.630 and the film thickness was 67 nm.

Drying condition of the high refractive index layer and low refractive index layer was 90° C. for 1 minute, subsequently 100° C. for 1 minute, and UV ray curing was performed under nitrogen purge for reaching the atmosphere of oxygen concentration of 1.0 vol % or lower with an air-cooled metal halide lamp of 240 W/cm (manufactured by EYEGRAPHICS, CO., LTD.) at illumination intensity of 600 mW/cm² and quantity of radiation of 600 mJ/cm².

The refractive index of the high refractive index layer after curing was 1.905 and the film thickness was 107 nm, the refractive index of the low refractive index layer after curing was 1.440 and the film thickness was 85 nm. Thus, a transparent protective film 02 having an antireflection layer was obtained (corresponding to functional film TAC2 in FIG. 2 or TAC2-1 in FIG. 3).

<2-5-1>

### Preparation of Polarizing Plate-3:

Polarizing plates (C1 to C14, an integrated type polarizing plate of a functional film and an optical compensation film in FIG. 2) were prepared in the same manner as in <2-3-1> except for using a transparent protective film 02 having an antireflection layer in place of a transparent protective film 01 having a light scattering layer. Further, in the same manner, a polarizing plate (CO) comprising a triacetyl cellulose film having a thickness of 80 μm (Fuji TAC TD80UF, manufactured by Fuji Photo Film Co., Ltd.) and having none of a transparent protective film 02 having an anti-reflection layer, a polarizer, and a functional layer was prepared.

In the wavelength region of from 380 to 780 nm, spectral reflectance at an incident angle of 5° was measured from the functional film side with a spectrophotometer (manufactured by JASCO Corporation). Integrating sphere average reflectance in 450 to 650 nm obtained was 0.4%.

### Example 3

### Mounting on Panel

### Example 3-1

### Mounting on VA Panel (One Sheet Type)

The liquid crystal display shown in FIG. 3 was manufactured. That is, from the observation side (upper side), upper side polarizing plate (TAC2-1 (with functional film/without functional film), a polarizer, TAC1-1), VA mode liquid crystal cell, lower side liquid crystal, lower side polarizing plate (TAC1-2, a polarizer, TAC2-2) were laminated, and further, a back-light light source was arranged. In the following example, an integrated type polarizing plate of an optical compensation film was used as the lower side polarizing plate, but if this is reversely formed, functionally there is no problem. However, it is thought that an integrated type polarizing plate is in many cases used as a lower side polarizing plate (for the reason that when an integrated type polarizing plate is used as an upper side polarizing plate, it is necessary to provide a functional film on the observation side (upper side) by which the production yield decreases), and that it is preferred embodiment.

### Preparation of Liquid Crystal Cell:

A liquid crystal cell was manufactured by making cell gap between substrates 3.6 μm, dripping a liquid crystal material (MLC 6608, manufactured by Merck Ltd., Japan) having negative dielectric constant anisotropy between substrates and sealing, thus a liquid crystal layer was formed between substrates. The retardation of the liquid crystal layer (that is, the product Δn·d of the thickness d (μm) of the liquid crystal layer and refractive index anisotropy Δn) was taken as 300 nm. The liquid crystal material was oriented so as to be perpendicularly oriented.

As the upper side polarizing plate (observer side) of the liquid crystal display (FIG. 3) in which the above perpendicular orientation type liquid crystal cell was used, commercially available super high contrast material (e.g., HLC2-5618, manufactured by SANRITZ CORPORATION) was used. As the lower side polarizing plate (on the back light side), the polarizing plate manufactured in <2-1-1> in Example 2 (A3 to A10) using the optical compensation sheet of any of F3 to F10 manufactured in Example 1 was arranged so that the cellulose acylate film manufactured in Example 1 (corresponding to TAC1-2 in FIG. 3) was on the liquid crystal cell side. The upper side polarizing plate and the lower side polarizing plate were adhered to the liquid cell with an adhesive. Crossed nicols arrangement was taken so that the transmitted axis of the upper side polarizing plate be up and down direction and the transmitted axis of the lower side polarizing plate be left and right direction. A liquid crystal display was manufactured by using polarizing plates preserved in a moisture-proof bag after humidity conditioning at 25° C. 60% RH for 2 hours, and those preserved in a moisture-proof bag without humidity conditioning.

Here, a commercial product was used as the upper side polarizing plate and the integrated type polarizing plate was used as the lower side polarizing plate, but as a result of the observation of the manufactured liquid crystal display, neutral black display was realized in the in-plane direction and in the direction of angle of visibility. However, in the liquid crystal display in which polarizing plates A5 and A10 were used, streaky unevenness was observed, although a slight. With a measuring apparatus (EZ-Contrast 160D, ELDIM Co.), the angle of visibility was measured (the range of contrast ratio of 10 or more and free of gradation reversal) in 8 stages from black display (L1) to white display (L8).

In the next place, the tint at the time of black display in the azimuth angle 45′ with the in-plane direction of the liquid crystal display screen as the standard and in the polar angle 60° with the normal direction of the screen as the standard was measured with a measuring apparatus (EZ-Contrast 160D, ELDIM Co.), and this was taken as the initial value. The panel was then allowed to stand in a room of normal temperature and humidity (25° C. 60% RH or so, and humidity was not controlled) for one week, and again the tint was measured at the time of black display.

The results of measurement of the angle of visibility and variation of tint are shown in Table 3 below. Every sample of the invention showed broad angle of visibility and no tint variation. The liquid crystal displays using the polarizing plates that had been subjected to humidity conditioning before assembling were conspicuously little in tint variation.

### Example 3-2

As the lower side polarizing plate of the liquid crystal display (FIG. 3) using the perpendicular orientation type liquid crystal cell, the polarizing plate (A3 to A10) manufactured in <2-1-1> in Example 2 using the optical compensation sheet of F3 to F10 manufactured in Example 1 was used, and as the upper side polarizing plate, the polarizing plate (B0) manufactured in <2-3-1> in Example 2 was used, and each polarizing plate was adhered with an adhesive. Crossed nicols arrangement was taken so that the transmitted axis of the observer side polarizing plate be up and down direction and the transmitted axis of the back light side polarizing plate be left and right direction. At this time, the working space was air-conditioned at the temperature of from 20 to 25° C. and the moisture of from 50 to 70% RH. A liquid crystal display was manufactured by using polarizing plates preserved in a moisture-proof bag after humidity conditioning at 25° C. 60% RH for 2 hours, and those preserved in a moisture-proof bag without humidity conditioning.

As a result of observation of the manufactured liquid crystal display, it was confirmed that neutral black display was realized in the in-plane direction and in the direction of angle of visibility. However, in the liquid crystal display in which polarizing plates A5 and A10 were used, streaky unevenness was observed. The angle of visibility and tint variation were also measured in the same manner as in Example 3-1, and the results obtained are shown in Table 3.

### Example 3-3

A liquid crystal display (FIG. 3) was manufactured in the same manner as in Example 3-1 using the perpendicular orientation type liquid crystal cell except for changing cell gas to 2.8 mm and the value of Δn·d to 230 nm. As the lower side polarizing plate of the liquid crystal display, the polarizing plate (A13 and A14) manufactured in <2-1-1> in Example 2, and as the upper side polarizing plate, the polarizing plate (C0) manufactured in <2-5-1> in Example 2 was used, and each polarizing plate was adhered with an adhesive. Crossed-nicols arrangement was taken so that the transmitted axis of the observer side polarizing plate be up and down direction and the transmitted axis of the back light side polarizing plate be left and right direction. At this time, the working space was air-conditioned at the temperature of from 20 to 25° C. and the moisture of from 50 to 70% RH. A liquid crystal display was manufactured by using polarizing plates preserved in a moisture-proof bag after humidity conditioning at 25° C. 60% RH for 2 hours, and those preserved in a moisture-proof bag without humidity conditioning.

As a result of observation of the manufactured liquid crystal display, it was confirmed that neutral black display was realized in the in-plane direction and in the direction of the angle of visibility. The angle of visibility and tint variation were also measured in the same manner as in Example 3-1, and the results obtained are shown in Table 3.

### Comparative Example 3-1

The same procedure as in Example 3-1 was repeated except that the lower side polarizing plates were changed to A1, B1, A2 and B2. The polarizing plates used in Comparative Example 3-1 were not humidity conditioned.

As a result of observation of the manufactured liquid crystal display, it was confirmed that neutral black display was realized in the in-plane direction and in the direction of the angle of visibility. The angle of visibility and tint variation were also measured in the same manner as in Example 3-1, and the results obtained are shown in Table 3.

TABLE 3

| | Angle of Visibility | | |
|---|---|---|---|
| | | Direction of | |
| Liquid | Direction of | 45° from | Black Tint Variation |
| Crystal | Transmission | Transmission | 1 Week after Assembly |
| Display | Axis | Axis | (ΔE*) |
| Example 3-1 | >80° | >80° | No humidity conditioning |
| | | | 0.010-0.013 |
| | | | With humidity conditioning |
| | | | 0.002 |
| Example 3-2 | >80° | >80° | No humidity conditioning |
| | | | 0.010-0.013 |
| | | | With humidity conditioning |
| | | | 0.002 |
| Example 3-3 | >80° | >80° | No humidity conditioning |
| | | | 0.010-0.013 |
| | | | With humidity conditioning |
| | | | 0.002 |
| Comparative | <50° | <50° | No humidity conditioning |
| Example 3-1 | | | 0.020-0.032 |

In Table 3, all the samples in Examples 3-1 to 3-3 of the invention have sufficiently broad angle of visibility and aging stability of the tint, and remarkably superior to comparative examples.

### Example 4

The following composition was mixed in total of 3 kg and put to a glass bottle, stirred at 25° C., 150 rpm for 3 hours to prepare a cellulose acylate solution.

### Cellulose Acylate Solution:

| | | |
|---|---|---|
| Cellulose acylate shown in Table 1 | 17.01 | mass % |
| Triphenyl phosphate | 1.16 | mass % |
| Biphenyldiphenyl phosphate | 0.83 | mass % |
| Methylene chloride | 0.47 | mass % |
| Methanol | 10.53 | mass % |

A cellulose acylate solution maintained at 36° C. was filtered at a flow rate of 7 ml/min through a filter paper (pore diameter: 47 μm, thickness: 1.32 mm, density: 0.32 g/m³) supported by a porous plate provided with 61 holes having a diameter of 3.8 mm in a circular plate having an effective area of 12.5 cm². From the time when the filtration pressure was temporarily stabilized, pressure increase was observed for 3.5 to 4 hours. A graph taking filtration time on the axis of abscissa and plotting PO/P^{0.64} on the axis of ordinate was made, and straight approximation of the plot was found. P and PO means filtration pressure and initial filtration pressure. Filtration clogging coefficient Ks is obtained from the found inclination of the straight line by the equation [−Ks 3.5× inclination] and the results are shown in Table 4.

TABLE 4

| | | Degree at | | |
|---|---|---|---|---|
| | | 6-Position/ | | |
| | Material | Total | | Clogging |
| | Cotton | Substitution | Polymerization | coefficient Ks |
| Remarks | No. | Degree | Degree | (m⁻³) |
| Invention | CA3 | 0.327 | 302 | 348 |
| Invention | CA4 | 0.328 | 291 | 298 |
| Invention | CA5 | 0.321 | 324 | 420 |
| Invention | CA6 | 0.325 | 287 | 291 |
| Comparison | CA7 | 0.310 | 369 | 658 |
| Invention | CA8 | 0.323 | 294 | 312 |

Total substitution degree is the sum total of acyl substitution degree at the 2-position, 3-position and 6-position.

### INDUSTRIAL APPLICABILITY

A cellulose acylate film in the invention and a polarizing plate using the same are little in the thickness variation in the breadth direction, little in face unevenness, excellent in a retardation increasing property in the in-plane and thickness directions, and little in the variation of retardation value due to environmental humidity.

Further, a liquid crystal display in the invention is little in luminance unevenness, particularly perpendicular streaky luminance unevenness, little in the variation and unevenness of tint, and little in the variation of characteristics of angle of visibility.

The entire disclosure of each and every foreign patent application from which the benefit of foreign priority has been claimed in the present application is incorporated herein by reference, as if fully set forth.

1. A cellulose acylate film for optics having an in-plane retardation Re (λ) of 46≦Re (630)≦200, a retardation in a film thickness direction Rth (λ) of 70≦Rth (630)≦350 and a thickness variation between every 10 mm in a breadth direction of 0.6 μm or less, wherein Re (λ) is an in-plane retardation Re value at wavelength λ nm (unit: nm) and Rth (λ) is a retardation Rth value in a film thickness direction at wavelength λ nm (unit: nm).

2. The cellulose acylate film according to claim 1, which is obtained by casting a dope having a coefficient of viscosity of from 10 to 70 Pas at 33° C.

3. The cellulose acylate film according to claim 1,
wherein a degree of polymerization of the cellulose acylate is from 265 to 380.

4. The cellulose acylate film according to claim 1,
wherein a bulk density of the cellulose acylate is from 0.30 to 0.80.

5. The cellulose acylate film according to claim 1, which is a film comprising a cellulose acylate obtained by substituting a hydroxyl group of a glucose unit constituting a cellulose with an acyl group having 2 or more carbon atoms,
wherein the film satisfies equations (I) and (II):
2.0≦DS2+DS3+DS6≦2.85 (I)
DS6/(DS2+DS3+DS6)23 0.315 (II)
wherein DS2 represents a degree of substitution of a hydroxyl group at a 2-position of the glucose unit with an acyl group;
DS3 represents a degree of substitution of a hydroxyl group at a 3-position with an acyl group; and
DS6 represents a degree of substitution of a hydroxyl group at a 6-position with an acyl group.

6. The cellulose acylate film according to claim 1, which comprises at least one retardation increasing agent comprising a rod-like or cylindrical compound.

7. The cellulose acylate film according to claim 1, which comprises at least one of a plasticizer, an ultraviolet absorber and a peeling accelerator.

8. The cellulose acylate film according to claim 1,
wherein a thickness of the film is from 40 to 180 μm.

9. The cellulose acylate film according to claim 1,
wherein a content of an additive added to the cellulose acylate is from 10 mass % or more to 30 mass % or less based on a total film mass.

10. The cellulose acylate film according to claim 1,
wherein a difference ΔRe between Re at 25° C. 10% RH (Re 10% RH) value and Re at 25° C. 80% RH (Re 80% RH) value (=Re 10% RH−Re 80% RH) of the film is 12 nm or less, and a difference ΔRth between Rth at 25° C. 10% RH (Rth 10% RH) value and Rth at 25° C. 80% RH (Rth 80% RH) value (=Rth 10% RH−Rth 80% RH) is 32 nm or less.

11. The cellulose acylate film according to claim 1,
wherein an equilibrium moisture content of the film at 25° C. 80% RH is 3.4% or less.

12. The cellulose acylate film according to claim 1,
wherein a moisture permeability (in terms of film thickness of 80 μm) of the film after being allowed to leave at 60° C. 95% RH for 24 hours is from 400 to 2,300 g/m^{2.} 24 hr.

13. The cellulose acylate film according to claim 1,
wherein a mass variation of the film in a case of being allowed to stand at 80° C. 90% RH for 48 hours is from 0 to 5%.

14. The cellulose acylate film according to claim 1,
wherein both dimensional variations of the film in a case of being allowed to stand at 60° C. 90% RH for 24 hours and in a case of being allowed to stand at 90° C. 3% RH for 24 hours are within ±2%.

15. The cellulose acylate film according to claim 1,
wherein a glass transition temperature Tg is from 80 to 180° C.

16. The cellulose acylate film according to claim 1,
wherein an elastic modulus is from 1,500 to 5,000 MPa.

17. The cellulose acylate film according to claim 1,
wherein a modulus of photoelasticity is 50×10⁻¹³ cm²/dyn (5×10⁻¹¹ Pa-1) or less.

18. The cellulose acylate film according to claim 1,
wherein a haze value is from 0.01 to 2%.

19. The cellulose acylate film according to claim 1, which comprises silicon dioxide fine particles having an average particle size of secondary particles of from 0.2 or more to 1.5 μm or less.

20. The cellulose acylate film according to claim 1,
wherein Re (630) and Rth (630) measured in an environmental humidity at 25° C. 60% RH satisfy equations (A), (B) and (C):
46≦Re(630)≦100 (A)
Rth(630)=a−5.9Re(630) (B)
520≦a≦600 (C)

21. The cellulose acylate film according to claim 1,
wherein Re value and Rth value measured by varying a wavelength in an environmental humidity at 25° C. 60% RH satisfy both equations (D) and (E):
0.90≦Re(450)/Re(550)≦1.10, and 0.90≦Re(650)/Re(550)≦1.10 (D)
0.90≦Rth(450)/Rth(550)≦1.25, and 0.90≦Rth(650)/Rth(550)≦1.10 (E)

22. The cellulose acylate film according to claim 1,
wherein a number of luminescent spot inclusions having a major axis of 20 μm or more is 20 or less in any 2.16 mm×1.72 mm area of the cellulose acylate film.

23. A polarizing plate comprising:
a polarizer; and
a protective film,
wherein the protective film comprises at least one cellulose acylate film according to claim 1.

24. The polarizing plate according to claim 23,
wherein single transmittance TT (%), parallel transmittance PT (%), cross transmittance CT (%) and polarization degree P of the polarizing plate measured at 25° C. 60% RH satisfy at least one of equations (a) to (d):
40.0≦TT≦45.0 (a)
30.0≦PT≦40.0 (b)
CT≦2.0 (c)
95.0≦P. (d)

25. The polarizing plate according to claim 23, wherein CT (380) (%), CT (410) (%) and CT (700) (%) satisfy at least one of equations (e) to (g), provided that a cross transmittance at wavelength λ is CT (λ) (%):
CT (380)≦2.0 (e)
CT (410)≦0.1 (f)
CT (700)≦0.5 (g)

26. The polarizing plate according to claim 23,
wherein a variation ΔCT (%) of a cross transmittance and a variation ΔP of a polarization degree at a time when the plate is allowed to stand at 60° C. 90% RH for 500 hours satisfy at least one of equations (h) and (i):
−3.0≦ΔCT≦3.0 (h)
−5.0≦ΔP≦0.0 (i)
wherein the variation means a value obtained by subtracting a measured value before a test from a measured value after the test.

27. The polarizing plate according to claim 23,
wherein a variation ΔCT (%) of a cross transmittance and a variation ΔP of a polarization degree at a time when the plate is allowed to stand at 60° C. 95% RH for 500 hours satisfy at least one of equations (j) and (k):
−6.0≦ΔCT≦6.0 (j)
−10.0≦ΔP≦0.0 (k)
wherein the variation means a value obtained by subtracting a measured value before a test from a measured value after the test.

28. The polarizing plate according to claim 23,
wherein a variation ΔCT of a cross transmittance and a variation ΔP of a polarization degree at a time when the plate is allowed to stand at 80° C. for 500 hours satisfy at least one of equations (l) and (m):
−3.0≦ΔCT≦3.0 (l)
−2.0≦ΔP≦0.0 (m)

29. The polarizing plate according to claim 23,
wherein at least one of a hard coat layer, a glare-proof layer and an antireflection layer is provided on a surface of a protective film provided on a side opposite to a liquid crystal cell of the polarizing plate.

30. The polarizing plate according to claim 23, which is packaged in a moisture-proof bag, and a humidity in a packaged state bag is from 43% RH to 70% RH at 25° C.

31. The polarizing plate according to claim 23, which is packaged in a moisture-proof bag, and a difference between a humidity in a packaged state bag and a humidity at a time of sticking the polarizing plate on a liquid crystal panel is 15% RH or less.

32. An OCB mode liquid crystal display comprising a cellulose acylate film according to claim 1.

33. A VA mode liquid crystal display comprising a cellulose acylate film according to claim 1.

34. A VA mode liquid crystal display comprising only one cellulose acylate film according to claim 1.

35. A VA mode liquid crystal display comprising only one cellulose acylate film according to claim 1 on a back light side.
